(19) United States
(12) Patent Application Publication
(10) Pub. No.: US 2009/0098270 A1
(43) Pub. Date: Apr. 16, 2009

(54) System for gluten replacement in food products

(75) Inventors: Jodi A. Engleson, Minneapolis, MN (US); Carrie A. Lendon, Minneapolis, MN (US); Janiece Hope, Minneapolis, MN (US); Jeffrey L. Casper, Minneapolis, MN (US)

Correspondence Address: CARGILL, INCORPORATED, LAW/24, 15407 MCGINTY ROAD WEST, WAYZATA, MN, 55391, US

(73) Assignee: CARGILL, INCORPORATED, Wayzata, MN (US)

(21) Appl. No.: 12/228,544

(22) Filed: Aug. 13, 2008

Related U.S. Application Data
(63) Continuation-in-part of application No. 11/891,911, filed on Aug. 13, 2007.
Application No. 11/891,911 is a continuation-in-part of application No. PCT/US07/75842, filed on Aug. 13, 2007.
(60) Provisional application No. 60/843,290, filed on Sep. 8, 2006.
(60) Provisional application No. 60/837,331, filed on Aug. 11, 2006.

(51) Int. Cl. A21D 10/04

(52) U.S. Cl. 426/551; 426/555

(57) ABSTRACT

The present invention is a system for replacing gluten in food products. In certain embodiments, the gluten replacement system of the present invention utilizes gluten-free ingredients that mimic the functions of gluten in a dough and in a final product made from the dough. The gluten replacement system can be used to formulate food products that are safe for consumption by those who have a gluten intolerance, allergy or sensitivity, or by those who follow a gluten-free diet. The present invention is also directed to a composition for making a gluten-free product. The composition in certain embodiments mimics the functions of gluten in a food product. This composition may include a gluten-free gas-retaining agent and a gluten-free setting agent, and it may also include a hydrocolloid or a starch, or both.

This application claims the benefit of priority of U.S. Utility application Ser. No. 11/891,911, filed on Aug. 13, 2007, which claims the benefit of priority to U.S. Provisional Application No. 60/837,331, filed on Aug. 11, 2006 (now expired); U.S. Provisional Application No. 60/843,290, filed on Sep. 8, 2006 (now expired); and claims the benefit of priority of PCT Application Number PCT/US07/75842, filed on Aug. 13, 2007. These applications are incorporated by reference in their entireties herein.

### BACKGROUND

Gluten is a protein complex found in the triticeae tribe of grains, which includes wheat, barley and rye. The gluten content in wheat flour provides desirable organoleptic properties, such as texture and taste, to innumerable bakery and other food products. Gluten also provides the processing qualities familiar to both the home baker as well as the commercial food manufacturer. In short, gluten is considered by many to be the “heart and soul” of bakery and other food products.

However, gluten has its drawbacks. The gluten protein complex, upon entering the digestive tract, breaks down into peptide chains like other protein sources, but the resulting gluten-related peptide chain length is longer than for other proteins. For this and other reasons, in some people, these longer peptides trigger an immune response commonly referred to as celiac disease. Celiac disease is characterized by inflammation, villous atrophy and cryptic hyperplasia in the intestine. The mucosa of the proximal small intestine is damaged by an immune response to gluten peptides that are resistant to digestive enzymes. This damage interferes with the body's ability to absorb vital nutrients such as proteins, carbohydrates, fat, vitamins, minerals, and in some cases, even water and bile salts. If left untreated, celiac disease increases the risk of other disorders, such as anemia, osteoporosis, short stature, infertility and neurological problems, and has been associated with increased rates of cancer and other autoimmune disorders.

The early diagnosis of celiac disease, followed by treatment of celiac disease by eliminating gluten from the diet, leads to clinical and histologic improvement, thereby helping to reduce the probability that some of the associated, irreversible disorders will occur in a person diagnosed with celiac disease. A gluten-free diet is the mainstay of safe and effective treatment and management of celiac disease.

There are other medical reasons for following a gluten-free diet. People who are gluten-intolerant or gluten sensitive, which may include people diagnosed with Crohn's disease, ulcerative colitis, irritable bowel syndrome, dermatitis herpetiformis, or autism, are sometimes recommended or prescribed to follow a gluten-free diet. In addition, some people experience an IgE-mediated response or allergy to wheat protein. The prevalence of gluten as a potential allergen has resulted in the U.S. Food and Drug Administration being required to issue regulations regarding the definition and requirements in order for a product to be labeled “gluten-free” by 2008. Europe and Canada have regulations currently in effect which define “gluten-free” labeling for food products. Therefore, there is also a compelling need for a diet that would meet regulatory bodies' definitions of a “gluten-free” label.

Accordingly, there is an increasing need for gluten replacement systems in food products, which not only reduce or eliminate gluten in a product, but which also result in food products that are comparable to their gluten-containing counterparts. There are numerous gluten-free products on the market, but most of these products, such as gluten-free bakery products, have a poor taste and eating quality, provide poor nutrition, and are sold at a high price to the consumer.

### SUMMARY OF INVENTION

Certain embodiments of the present invention are directed to systems for replacing gluten in food products. In certain embodiments, the gluten replacement system of the present invention overcomes the typical problems associated with formulating gluten-free food products, by utilizing gluten-free ingredients that mimic the functions of gluten in a dough and in a final product made from the dough. The gluten replacement system of the present invention can also be used in combination with gluten-removing technologies if the technologies are deemed safe and effective.

Gluten, as described above, is a dynamic component in a product, and the present invention is directed to providing a dynamic gluten replacement system that results in high quality, good tasting products that are comparable to their gluten-containing counterparts. The gluten replacement system in accordance with the present invention is useful for the treatment or management of celiac disease, and is safe for consumption by those with a gluten-intolerant disorder, by those who in general have a gluten intolerance, allergy or sensitivity, or by those who have been placed on or choose to follow a gluten-free diet for medical or non-medical reasons. The present invention therefore can also be directed to the treatment or management of symptoms associated with gluten-intolerant, gluten sensitive or gluten allergic disorders by using the gluten replacement system of the present invention or by using gluten-free products made with the gluten replacement system of the present invention.

The present invention is directed to a dry, gluten-free ingredient delivery system for making a gluten-free product. The delivery system mimics the functions of gluten in a food product. This delivery system may include a gluten-free gas-retaining agent and a gluten-free setting agent.

The present invention provides a dry, gluten-free ingredient delivery system containing a gas-retaining agent and a setting agent that when processed to form a batter and baked to form a gluten-free product has a chewiness of less than about 1500 grams for at least 7 days. In certain embodiments, the gluten-free product has a chewiness of less than about 800-1500 grams for at least 7 days. In certain embodiments, the gluten-free product has a chewiness of less than about 800-1200 grams for at least 7 days. In certain embodiments, the gas-retaining agent and/or the setting agent are polymers. In certain embodiments, the gas-retaining agent is a powdered chewing gum base. In certain embodiments, the chewing gum base has a particle size of less than about 5 mm, less than about 2 mm, less than about 0.5 mm, or between about 0.20 mm to about 0.35 mm. In certain embodiments, the chewing gum base is present at an amount of about 2 to about 9 wt % of the gluten-free product. In certain embodiments the chewing gum base is present at an amount of about 2 to about 8.1 wt % of the gluten-free product. In certain embodiments, the powdered chewing gum base is generated by grinding a slab of gum base into a powder into a desired particle size.

In certain embodiments, the gas-retaining agent or the setting agent is a hydrocolloid. In certain embodiments, the delivery system also contains a hydrocolloid. In certain embodiments, the hydrocolloid is a linear and neutral hydrocolloid, a linear and charged hydrocolloid, or a combination thereof. In certain embodiments, the linear and charged hydrocolloid is pectin, low ester pectin, alginate, carrageenan, agar, xanthan gum, gellan gum, carboxymethyl cellulose, or a combination thereof. In certain embodiments, the linear and neutral hydrocolloid is microcrystalline cellulose, methyl cellulose, hydroxypropyl methyl cellulose, hydroxypropyl cellulose, amylose, guar, locust bean gum, tara, konjac, or a combination thereof. In certain embodiments, the hydrocolloid is propylene glycol alginate. In certain embodiments, the setting agent is polylactic acid, polyvinyl alcohol, zein, polycaprolactone, kafirin, whey protein, egg protein, soy protein, casein, caroubin, shellac, or water insoluble protein-based edible barrier coating or film. In certain embodiments, the shellac is in an ethanol-solubilized form, aqueous-solubilized form or a dry-and-ground form. In certain embodiments, the gas-retaining polymer or the setting agent is a starch. In certain embodiments, the delivery system also contains a starch.

In certain embodiments, the gluten-free product is dairy-free. As used herein, the term “dairy-free” and “milk-free” mean that the food does not contain milk or milk-derived ingredients that can cause milk allergy, milk protein allergy, or lactose intolerance.

In certain embodiments, the gluten-free product is a bakery product. In certain embodiments, the gluten-free product has a chewiness of less than about 800-1500 grams for at least 7 days, or of less than about 800-1200 grams for at least 7 days.

The present invention provides a food product made with a dry, gluten-free ingredient delivery system containing a gas-retaining agent and a setting agent that when processed to form a batter and baked to form a gluten-free product has a chewiness of less than about 1500 grams for at least 7 days. In certain embodiments, the food product is a gluten-free bakery product, a gluten-free pasta, a gluten-free cereal product, a gluten-free cracker, a gluten-free pizza crust, or a gluten-free bar product.

The present invention provides a pre-mix containing a dry, gluten-free ingredient delivery system containing a gas-retaining agent and a setting agent that when processed to form a batter and baked to form a gluten-free product has a chewiness of less than about 1500 grams for at least 7 days.

The present invention provides a dough product made with a dry, gluten-free ingredient delivery system containing a gas-retaining agent and a setting agent that when processed to form a batter and baked to form a gluten-free product has a chewiness of less than about 1500 grams for at least 7 days.

The present invention provides a batter made with the delivery system of a dry, gluten-free ingredient delivery system containing a gas-retaining agent and a setting agent that when processed to form a batter and baked to form a gluten-free product has a chewiness of less than about 1500 grams for at least 7 days.

The present invention provides a method for making a gluten-free bakery product, that involves the steps of providing a gluten-free gas-retaining polymer that is a powdered chewing gum base and a gluten-free setting polymer, preparing a batter composition, and baking the batter composition to form an air continuous, stable food product.

The present invention provides a method of managing a gluten-related disorder in an individual by providing to the individual a food product made with a dry, gluten-free ingredient delivery system containing a gas-retaining agent and a setting agent that when processed to form a batter and baked to form a gluten-free product has a chewiness of less than about 1500 grams for at least 7 days. In certain embodiments, the gluten-related disorder is celiac disease, gluten allergy, gluten intolerance, or gluten sensitivity.

The present invention provides a method of producing a gluten-free bakery product with a chewiness of less than about 1500 grams for at least 7 days that involves the steps of preparing a batter composition from an ingredient delivery system such as a dry, gluten-free baking mix; proofing the batter to a known height above the bread pan; and either (i) steaming the proofed batter to ensure optimal crust color formation and set, and baking the steamed batter to form an air continuous, stable food product, or (ii) dusting the proofed batter to ensure optimal crust color formation, and baking the dusted batter to form an air continuous, stable food product.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 shows perspective and side views of a loaf of bread treated with ethanol solubilized zein (left), and perspective and side views of a control loaf of bread which was not treated with ethanol solubilized zein (right).

FIG. 2 shows end and cross-sectional views of a loaf of bread made with a hydrocolloid and a starch. The specific volume=6.4 cc/g.

FIG. 3 is a MIXOLAB™ curve of a batter made with a hydrocolloid and a starch.

FIG. 4 shows cross-sectional views of a loaf of bread made with tapioca starch and ethanol-solubilized zein. Cross-sectional views of the bread initially after baking and cooling (top), and of the bread five days after baking (bottom), are shown.

FIG. 5 shows end, side, and cross-sectional views of loaves of bread made with tapioca starch and high amylose starch, and cross-sectional views of a loaf of bread made with tapioca starch and modified starch.

FIG. 6 shows RAPID VISCO® Analyzer (RVA) curves, in duplicate, of doughs made with wheat starch and tapioca starch. The “wheat treatment” and “tapioca treatment” curves are RVA curves of a wheat starch dough and a tapioca starch dough, respectively, wherein the doughs include chewing gum base and zein. The “wheat control” and “tapioca control” curves are RVA curves of a wheat starch dough and a tapioca starch dough, respectively, wherein the doughs do not include chewing gum base and zein.

FIG. 7 shows RAPID VISCO® Analyzer (RVA) curves, in duplicate, of doughs made with wheat flour. The “xanthan” curve is an RVA curve of a wheat flour dough made with xanthan gum. The “no xanthan” curve is an RVA curve of a wheat flour dough made without xanthan gum.

FIG. 8 is a bar graph showing the linear viscoelastic endpoint (LVE) values of doughs made with wheat starch, tapioca starch, and wheat flour.

FIG. 9 is a creep-recovery test curve of doughs made with tapioca starch and wheat flour.

FIG. 10 is a typical Texture Profile Analysis curve.

FIG. 11 shows views of pellets obtained after centrifugation of a bread made with xanthan gum, a bread made with PERMSOFT™ chewing gum base and zein, and a commercial WONDER® Classic white bread.

FIG. 12 shows end and side views of a loaf of bread made with polyethylene oxide.

FIG. 13 shows end, side, and cross-sectional views of a loaf of bread made with natural chicle chewing gum base.

FIG. 14 shows end and cross-sectional views of a loaf of bread made with aqueous zein. Specific volume=5.4 cc/g.

FIG. 15 is a MIXOLAB™ curve of a dough made with aqueous zein.

FIG. 16 shows end, side, and cross-sectional views of a loaf of yeast-leavened bread. Specific volume=4.5 cc/g.

FIG. 17 is a MIXOLAB™ curve of a yeast-leavened dough.

FIGS. 18A-18B show light microscope images of iodine-stained gluten-containing commercial breads, at a 4× magnification level. FIG. 18A is an image of WONDERS Classic white bread, and FIG. 18B is an image of Levain artisan bread (Rustica, L.L.C., Minneapolis, Minn., US).

FIG. 19 shows a light microscope image of iodine-stained gluten-free bread made in accordance with the present invention, at a 4× magnification level.

FIGS. 20A-20D show images of bread using the formula set forth in Example 12 (ground gum base (Permsoft™), no zein, with soybean oil and lecithin). FIG. 20A: Lowest to highest (left to right) level of powdered gum base. FIG. 20B: Crumb structure (lowest level of powered gum base). FIG. 20C: Crumb structure (medium level of powered gum base). FIG. 20D: Crumb structure (highest level of powdered gum base).

FIGS. 21A and 21B show images of bread using the formula of Table 32 (ground gum base (Permsoft™), with zein, soybean oil and lecithin. FIG. 21A shows a side view of a finished loaf of bread. FIG. 21B shows the crumb structure.

FIGS. 22A and 22B show images of bread using the formula of Table 3 (Freedent™ chewing gum), with zein, soybean oil and lecithin). FIG. 22A shows a side view of a finished loaf of bread. FIG. 22B shows the crumb structure.

FIG. 23 shows a formula for gluten-free and milk-free bread premix with wheat starch.

FIG. 24 shows a formula for gluten-free and milk-free bread.

FIG. 25 shows an image of the bread using the formula of FIG. 24.

FIG. 26 shows the final baked gluten-free and milk-free bread nutrition and ingredient declarations.

FIG. 27 shows a graph of the final baked gluten-free and milk-free bread texture. Chewiness has the units of grams.

FIG. 28 shows a gluten-free, milk-free, and wheat-free bread premix and formula.

FIG. 29 shows a graph of air cell distribution. The gluten free prototype is most similar to the artisan bread sample.

FIG. 30 shows a graph of cell wall thickness distribution. The gluten free prototype is most similar to the artisan bread sample.

FIGS. 31A-31D show X-ray microtomography images of bread crumbs produced using the method described in Example 17. The location of the gum base are the lightest colored regions of the images.

FIGS. 32A and 32B shows images of bread produced using the method described in Example 18. Shellac samples L to R Mantrose Haeuser CB-10, CB-15, CB-20, CB-25. FIG. 32A shows an end-view of the loaves of bread, and FIG. 32B shows the crumb structure.

FIG. 33 shows images of breads produced according to the method described in Example 18, which had reduced levels of shellac.

FIG. 34 shows images of breads produced according to the method described in Example 19.

### DETAILED DESCRIPTION

Successful gluten replacement, therefore, provides a difficult challenge to the food manufacturer. This is due to the multi-faceted role that gluten plays as an ingredient in a vast array of food products.

One possible approach to making gluten-free food products is to remove the gluten from the gluten-containing ingredients. Examples of gluten-removing technologies are as follows:
Extraction using various solvents and solutions, such as ethanol, solutions of salts (including lithium chloride), and aqueous solutions of various pH;
Combined extraction/High Pressure Liquid Chromatography (HPLC) procedures;
Fractionation extraction;
Water washing (which is similar to extraction, and may be combined with precipitation);
Centrifugation and ultracentrifugation;
Enzyme treatments (such as enzyme-assisted hydrolysis);
Gluten recovery using sieves; and,
Emulsification/agglomeration.

There are many potential problems associated with attempting to remove gluten from gluten-containing ingredients. First, gluten may not be completely removed from the ingredients, resulting in levels of gluten which may be unacceptably high for patients with celiac disease. Second, the removal of gluten from some ingredients may result in the removal of the functional polymers that these ingredients require in order to bring structure to food products. Third, the expense associated with removing gluten from gluten-containing ingredients on a commercial scale may result in food product prices that are unacceptably high for consumers. Fourth, incomplete clean-up following extraction procedures may leave deleterious substances in the ingredients. Some extraction solvents and solutions are not safe for human consumption. Moreover, even extraction solvents and solutions that are safe for human consumption may leave unpleasant flavors or aromas in the food ingredients, or may lead to other unwanted results. For example, the incomplete removal of ethanol could depress yeast activity, and the changes in pH caused by certain extraction solvents or solutions could affect gelatinization temperatures.

A typical method for making gluten-free food products consists of using only ingredients derived from gluten-free starting materials. For instance, a bakery product may be made using a flour derived from a gluten-free food source, such as garbanzo beans, rather than a flour derived from a gluten-containing grain, such as wheat. Examples of gluten-free flours that may be used to make gluten-free bakery products are as follows: amaranth flour, arrowroot flour, brown rice flour, buckwheat flour, corn flour, cornmeal, garbanzo bean flour, garfava flour (a flour produced by Authentic Foods which is made from a combination of garbanzo beans and fava beans), millet flour, oat flour, potato flour, quinoa flour, Romano bean flour, sorghum flour, soy flour, sweet rice flour, tapioca flour, teff flour, and white rice flour. However, this is not a comprehensive list of all flours that may be used to make gluten-free bakery products. Frequently, different gluten-free flours are combined to make a bakery product.

Examples of other possible ingredients in gluten-free bakery products, besides gluten-free flours, are as follows: starches, including potato starch and cornstarch; gums, including xanthan gum and guar gum; gelatin; eggs; egg replacers; sweeteners, including sugars, molasses, and honey; salt; yeast; chemical leavening agents, including baking powder and baking soda; fats, including margarine and butter; oils, including vegetable oil; vinegar; dough enhancer; dairy products, including milk, powdered milk, and yogurt; soy milk; nut ingredients, including almond meal, nut milk, and nut meats; seeds, including flaxseed, poppy seeds, and sesame seeds; fruit and vegetable ingredients, including fruit puree and fruit juice; and flavorings, including rye flavor powder, vanilla, cocoa powder, and cinnamon. However, this is not a comprehensive list of all ingredients that can be used to make gluten-free bakery products.

Most approaches to formulating gluten-free products involve the use of starches, dairy products, gums and hydrocolloids, and other non-gluten proteins. These materials tend to be hydrophilic and thus may require excessive amounts of water; in fact, the unbaked material is often a batter that is poured into the pan. During baking, the high water content leads to more fully pasted starch and in turn a more brittle, crumbly final texture and a shorter, less chewy bite. In some cases the final product is even starch continuous, which is the opposite of gluten-containing bread.

Gluten is a cohesive protein mass containing primarily two groups of protein subunits—the lower molecular weight monomeric gliadins, having a molecular weight of between about 30,000 to about 125,000, and the higher molecular weight polymeric glutenins, having a molecular weight of between about 100,000 to 3,000,000 or higher.

Gluten contains both hydrophilic and hydrophobic amino acids, giving the protein mass both properties. Upon hydration, gliadins are viscous and extensible—they flow with gravity. As a result, gliadins are often considered plasticizers. Glutenins, on the other hand, upon hydration become very elastic, that is, they have a memory and are capable of returning to the original shape or approximately the original shape following deformation. This combination of properties of gluten imparts the cohesive and viscoelastic properties of a dough containing gluten, and provides the dough with gas-holding properties beneficial for successfully making bakery products.

The protein composition of gluten also includes both ordered and random regions, short and long chain proteins, and linear and branched chains. This combination of opposing properties makes gluten an important component of the manufacturing and final qualities of bakery products, and is why it has been so difficult to replace gluten with other ingredients and still produce a suitable final bakery product.

Gluten-containing bakery products begin with a gluten-containing dough. To make the dough, the ingredients are mixed with a liquid, such as water, and the continued mixing of the dough creates gas cells in the dough. As a result of mixing, the hydrated gluten forms a continuous phase in the dough, which encapsulates and stabilizes the gas cells created in the dough. When the leavening agent in the bakery product begins to generate carbon dioxide, the carbon dioxide first dissolves into the liquid phase of the dough, but upon saturation of the liquid phase, enters into the gas cells, causing the cells to expand. Gluten provides the necessary strength and flexibility to stabilize the gas cells as they expand.

When a dough containing gluten is baked, the temperature and volume of the dough begin to increase with time, until the volume reaches a plateau. As baking progresses, there is a major change in the water balance of the bread system. The starch gelatinizes and becomes hygroscopic. Amylose exudes from the starch granules; however, the granules remain largely intact because water is limited and unable to fully paste the starch. Gas cells become larger because the volume that a gas occupies is related to its temperature. This stretches the gluten, which enables the gluten polymers to align, and in turn, strain harden. Eventually the system fails and the cells break, resulting in a bicontinuous bread system; the air and gluten are continuous and the starch is discontinuous. With zero pressure gradient, the bread does not collapse. Upon cooling, the viscosity of the starch gel in the crumb increases and the structure sets. The continuous, polymerized and strain-hardened nature of the gluten and the discontinuous nature of the starch provide the final bread structure having a desirable specific volume and chewy texture.

Gluten, therefore, is a very dynamic component of a bakery product system. In its hydrated form in a dough, gluten forms the viscoelastic gas-retaining matrix that is needed in order for the dough to attain the characteristics that will result in a successful bakery product. To achieve the final bread structure, a physical strain hardening and a chemical cross-linking or polymerization occurs. Upon baking or other types of heating, gluten loses moisture, becomes polymerized, and strain hardens, thereby setting the texture and volume of the bakery product.

The present invention is directed to the use of polymers having a variety of properties to replace gluten in a food product, such as, but not limited to, a bakery product. In certain embodiments, the polymers include a gas-retaining agent and a setting agent, as will be described in more detail below.

The gas-retaining agent mimics the gas retaining properties typically imparted to a dough and the food product by its gluten content, so that carbon dioxide generated by the leavening agent in the dough is retained within the gas cells. The gas-retaining agent also permits the gas cells to expand as more carbon dioxide enters the cells and as the gas expands upon heating.

The setting agent mimics the effects of gluten strain hardening upon an increase in temperature and concomitant moisture loss in the product.

It is believed that many polymers, including, but not limited to, those listed below, can impart gas-retaining properties similar to those observed in a gluten-containing dough and food product. Gas-retaining agents can include any variety of polymers, including but not limited to hydrophilic polymers, hydrocolloids and pregelatinized starches, and the like. In certain embodiments, these polymers have hydrophobic properties.

Polymers with Gas-Retaining Properties
Butadiene-styrene rubber
Isobutylene-isoprene copolymer (butyl rubber)
Paraffin
Petroleum wax
Petroleum wax synthetic
Polyethylene polyisobutylene
Polyvinyl acetate
Poly-1-vinylpyrrolidone-co-vinyl acetate copolymer
Polyvinyl alcohol
Polyethylene glycol
Polyethylene oxide
Polyacrylic acid
Sapotaceae [chicle, chiquibul, crown gum, gutta hang kang, massaranduba balata, massaranduba chocolate, nispero, rosidinha (rosadinha) and Venezuelan chicle],
Apocynaceae [jelutong, leche caspi (sorva), pendare and perillo]
Moraceae [leche de vaca, niger gutta and tunu (tuno)]
Euphorbiaceae (chilte and natural rubber)
PERMSOFT™ chewing gum base
FREEDENT™ chewing gum base

The gas-retaining agents listed above may require the use of a setting agent in order to provide the product with the appropriate structure when the product temperature is increased, such as by baking. Setting agents can include any variety of polymers, including but not limited to hydrophilic polymers, hydrocolloids, high amylose or modified starches, and the like. In certain embodiments, these polymers have hydrophobic properties and/or contain species that dehydrate. A few examples of setting agents are listed below.

Polymers with Setting Properties
Polylactic acid
Polyvinyl alcohol
Corn zein
Polycaprolactone

In certain embodiments, the setting agent is kafirin, whey protein, egg protein, soy protein, casein, caroubin, shellac, or water insoluble protein-based edible barrier coating or film. In certain embodiments, the shellac is an ethanol solubilized form, an aqueous solubilized form, or a dry and ground form.

Other suitable polymers include those with both gas-retaining and setting properties. In certain embodiments these polymers have both hydrophilic and hydrophobic properties, to more closely resemble the unique properties of gluten.

In addition to the gas-retaining agent and the setting agent, in certain embodiments other conventional dough ingredients are used, such as softeners, including soybean oil, plasticizers, such as glycerol, and emulsifiers, such as lecithin, in order to obtain a suitable cohesive mass comparable to a gluten-containing dough.

The present invention can be directed to a gluten replacement system that can be used to prepare high quality, good tasting gluten-free products. In certain embodiments the gluten-free products are gluten-free bread products, or other bakery products such as gluten-free muffins, cakes, and cookies. In addition to gluten-free bakery products, other gluten-free versions of baked products, and products typically made with grains from the triticeae family, such as gluten-free pasta, crackers, pizza crust, bars, cereal and the like are also within the scope of the present invention.

In certain embodiments, the bread or similar bakery products made with the gluten replacement system of the present invention have properties comparable to those of their gluten-containing counterparts, e.g., similar products made with wheat flour containing gluten. The gluten-free products of the present invention have a specific volume of about 3.0 cc/g or higher, although not so high as to result in the product collapsing. In certain embodiments, the products of the present invention may have specific volumes of about 4.0 cc/g or higher, or even have specific volumes in the range of about 4.0 cc/g to about 6.0 cc/g.

Similarly, in certain embodiments, the gluten-free products of the present invention have a chewiness, as determined by texture profile analysis, of less than about 1200 g for at least seven days. In certain embodiments, the gluten-free product has a chewiness approaching 100 g, and a gumminess of between about 100-150 g.

### EXAMPLE 1

### Chewing Gum Base and Corn Zein

A gluten-free bread was produced in accordance with the present invention, using the formula of Tables 1 and 2. The formula of the softened chewing gum base listed in Table 2 is provided in Table 1. The gas-retaining agent was a chewing gum base, and the setting agent was corn zein.

TABLE 1
Softened Chewing Gum Base

| Ingredient | Mass (g) |
|---|---|
| Chewing gum base (PERMSOFT ™ chewing | 18 |
| gum base, Cafosa, S.A.U., Barcelona, Spain) | |
| Soybean oil (Cargill, Inc., Wayzata, MN, US) | 3 |
| Lecithin (LECIPRIME ™ lecithin, Cargill, Inc., | 0.9 |
| Wayzata, MN, US) | |

TABLE 2

| Ingredient | Mass (g) |
|---|---|
| Corn zein¹ (Freeman Industries LLC, Tuckahoe, NY, US) | 6 |
| 75% Aqueous ethanol (EVERCLEAR ® alcohol, | 6 |
| Luxco, Inc., St. Louis, MO, US) | |
| Salt (Cargill, Inc., Wayzata, MN, US) | 0.1 |
| Sugar (Cargill, Inc., Wayzata, MN, US) | 0.1 |
| Softened chewing gum base (made according to | 7 |
| formula of Table 1) | |
| Starch² (AYTEX ® P wheat starch, Archer | 30-40 |
| Daniels Midland Company, Decatur, IL, US) | |
| Glucono delta-lactone (GDL) (PURAC America Inc., | 1-3 |
| Lincolnshire, IL, US) | |
| Sodium bicarbonate (Church and Dwight Co., Inc., | 1-3 |
| Princeton, NJ, US) | |
| Water | 30-40 |

¹White zein (either from white maize or solvent extracted) is also available from companies like Freeman Industries LLC, but it is more difficult to procure.
²Codex wheat starch (wheat starch meeting the standard for gluten-free foods set by the Codex Alimentarius Commission) can be substituted for AYTEX ® P wheat starch.

To prepare the softened chewing gum base, the chewing gum base was melted. Soybean oil and lecithin were added to emulsify and soften the melted gum base, and these ingredients were stirred until combined. Other plasticizers for chewing gum base may include dibutyl sebacate, diethyl phthalate, acetyl tributyl citrate, acetylated mono- and di-glycerides, fully or partially hydrogenated vegetable oils, fully or partially hydrogenated animal fats, and natural and petroleum waxes.

In a separate beaker, the corn zein was dissolved in EVERCLEAR® alcohol. Salt and sugar were added to the zein solution with vigorous stirring.

Approximately 7 g of the softened chewing gum base was added to the zein solution, and the resulting combination was stirred vigorously to result in a homogeneous mixture. Cold water was then added to form a soft resin as a result of the corn zein precipitating in the presence of cold water. The resin had viscoelastic properties at ambient conditions. The resin formed a film upon bilateral extension.

Prior to heating the resin, 30-40 g of starch and water were added in an amount to result in a dough having a final mass of about 80-100 g. The ingredients were mixed until a gluten-like film occurred in the dough upon bilateral extension. Near the end of the mixing stage, glucono delta-lactone and sodium bicarbonate were added as chemical leavening agents. Approximately 20 g of dough were placed in a pan, so that the dough reached to approximately half the height of the pan. The panned dough was proofed for 15 minutes at 115° F. and 95% relative humidity, causing the dough to rise above the top of the pan. The proofed dough was then baked at 425° F. for 5 minutes. The dough was able to retain gas and expand upon initial heating, and was able to set upon further heating.

The resulting bread product had a specific volume of 3.8-4.0 cc/g, and had a chewy texture similar to a gluten-containing bread. The bread product remained soft when stored in a closed plastic bag at ambient conditions.

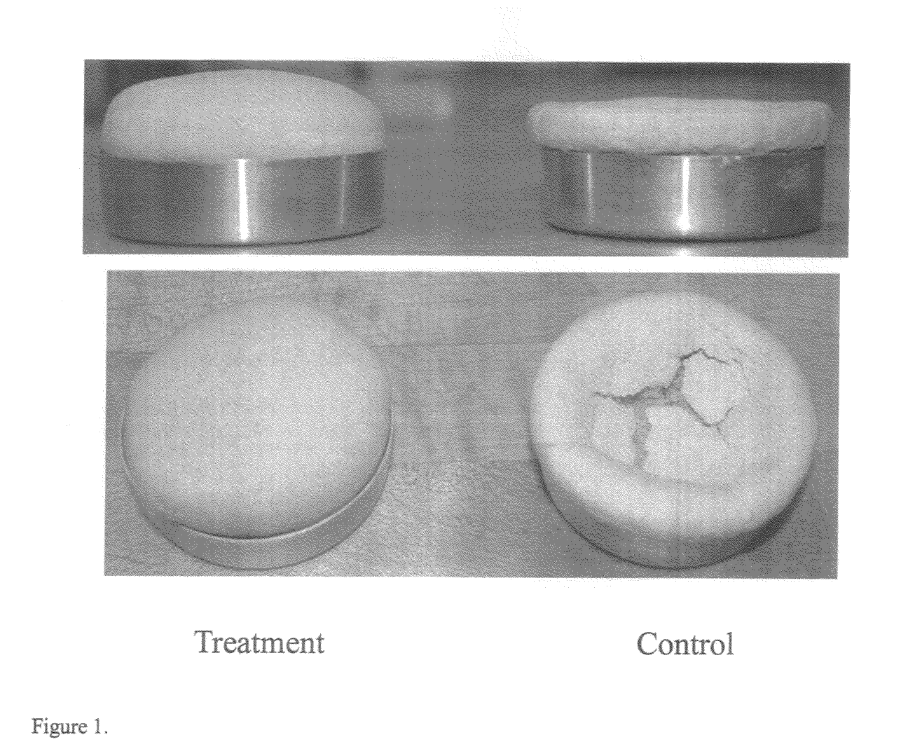

A control bread, which was prepared without ethanol solubilized zein, was compared to the bread made according to the formula of Table 1, wherein the dough was treated with ethanol solubilized zein. FIG. 1 shows photographs of both the control bread and the treated bread. The control bread proofed like the treated bread, but collapsed midway through the baking process.

The chewing gum base suitable for use in the composition of the present invention can be any chewing gum base as defined in 21 C.F.R. §172.615, which is incorporated herein by reference. The corn zein suitable for use in the composition of the present invention is the water-insoluble prolamine protein obtained from corn.

### Viscosity

The balancing of the gas-retaining and setting properties, and the hydrophobic and hydrophilic characteristics, of various gluten-replacing ingredients results in high quality gluten-free products that have the desired specific volume, texture and other properties associated with gluten-containing products.

Many of these gluten-replacing ingredients affect the viscosity of the dough or batter, and it is believed that achieving a suitable viscosity during mixing and proofing results in a desirable end product. A suitable viscosity enables gas to diffuse into existing gas cells as opposed to out of the dough or batter matrix, minimizes gas cell coalescence caused by surface tension, and reduces or prevents the dough or batter from flowing over the pan during proofing.

### Hydrocolloids

As used herein, the term “hydrocolloids” shall be used to describe non-starch hydrophilic materials that are dispersible in water. They are often used as emulsifiers, thickeners, or viscosifiers in food products. Hydrocolloids are able to increase viscosity in aqueous systems, due to their ability to absorb water.

In general, hydrocolloids are classified as linear or branched. Both linear and branched hydrocolloids are either neutral or charged. The following materials are examples of linear and neutral hydrocolloids: microcrystalline cellulose, methyl cellulose, hydroxypropyl methyl cellulose, hydroxypropyl cellulose, amylose, guar, locust bean gum, tara, and konjac. The following materials are examples of linear and charged hydrocolloids: pectin, low ester pectin, alginate, propylene glycol alginate, carrageenan, agar, xanthan gum, gellan gum, and carboxymethyl cellulose (cellulose gum). The following materials are examples of branched and charged hydrocolloids: gum arabic, tragacanth, and karaya. Amylopectin is an example of a branched and neutral hydrocolloid.

Hydrocolloids that may be suitable for use in the composition of the present invention include, but are not limited to, xanthan gum, hydroxypropyl methyl cellulose, methyl cellulose, carboxymethyl cellulose (cellulose gum), guar gum, locust bean gum, pectin, low ester pectin, alginate, propylene glycol alginate, carrageenan, agar, gellan gum, mycrocrystalline cellulose, hydroxypropyl cellulose, amylose, tara, konjac, and combinations thereof.

It has been found that certain viscosity-building hydrocolloids, such as xanthan gum, hydroxypropyl methyl cellulose, and the like can be used in combination with starch as a gluten-replacement system to result in a suitable gluten-free bakery product. Starches that can be used include gluten-free or Codex wheat starch, corn starch, high amylose starch, tapioca starch, rice starch, and the like. The resulting products have an excellent specific volume, crumb structure and appearance. Example 2 describes the use of various hydrocolloids in combination with a starch as the gluten replacement system of the present invention.

### EXAMPLE 2

### Hydrocolloid Treatment

A batter was prepared according to the formula of Table 3. The ingredients, except for the chemical leavening agents, were mixed for 3 minutes on high speed in a KITCHENAID™ Classic mixer with a paddle. The chemical leavening agents were then added, and the batter was mixed on high speed for an additional 3 minutes. The resulting batter was sticky.

TABLE 3
Hydrocolloid Treatment with no Chewing Gum Base and no Aqueous Zein

| Ingredient | Percent | Mass (g) |
|---|---|---|
| Salt (Cargill, Inc., Wayzata, MN, US) | 0.13 | 0.80 |
| Sugar (Cargill, Inc., Wayzata, MN, US) | 0.13 | 0.80 |
| Starch* (AYTEX ® P wheat starch, Archer Daniels Midland | 37.87 | 240.00 |
| Company, Decatur, IL, US) | | |
| Glucono delta-lactone (GDL) (PURAC America Inc., | 2.52 | 16.00 |
| Lincolnshire, IL, US) | | |
| Sodium bicarbonate (Church and Dwight Co., Inc., Princeton, | 1.26 | 8.00 |
| NJ, US) | | |
| Water | 53.65 | 340 |
| Ammonium bicarbonate (Church and Dwight Co., Inc., | 0.31 | 2.00 |
| Princeton, NJ, US) | | |
| Soybean oil (Cargill, Inc., Wayzata, MN, US) | 1.68 | 10.68 |
| Lecithin (LECIPRIME ™ lecithin, Cargill, Inc., Wayzata, MN, | 0.50 | 3.20 |
| US) | | |
| Xanthan Gum (KELTROL ® HP, CP Kelco, Chicago, IL, US) | 1.58 | 10.00 |
| Diacetyl tartaric acid esters of mono- and diglycerides (Danisco, | 0.16 | 1.00 |
| Ardsley, NY, US) | | |
| Azodicarbonamide ADA-PAR (BENCHMATE ™, Burns Philp | 0.02 | 0.10 |
| Food Inc., Fenton, MO, US) | | |
| Ascorbic Acid PAR-C-120 (BENCHMATE ™, Burns Philp Food | 0.02 | 0.10 |
| Inc., Fenton, MO, US) | | |
| Sodium stearoyl lactylate (Archer Daniels Midland Company, | 0.16 | 1.00 |
| Decatur, IL, US) | | |
| Total | 100.00 | 633.68 |

*Codex wheat starch can be substituted for AYTEX ® P wheat starch.

Approximately 220 g of batter were poured into a pup loaf pan. The batter was proofed to approximately 1 inch above the top of the pan, at 115° F. and 85% relative humidity. The batter was then baked for 30 minutes at 430° F.

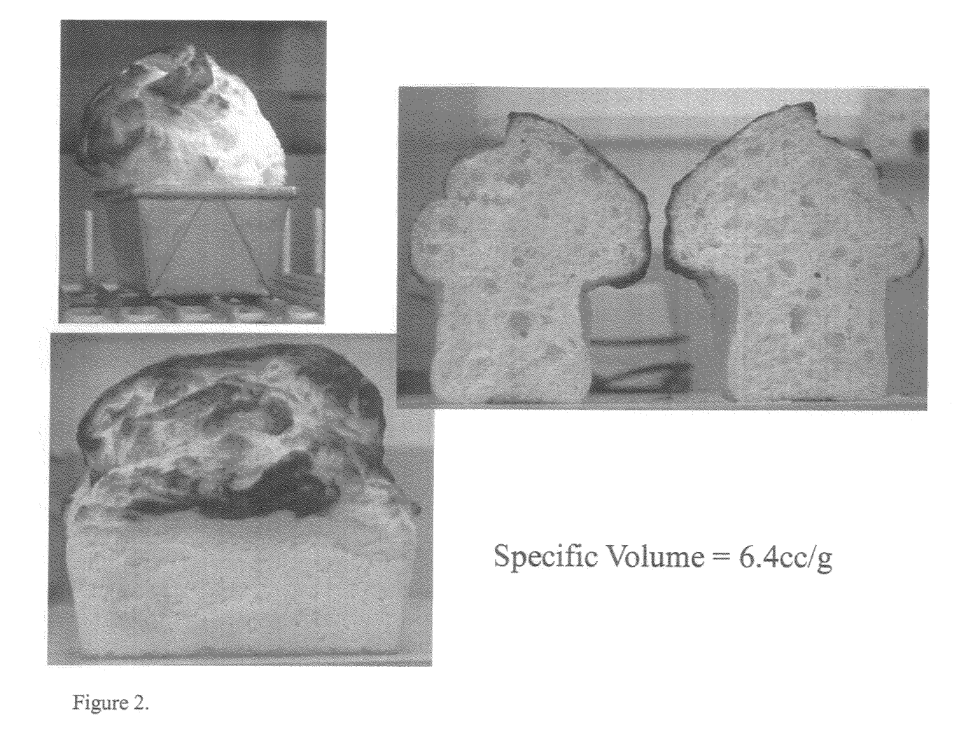

The combination of water, starch, and hydrocolloid produced a batter that was surprisingly able to proof to height and yield a significant amount of oven spring. The resulting bread had a specific volume of 6.4 cc/g, and a set crumb structure (FIG. 2).

The final product had a crumb structure very much like bread; however, it lacked a chewy texture and fell apart easily in the mouth. The bread was soft and stable after 24 hours in a plastic bread bag.

A batter prepared according to the formula of Table 3 was analyzed using a MIXOLAB™ mixer, which is a mixer that can be used to measure the viscosity and gelatinization of a batter or dough. The MIXOLAB™ mixer is commercially available from Chopin Technologies, Villeneuve-la-Garenne, France. The following protocol was used to conduct the MIXOLAB™ analysis:
85 g dough
Protocol:
Mixing speed: 80 rpm
Tank temp: 30° C.
   1. Start test, hold at 30° C. for 5 minutes
   2. 1^{st} gradient: heat to 90° C. at a rate of 6 degrees/minute
   3. Hold for 7 minutes at 90° C.
   4. 2^{nd} gradient: cool to 50° C. at a rate of −8 degrees/minute
   5. Hold for 5 minutes at 50° C.
Total analysis time: 32 minutes

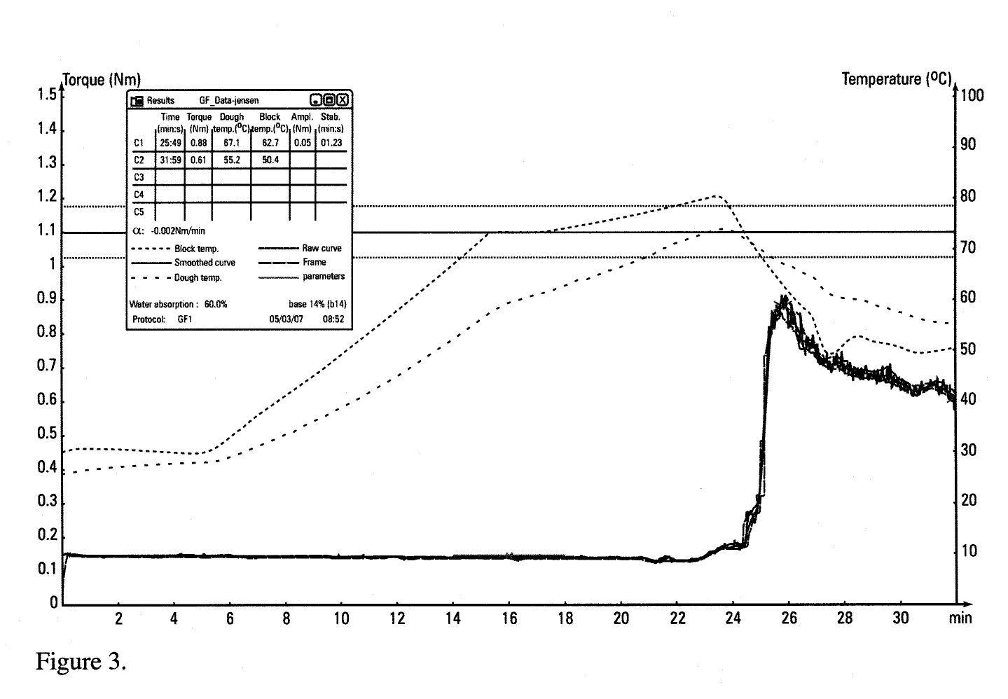

A MIXOLAB™ curve for this batter is shown in FIG. 3. The data suggest that although the hydrocolloids are able to provide adequate proofing and result in a product with sufficient starch gelatinization, additional functional ingredients are needed to provide other attributes associated with gluten-containing products.

### Hydrocolloids and Hydrophobic Ingredients

When there is a high level of a viscosifier, like a hydrocolloid and/or modified or high amylose starch, present in the product, the product may not have a proper chewy texture resembling that of a gluten-containing product. It was found that a combination of hydrocolloids and hydrophobic functional ingredients gave the optimal performance, resulting in a bread with a proper chewy texture. Balancing hydrophilic and hydrophobic ingredients may also lead to longer shelf life.

Combining relatively high levels of viscosifying hydrocolloids with the other polymeric gas-retaining and setting agents described above results in a gluten-free bakery product with a desired specific volume, crumb structure, appearance, and chewiness associated with gluten-containing bakery products. It is believed that the inclusion of hydrocolloids helps to stabilize the gas cells in the dough, and reduce the rate of diffusion of gas out of the dough, and the hydrophobic properties of the polymers provide the desired textural properties in the finished product.

Example 3 describes the effects of adding a hydrocolloid to the polymeric gas-retaining and setting system in order to replace the gluten in a bakery product in accordance with the present invention.

### EXAMPLE 3

### Chewing Gum Base, Corn Zein and Hydrocolloids

The following hydrocolloid treatments were evaluated, as listed in Table 4: 1) 10 g xanthan gum, 2) 5 g xanthan gum and 5 g hydroxypropyl methylcellulose (HPMC) (METHOCEL® K4M), 3) 5 g xanthan gum and 5 g methylcellulose (MC) (METHOCEL® A4M), 4) 10 g guar, and 5) 10 g methylcellulose (MC) (METHOCEL® A4M). All 5 treatments produced satisfactory bread with respect to specific volume and set crumb, suggesting that a pure viscosifier alone rather than a charged hydrocolloid alone or viscosifier/charged hydrocolloid combination was sufficient to trap gas in the matrix and set the baked bread.

It was also discovered that the crumb structure of the gluten-free products could be made finer by adding a punch step as follows: after the batter is proofed for 1 hour at 115° F. and 85% relative humidity, the batter is then punched-down manually using the mixer paddle, an additional 16 g of glucono delta-lactone and 8 g of sodium bicarbonate are added to the entire batter and mixed on medium speed for 1 minute, and 220 g of batter are poured into a pup loaf pan and proofed and baked as described. The addition of the punch step and additional leavening agents produced baked products with desirable specific volumes and finer crumb structures as compared to similar products made without the punch step.

TABLE 4
Hydrocolloid Ingredients

| | Treatment | | Treatment | | Treatment | | Treatment | | Treatment | |
|---|---|---|---|---|---|---|---|---|---|---|
| | 1 | | 2 | | 3 | | 4 | | 5 | |
| Hydrocolloid | | Mass | | Mass | | Mass | | Mass | | Mass |
| Ingredient | % | (g) | % | (g) | % | (g) | % | (g) | % | (g) |
| HPMC | 0.00 | 0.00 | 0.64 | 5.00 | 0.00 | 0.00 | 0.00 | 0.00 | 0.00 | 0.00 |
| (METHOCEL ® | | | | | | | | | | |
| K4M, Dow | | | | | | | | | | |
| Chemical Co., | | | | | | | | | | |
| Midland, MI, | | | | | | | | | | |
| US) | | | | | | | | | | |
| MC | 0.00 | 0.00 | 0.00 | 0.00 | 0.64 | 5.00 | 0.00 | 0.00 | 1.28 | 10.00 |
| (METHOCEL ® | | | | | | | | | | |
| A4M, Dow | | | | | | | | | | |
| Chemical Co., | | | | | | | | | | |
| Midland, MI, | | | | | | | | | | |
| US) | | | | | | | | | | |
| Xanthan Gum | 1.28 | 10.00 | 0.64 | 5.00 | 0.64 | 5.00 | 0.00 | 0.00 | 0.00 | 0.00 |
| (KELTROL ® | | | | | | | | | | |
| HP, CP Kelco, | | | | | | | | | | |
| Chicago, IL, US) | | | | | | | | | | |
| Guar (TIC | 0.00 | 0.00 | 0.00 | 0.00 | 0.00 | 0.00 | 1.28 | 10.00 | 0.00 | 0.00 |
| PRETESTED ® | | | | | | | | | | |
| Guar, Tic Gums, | | | | | | | | | | |
| Belcamp, MD, | | | | | | | | | | |
| US) | | | | | | | | | | |
| Total | 1.28 | 10.00 | 1.28 | 10.00 | 1.28 | 10.00 | 1.28 | 10.00 | 1.28 | 10.00 |

The ingredients of the dough that were mixed with the hydrocolloid ingredients are listed in Tables 5 and 6. The hydrocolloid treated breads were prepared as follows. To prepare the softened chewing gum base, the chewing gum base was melted completely at 200-250° C. Soybean oil and lecithin were added to emulsify and soften the melted gum base, and these ingredients were stirred until combined.

TABLE 5
Softened Chewing Gum Base

| Ingredient | Percent | Mass (g) |
|---|---|---|
| Chewing gum base (PERMSOFT ™ chewing | 82.20 | 64.10 |
| gum base, Cafosa, S.A.U., Barcelona, Spain) | | |
| Soybean oil (Cargill, Inc., Wayzata, MN, US) | 13.69 | 10.68 |
| Lecithin (LECIPRIME ™ lecithin, Cargill, Inc., | 4.11 | 3.20 |
| Wayzata, MN, US) | | |
| Total | 100.00 | 77.98 |

TABLE 6
Ingredients Mixed with the Hydrocolloid Ingredients of Table 4

| Ingredient | Percent | Mass (g) |
|---|---|---|
| Corn zein (Freeman Industries LLC, Tuckahoe, | 6.12 | 47.90 |
| NY, US) | | |
| 75% Aqueous ethanol (EVERCLEAR ® alcohol, | 6.12 | 47.90 |
| Luxco, Inc., St. Louis, MO, US) | | |
| Salt (Cargill, Inc., Wayzata, MN, US) | 0.10 | 0.80 |
| Sugar (Cargill, Inc., Wayzata, MN, US) | 0.10 | 0.80 |
| Softened chewing gum base (from Table 5) | 8.56 | 67.00 |
| Starch* (AYTEX ® P wheat starch, Archer Daniels | 30.67 | 240.00 |
| Midland Company, Decatur, IL, US) | | |
| Glucono delta-lactone (GDL) (PURAC America | 2.04 | 16.00 |
| Inc., Lincolnshire, IL, US) | | |
| Sodium bicarbonate (Church and Dwight Co., Inc., | 1.02 | 8.00 |
| Princeton, NJ, US) | | |
| Water | 43.44 | 340 |
| Ammonium bicarbonate (Church and Dwight Co., | 0.26 | 2.00 |
| Inc., Princeton, NJ, US) | | |
| Diacetyl tartaric acid esters of mono- and | 0.13 | 1.00 |
| diglycerides (Danisco, Ardsley, NY, US) | | |
| Azodicarbonamide ADA-PAR (BENCHMATE ™, | 0.01 | 0.10 |
| Burns Philp Food Inc., Fenton, MO, US) | | |
| Ascorbic Acid PAR-C-120 (BENCHMATE ™, | 0.01 | 0.10 |
| Burns Philp Food Inc., Fenton, MO, US) | | |
| Sodium stearoyl lactylate (Archer Daniels Midland | 0.13 | 1.00 |
| Company, Decatur, IL, US) | | |
| Total | 98.72 | 772.6 |

*Codex wheat starch can be substituted for AYTEX ® P wheat starch.

The corn zein, salt, and sugar were dissolved in EVERCLEAR® alcohol, and combined with softened chewing gum base. Cold water was then added to precipitate the softened chewing gum base and zein, until the material was no longer sticky (approximately 2 minutes). The remaining ingredients were then added, and the combination was mixed for 3 minutes on high speed in a KITCHENAID™ Classic mixer with a paddle. The chemical leavening agents were then added, and the batter was mixed on high speed for an additional 3 minutes. The resulting dough was sticky.

Approximately 220 g of dough were poured into a pup loaf pan. The dough was proofed to approximately 1 inch above the top of the pan, at 115° F. and 85% relative humidity. The batter was then baked for 30 minutes at 430° F.

All five hydrocolloid-starch treatments resulted in an acceptable specific volume. The specific volumes of the products made with each treatment were as follows: Treatment 1 resulted in 5.9 cc/g; Treatment 2 resulted in 3.8 cc/g; Treatment 3 resulted in 6.0 cc/g; Treatment 4 resulted in 4.1 cc/g; and Treatment 5 resulted in 4.3 cc/g.

### Starches

To further investigate the function of starches in the gluten-replacing composition or system of the present invention, tapioca starch and high amylose starch were evaluated, in addition to the wheat starch studied in the previous Examples. Example 4 describes the use of tapioca starch with zein or high amylose starch as the setting agent.

### EXAMPLE 4

### Tapioca Starch and Zein or High Amylose Starch

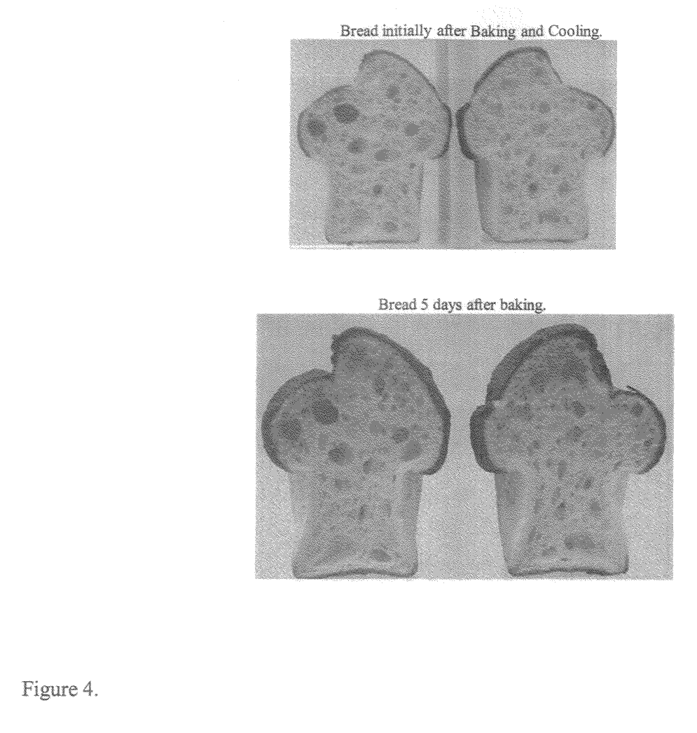

Tapioca starch bread was set using ethanol-solubilized zein, according to the formula of Tables 7 and 8 (see FIG. 4). The nonpolar zein fractions are likely solubilized in the ethanol, rather than plasticized. As the ethanol vaporizes during proofing and baking, the zein may harden and in turn set the breadcrumb. It is also possible that the ethanol changes the temperatures and extent of starch gelatinization by competing for water. It is likely that anything that competes for water in the dough will change the temperatures and extent of starch gelatinization, as will modifications to the tapioca starch, such as cross-linking.

TABLE 7
Softened Chewing Gum Base

| Ingredient | Percent | Mass (g) |
|---|---|---|
| Chewing gum base (PERMSOFT ™ chewing | 82.20 | 64.10 |
| gum base, Cafosa, S.A.U., Barcelona, Spain) | | |
| Soybean oil (Cargill, Inc., Wayzata, MN, US) | 13.69 | 10.68 |
| Lecithin (LECIPRIME ™ lecithin, Cargill, Inc., | 4.11 | 3.20 |
| Wayzata, MN, US) | | |
| Total | 100.00 | 77.98 |

TABLE 8
Tapioca Starch and Zein

| Ingredient | Percent | Mass (g) |
|---|---|---|
| Corn zein (Freeman Industries LLC, Tuckahoe, | 6.12 | 47.90 |
| NY, US) | | |
| 75% Aqueous ethanol (EVERCLEAR ® alcohol, | 6.12 | 47.90 |
| Luxco, Inc., St. Louis, MO, US) | | |
| Salt (Cargill, Inc., Wayzata, MN, US) | 0.10 | 0.80 |
| Sugar (Cargill, Inc., Wayzata, MN, US) | 0.10 | 0.80 |
| Softened chewing gum base (from Table 7) | 8.56 | 67.00 |
| Starch (Tapioca starch, Cream Gel 70001, Cargill, | 30.67 | 240.00 |
| Inc., Wayzata, MN, US) | | |
| Glucono delta-lactone (GDL) (PURAC America | 2.04 | 16.00 |
| Inc., Lincolnshire, IL, US) | | |
| Sodium bicarbonate (Church and Dwight Co., Inc., | 1.02 | 8.00 |
| Princeton, NJ, US) | | |
| Water | 43.44 | 340.00 |
| Ammonium bicarbonate (Church and Dwight Co., | 0.26 | 2.00 |
| Inc., Princeton, NJ, US) | | |
| Xanthan Gum (KELTROL ® HP, CP Kelco, | 1.27 | 10.00 |
| Chicago, IL, US) | | |
| Diacetyl tartaric acid esters of mono- and | 0.13 | 1.00 |
| diglycerides (Danisco, Ardsley, NY, US) | | |
| Azodicarbonamide ADA-PAR (BENCHMATE ™, | 0.01 | 0.10 |
| Burns Philp Food Inc., Fenton, MO, US) | | |
| Ascorbic Acid PAR-C-120 (BENCHMATE ™, | 0.01 | 0.10 |
| Burns Philp Food Inc., Fenton, MO, US) | | |
| Sodium stearoyl lactylate (Archer Daniels Midland | 0.13 | 1.00 |
| Company, Decatur, IL, US) | | |
| Total | 100.00 | 782.60 |

To prepare the softened chewing gum base, the chewing gum base was melted completely at 200-250° C. Soybean oil and lecithin were added to emulsify and soften the melted gum base, and these ingredients were stirred until combined.

The ingredients, except for the GDL and sodium bicarbonate, were added to a bowl and mixed for 3 minutes on high speed in a KITCHENAID™ Classic mixer with a paddle. The GDL and sodium bicarbonate were then added, and the dough was mixed on high speed for an additional 3 minutes. The resulting dough was sticky. Approximately 220 g of dough were poured into a pup loaf pan. The dough was proofed to approximately 1 inch above the top of the pan, at 115° F. and 85% relative humidity. The dough was then baked for 30 minutes at 430° F. At a time of 48 hours after baking, the specific volume of the resulting bread was 7.0 cc/g.

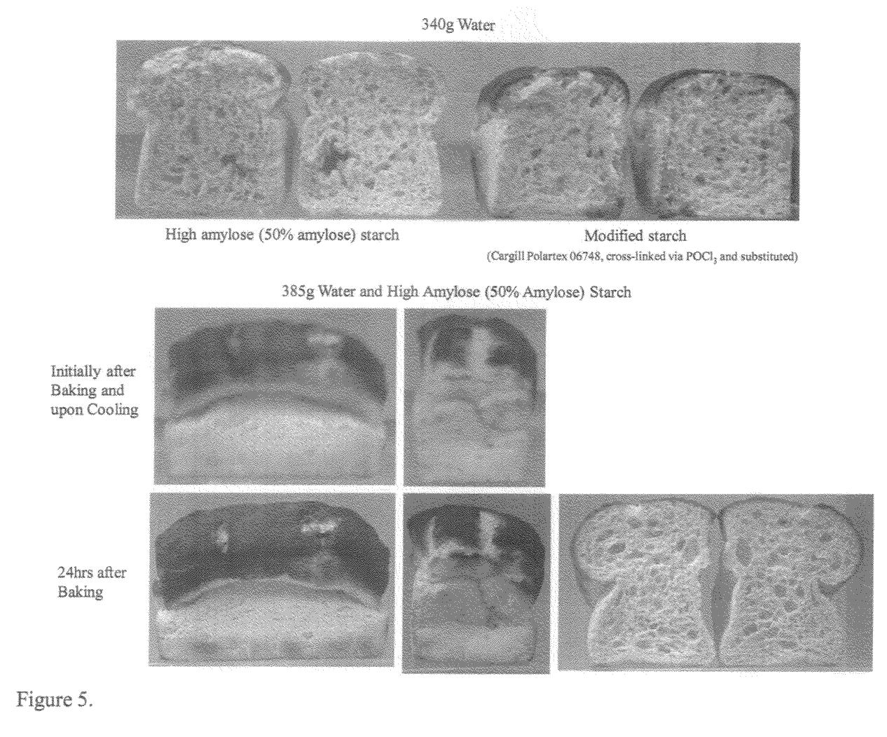

Tapioca starch bread was also set using high amylose (50% amylose) starch. Tables 9 and 10 provide the bread formula and FIG. 5 shows photographs of the breads.

TABLE 9
Softened Chewing Gum Base

| Ingredient | Percent | Mass (g) |
|---|---|---|
| Chewing gum base (PERMSOFT ™ chewing | 82.20 | 64.10 |
| gum base, Cafosa, S.A.U., Barcelona, Spain) | | |
| Soybean oil (Cargill, Inc., Wayzata, MN, US) | 13.69 | 10.68 |
| Lecithin (LECIPRIME ™ lecithin, Cargill, Inc., | 4.11 | 3.20 |
| Wayzata, MN, US) | | |
| Total | 100.00 | 77.98 |

TABLE 10
Tapioca Starch and High Amylose Starch

| Ingredient | Percent | Mass (g) |
|---|---|---|
| High amylose starch (Amylogel 03001, Cargill, | 6.52 | 47.90 |
| Inc., Wayzata, MN, US) | | |
| Salt (Cargill, Inc., Wayzata, MN, US) | 0.11 | 0.80 |
| Sugar (Cargill, Inc., Wayzata, MN, US) | 0.11 | 0.80 |
| Softened chewing gum base (from Table 9) | 9.12 | 67.00 |
| Starch (Tapioca starch, Cream Gel 70001, Cargill, | 32.67 | 240.00 |
| Inc., Wayzata, MN, US) | | |
| Glucono delta-lactone (GDL) (PURAC America | 2.18 | 16.00 |
| Inc., Lincolnshire, IL, US) | | |
| Sodium bicarbonate (Church and Dwight Co., Inc., | 1.09 | 8.00 |
| Princeton, NJ, US) | | |
| Water | 46.28 | 340.00 |
| Ammonium bicarbonate (Church and Dwight Co., | 0.27 | 2.00 |
| Inc., Princeton, NJ, US) | | |
| Xanthan Gum (KELTROL ® HP, CP Kelco, | 1.36 | 10.00 |
| Chicago, IL, US) | | |
| Diacetyl tartaric acid esters of mono- | 0.14 | 1.00 |
| and diglycerides (Danisco, Ardsley, NY, US) | | |
| Azodicarbonamide ADA-PAR (BENCHMATE ™, | 0.01 | 0.10 |
| Burns Philp Food Inc., Fenton, MO, US) | | |
| Ascorbic Acid PAR-C-120 (BENCHMATE ™, | 0.01 | 0.10 |
| Burns Philp Food Inc., Fenton, MO, US) | | |
| Sodium stearoyl lactylate (Archer Daniels Midland | 0.14 | 1.00 |
| Company, Decatur, IL, US) | | |
| Total | 100.00 | 734.7 |

To prepare the softened chewing gum base, the chewing gum base was melted completely at 200-250° C. Soybean oil and lecithin were added to emulsify and soften the melted gum base, and these ingredients were stirred until combined.

The ingredients, except for the GDL and sodium bicarbonate, were added to a bowl and mixed for 3 minutes on high speed in a KITCHENAID™ Classic mixer with a paddle. The GDL and sodium bicarbonate were then added, and the dough was mixed on high speed for an additional 3 minutes. The resulting dough was sticky and very light in color.

Approximately 220 g of dough were poured into a pup loaf pan. The dough was proofed to approximately 1 inch above the top of the pan, at 115° F. and 85% relative humidity. The dough was then baked for 30 minutes at 430° F. The specific volume of this bread was improved by increasing the water mass to 385 g (FIG. 5). This high amylose starch set bread had a specific volume of 4.1 cc/g at 48 hrs after baking. The amylose most likely forms hydrogen bonds intermolecularly to set the breadcrumb.

Wheat starch- and tapioca starch-containing products were analyzed to study the effects of starch gelatinization on the viscosity profile of the dough, as the viscosity ultimately leads to the final product structure and quality. The analysis was conducted over a set temperature range that included temperatures that trigger starch gelatinization. Example 5 describes the results of viscosity and rheological analyses.

### EXAMPLE 5

### RVA and Rheology Analysis of Gluten Free Doughs Containing Chewing Gum Base, Corn Zein, and a Starch

The ingredients listed in Table 11 were combined to make dough products for the analyses. Leavening agents were omitted. Relative percent values were calculated on a dry basis, and added water quantities are noted separately. WSC and TSC refer to the wheat starch and tapioca starch controls, respectively, and WST and TST refer to the wheat starch and tapioca starch treatments, respectively, that include the chewing gum base and zein. Both the gluten-free controls and treatments were compared with wheat flour gluten-containing controls (WFC), with and without xanthan gum.

TABLE 11

| | | | | | Wheat Flour | | WFC with | |
|---|---|---|---|---|---|---|---|---|
| | Control | | Treatment | | Control | | Xanthan | |
| | WSC, TSC | | WST, TST | | WFC | | WFCwX | |
| | Mass | | Mass | | Mass | | Mass | |
| Ingredient | (g) | % | (g) | % | (g) | % | (g) | % |
| Chewing | | | 64.1 | 16.88 | | | | |
| gum base¹ | | | | | | | | |
| Soybean oil² | 10.7 | 3.99 | 10.7 | 2.81 | 10.7 | 2.81 | 10.7 | 2.81 |
| Lecithin³ | 3.2 | 1.20 | 3.2 | 0.84 | 3.2 | 0.84 | 3.2 | 0.84 |
| Zein⁴ | | | 47.9 | 12.62 | | | | |
| Aqueous Ethanol⁵ | | | | | | | | |
| Water | | | | | | | | |
| Xanthan⁶ | 10.0 | 3.74 | 10.0 | 2.63 | | | 10.0 | 2.63 |
| Starch | 240.0 | 89.66 | 240.0 | 63.21 | | | | |
| (wheat or tapioca)⁷ | | | | | | | | |
| Salt⁸ | 0.8 | .30 | 0.8 | 0.21 | 0.8 | 0.21 | 0.8 | 0.21 |
| DATEM⁹ | 1.0 | .37 | 1.0 | 0.26 | 1.0 | 0.26 | 1.0 | 0.26 |
| Ascorbic | 0.1 | 0.04 | 0.1 | 0.03 | 0.1 | 0.03 | 0.1 | 0.03 |
| acid¹⁰ | | | | | | | | |
| SSL¹¹ | 1.0 | .37 | 1.0 | 0.26 | 1.0 | 0.26 | 1.0 | 0.26 |
| ADA¹² | 0.1 | 0.04 | 0.1 | 0.03 | 0.1 | 0.03 | 0.1 | 0.03 |
| Sugar¹³ | 0.8 | 0.30 | 0.8 | 0.21 | 0.8 | 0.21 | 0.8 | 0.21 |
| Wheat flour¹⁴ | | | | | 362.0 | 95.34 | 352.0 | 92.71 |
| TOTAL | 268 | 100 | 380 | 100 | 380 | 100 | 380 | 100 |

¹PERMSOFT ™ chewing gum base, Cafosa, S.A.U., Barcelona, Spain
²Cargill, Inc., Wayzata, MN, US
³LECIPRIME ™ lecithin, Cargill, Inc., Wayzata, MN, US
⁴Corn zein, Freeman Industries LLC, Tuckahoe, NY, US
⁵75% Aqueous ethanol, EVERCLEAR ® alcohol, Luxco, Inc., St. Louis, MO, US
⁶KELTROL ® HP, CP Kelco, Chicago, IL, US
⁷AYTEX ® P wheat starch, Archer Daniels Midland Company, Decatur, IL, US, or Tapioca starch, Cream Gel 70001, Cargill, Inc., Wayzata, MN, US
⁸Cargill, Inc., Wayzata, MN, US
⁹Diacetyl tartaric acid esters of mono- and diglycerides, Danisco, Ardsley, NY, US
¹⁰Ascorbic Acid PAR-C-120 (BENCHMATE ™, Burns Philp Food Inc., Fenton, MO, US)
¹¹Sodium stearoyl lactylate (Archer Daniels Midland Company, Decatur, IL, US)
¹²Azodicarbonamide ADA-PAR (BENCHMATE ™, Burns Philp Food Inc., Fenton, MO, US)
¹³Cargill, Inc., Wayzata, MN, US
¹⁴Artisan, Cargill, Inc., Wayzata, MN, US

Because the dough has a consistency more similar to batter, the viscosity analysis was conducted with an RVA (RAPID VISCO® Analyzer, Newport Scientific Pty. Ltd., Warriewood, Australia), using a method known for analyzing starch gelatinization and other formulas with a batter-like consistency. The RVA continuously measures apparent viscosity under a constant shear rate and controlled heating and cooling conditions. In order for the viscosity of the dough formulations listed above to fall within the dynamic range of the instrument, the dough was diluted 2:1 with water. With this modification, it was possible to collect RVA data. Additionally, analysis of tapioca starch gelatinization with water and water/ethanol was performed using 4 g of starch and 25 g total grams of liquid. The ratio of water to ethanol used to make the treatment dough was maintained (21.9 g water, 3.1 g ethanol).

The following RVA protocol was used:
Protocol:
Mixing speed: 160 rpm
Tank temperature: 30° C.
   1. Start test, hold for 30° C. for 5 minutes
   2. 1^{st} gradient: heat to 90° C. over 10 minutes
   3. Hold for 7 minutes at 90° C.
   4. 2^{nd} gradient: cool to 50° C. over 5 minutes
   5. Hold at 50° C. for 5 minutes
   6. 3^{rd} gradient: cool to 30° C. over 4 minutes
   7. Hold at 30° C. for 4 minutes
Total analysis time: 40 minutes

The various stages of starch gelatinization (for starch-water mixtures) have been well characterized by RVA. In a starch-water system, typically there is a peak viscosity (where the majority of the starch granules are swollen) and then a drop (where the granules begin to break down) followed by a final increase in viscosity (typically called a setback) where the solubilized starch molecules begin to re-associate. Since the formulas used contain a large (˜60 to 90%) amount of starch, it is assumed that starch makes a substantial contribution to the changes seen in the RVA graph. Deviations from the expected starch gelatinization profile are then attributed to the other ingredients, likely acting individually and synergistically. The resulting RVA curve is then a combination of all of these contributions.

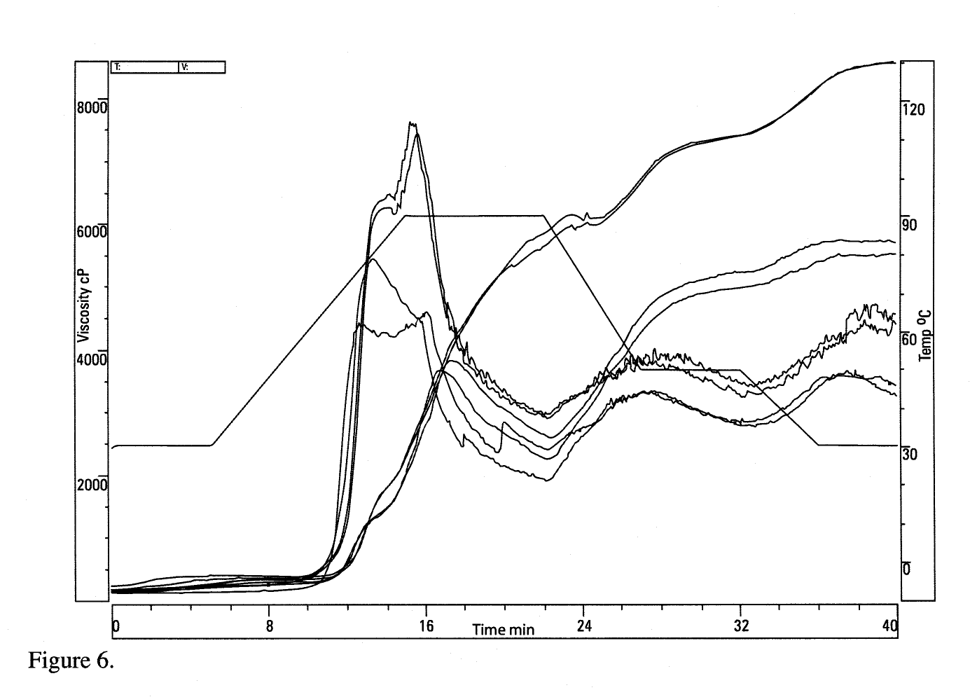

RVA curves for wheat starch and tapioca starch doughs (control and treatment) are shown, in duplicate, in FIG. 6. In general, it has been observed that ingredients like ethanol and hydrophilic polymers (xanthan) inhibit starch gelatinization (lower peak viscosity) and final setback viscosity in wheat and tapioca starch. It may be that the inhibition of tapioca starch gelatinization partially enables the crumb to set properly, and this is surprising. It is also very likely that the zein in the tapioca starch treatment hardens and enables the crumb to set properly. Additionally, a concentration effect contributes to the observables.

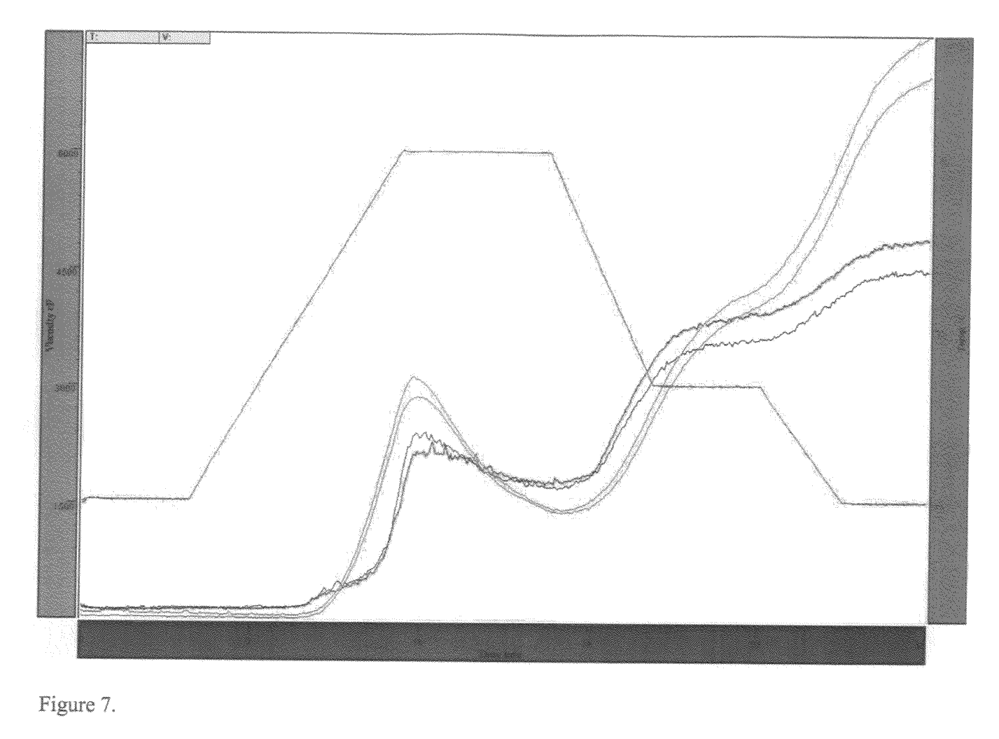

RVA curves for a wheat flour-containing control, with and without xanthan gum, are shown in FIG. 7. From these curves it can be seen that the gluten-free wheat starch treatment containing chewing gum base and zein is similar to the wheat flour controls.

Because the dough products of the present invention are at least partially viscoelastic, dynamic rheological measurements, designed to measure viscoelastic properties, are well suited to characterize these doughs.

Experiments were performed on a Physica rheometer (Anton Paar Germany GmbH, Ostfildern, Germany) using a parallel plate configuration with a 1 mm gap size. The temperature was maintained at 25° C.

Amplitude/strain sweep measurements were performed using the 50 mm geometry and a shear stress range of 0.1 to 1000 Pa at an angular frequency of 10 s⁻¹. A disposable aluminum pan was filled with 1.5 g of sample. Excess material was trimmed immediately prior to the run to minimize drying.

The amplitude sweep test tracks changes in the storage modulus (G′) and loss modulus (G″) as a function of increasing shear stress. The storage and loss modulus correlate to the elastic and viscous components of the dough, respectively.

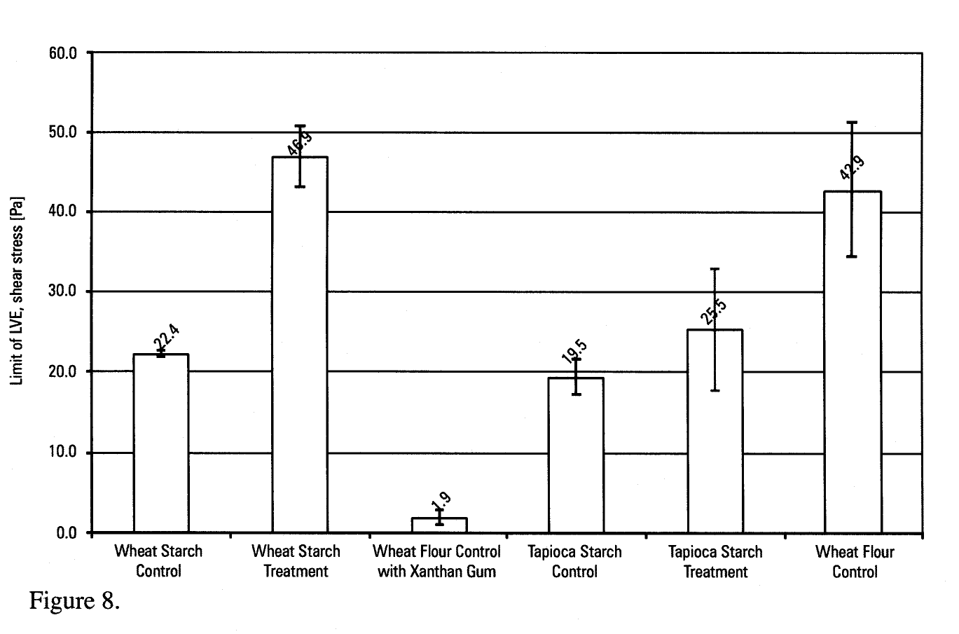

At low shear stresses, the storage modulus is relatively flat. In this region, known as the linear viscoelastic region, the material is exhibiting viscoelastic behavior in response to the shear stress. With increasing shear stress, the material eventually can no longer behave like a viscoelastic material and begins to slip and/or flow, and linearity is lost. This is the limit of the linear viscoelastic region. The linear viscoelastic endpoint, or LVE, values for the doughs made in accordance with the present invention were calculated and shown in FIG. 8. As can be seen from this Figure, products made with the chewing gum base and zein treatment showed an increase in LVE values compared to the controls, and the wheat starch treatment formula behaved very similarly to the wheat flour control. The larger the LVE value, the more time elapsed and the larger stress induced prior to dough flowing or behaving more like a liquid. Therefore, the LVE value likely correlates with mixing tolerance and bread chewiness.

Creep experiments were performed using the 25 mm geometry. A disposable aluminum pan was filled with 1.5 g of sample. Excess material was trimmed and edges sealed with silicon oil to prevent evaporation. The instrument algorithm was programmed to allow the sample to rest for 5 minutes prior to the application of a pseudo instantaneous shear stress of 2 Pa. The stress was applied for 3 minutes and then removed. The strain response was monitored for 10 minutes following the removal of the strain. Data points were collected logarithmically (0.01 to 25 seconds).

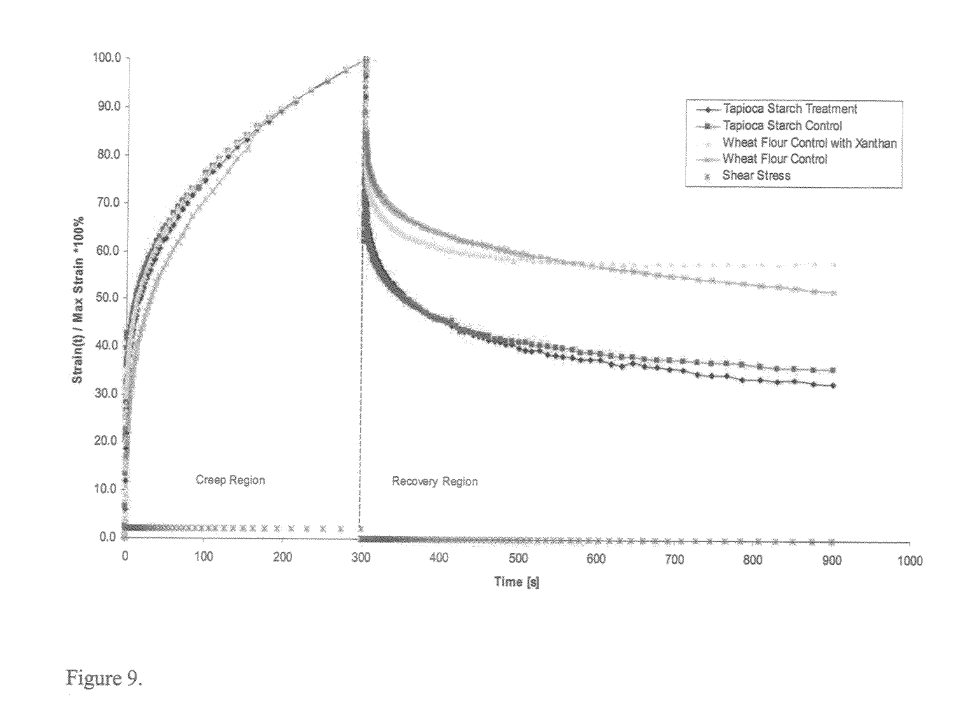

Differences in the large-scale architecture of the polymeric materials in the dough can be determined by creep-recovery testing. In FIG. 9, creep-recovery test curves are shown and exhibit typical viscoelastic behavior. In the creep region, there is an initial elastic response up to ˜40%, followed by a viscoelastic response from ˜40 to ˜70% and finally a viscous-like response occurring immediately before the stress is removed. After the stress is removed (at 300 s), the material recovers. Adding xanthan to the WFC impairs recovery, which is undesirable. It has been published that a greater creep recovery leads to better dough strength and baking performance. Hydrophobic polymers like PERMSOFT™ chewing gum base and zein improve recovery in the tapioca starch treatment.

### Texture Profile Analysis

Example 6 describes the texture profile analysis of various bread products made with hydrocolloids, and with hydrocolloids in combination with gas-retaining and setting polymers. Example 7 describes a total water insoluble analysis comparing a hydrocolloid-containing bakery product, a bakery product containing polymeric gas-retaining and setting agents with a hydrocolloid viscosifier, and a control gluten-containing bakery product. From these Examples, it is seen that the combination of the polymeric gas-retaining and setting agents with a viscosity-building hydrocolloid and starch in accordance with the present invention results in an exceptional gluten-free bakery product with properties very similar to those of a gluten-containing bakery product.

### EXAMPLE 6

### Texture Profile Analysis

Texture profile analysis (TPA) is a simple compression test that is used widely to study food product texture.

A texture analyzer (TA-XT2i Texture Analyzer, Stable Micro Systems Ltd., Scarsdale, N.Y., US) was used to run TPA on the following bread samples: a xanthan hydrophilic treatment (Table 12), a PERMSOFT™ chewing gum base-zein hydrophobic treatment with wheat starch, and a PERMSOFT™ chewing gum base-zein hydrophobic treatment with tapioca starch (Tables 13 and 14), and a wheat flour control (Table 15).

TABLE 12
Xanthan Hydrophilic Treatment

| Ingredient | Percent | Mass (g) |
|---|---|---|
| Salt (Cargill, Inc., Wayzata, MN, US) | 0.13 | 0.80 |
| Sugar (Cargill, Inc., Wayzata, MN, US) | 0.13 | 0.80 |
| Starch* (AYTEX ® P wheat starch, Archer Daniels | 37.87 | 240.00 |
| Midland Company, Decatur, IL, US) | | |
| Glucono delta-lactone (GDL) (PURAC America | 2.52 | 16.00 |
| Inc., Lincolnshire, IL, US) | | |
| Sodium bicarbonate (Church and Dwight Co., Inc., | 1.26 | 8.00 |
| Princeton, NJ, US) | | |
| Water | 53.65 | 340 |
| Ammonium bicarbonate (Church and Dwight Co., | 0.31 | 2.00 |
| Inc., Princeton, NJ, US) | | |
| Soybean oil (Cargill, Inc., Wayzata, MN, US) | 1.68 | 10.68 |
| Lecithin (LECIPRIME ™ lecithin, Cargill, Inc., | 0.50 | 3.20 |
| Wayzata, MN, US) | | |
| Xanthan Gum (KELTROL ® HP, CP Kelco, | 1.58 | 10.00 |
| Chicago, IL, US) | | |
| Diacetyl tartaric acid esters of mono- and | 0.16 | 1.00 |
| diglycerides (Danisco, Ardsley, NY, US) | | |
| Azodicarbonamide ADA-PAR (BENCHMATE ™, | 0.02 | 0.10 |
| Burns Philp Food Inc., Fenton, MO, US) | | |
| Ascorbic Acid PAR-C-120 (BENCHMATE ™, | 0.02 | 0.10 |
| Burns Philp Food Inc., Fenton, MO, US) | | |
| Sodium stearoyl lactylate (Archer Daniels Midland | 0.16 | 1.00 |
| Company, Decatur, IL, US) | | |
| Total | 100.00 | 633.68 |

*Codex wheat starch can be substituted for AYTEX ® P wheat starch.

The xanthan hydrophilic treatment bread was prepared as follows. The ingredients, except for the chemical leavening agents, were added to a bowl and mixed for 3 minutes on high speed in a KITCHENAID™ Classic mixer with a paddle. The chemical leavening agents were then added, and the dough was mixed on high speed for an additional 3 minutes. The resulting dough was sticky.

Approximately 220 g of dough were poured into a pup loaf pan. The dough was proofed to approximately 1 inch above the top of the pan, at 115° F. and 85% relative humidity. The dough was then baked for 30 minutes at 430° F. A significant amount of oven spring occurred. The specific volume of the resulting bread was 6.4 cc/g.

TABLE 13
Softened Chewing Gum Base

| Ingredient | Percent | Mass (g) |
|---|---|---|
| Chewing gum base (PERMSOFT ™ chewing | 82.20 | 64.10 |
| gum base, Cafosa, S.A.U., Barcelona, Spain) | | |
| Soybean oil (Cargill, Inc., Wayzata, MN, US) | 13.69 | 10.68 |
| Lecithin (LECIPRIME ™ lecithin, Cargill, Inc., | 4.11 | 3.20 |
| Wayzata, MN, US) | | |
| Total | 100.00 | 77.98 |

TABLE 14
PERMSOFT ™ chewing gum base-zein hydrophobic
treatment with wheat starch and tapioca starch

| Ingredient | Percent | Mass (g) |
|---|---|---|
| Corn zein (Freeman Industries LLC, Tuckahoe, | 6.12 | 47.90 |
| NY, US) | | |
| 75% Aqueous ethanol (EVERCLEAR ® alcohol, | 6.12 | 47.90 |
| Luxco, Inc., St. Louis, MO, US) | | |
| Salt (Cargill, Inc., Wayzata, MN, US) | 0.10 | 0.80 |
| Sugar (Cargill, Inc., Wayzata, MN, US) | 0.10 | 0.80 |
| Softened chewing gum base (from Table 13) | 8.56 | 67.00 |
| Starch* (AYTEX ® P wheat starch, Archer | 30.67 | 240.00 |
| Daniels Midland Company, Decatur, IL, US) or | | |
| Starch (Tapioca starch, Cream Gel 70001, | | |
| Cargill, Inc., Wayzata, MN, US) | | |
| Glucono delta-lactone (GDL) (PURAC America | 2.04 | 16.00 |
| Inc., Lincolnshire, IL, US) | | |
| Sodium bicarbonate (Church and Dwight Co., Inc., | 1.02 | 8.00 |
| Princeton, NJ, US) | | |
| Water | 43.44 | 340 |
| Ammonium bicarbonate (Church and Dwight Co., | 0.26 | 2.00 |
| Inc., Princeton, NJ, US) | | |
| HPMC (METHOCEL ® K4M, Dow Chemical Co., | 0.00 | 0.00 |
| Midland, MI, US) | | |
| MC (METHOCEL ® A4M, Dow Chemical Co., | 0.00 | 0.00 |
| Midland, MI, US) | | |
| Xanthan Gum (KELTROL ® HP, CP Kelco, | 1.28 | 10.00 |
| Chicago, IL, US) | | |
| Diacetyl tartaric acid esters of mono- and | 0.13 | 1.00 |
| diglycerides (Danisco, Ardsley, NY, US) | | |
| Azodicarbonamide ADA-PAR (BENCHMATE ™, | 0.01 | 0.10 |
| Burns Philp Food Inc., Fenton, MO, US) | | |
| Ascorbic Acid PAR-C-120 (BENCHMATE ™, | 0.01 | 0.10 |
| Burns Philp Food Inc., Fenton, MO, US) | | |
| Sodium stearoyl lactylate (Archer Daniels Midland | 0.13 | 1.00 |
| Company, Decatur, IL, US) | | |
| Total | 100.00 | 782.6 |

*Codex wheat starch can be substituted for AYTEX ® P wheat starch.

The PERMSOFT™ chewing gum base-zein hydrophobic treatment breads were prepared as follows. The softened chewing gum base was prepared by melting the chewing gum base completely at 200-250° C. Soybean oil and lecithin were added to the chewing gum base, and the mixture was stirred until combined.

Zein, salt, and sugar were dissolved in EVERCLEAR® alcohol. The resulting solution was combined with the softened chewing gum base. Cold water was then added to the mixture to precipitate softened chewing gum and zein, until the mixture was no longer sticky (approximately two minutes). The remaining ingredients, except for the chemical leavening agents, were added to the mixture and mixed for 3 minutes on high speed in a KITCHENAID™ Classic mixer with paddle. Finally, the chemical leavening agents were added, and the dough was mixed on high speed for an additional 3 minutes. The resulting dough was sticky.

Approximately 220 g of dough were poured into a pup loaf pan. The dough was proofed to approximately 1 inch above the top of the pan, at 115° F. and 85% relative humidity. The dough was subsequently baked for 30 minutes at 430° F. A significant amount of oven spring occurred. The specific volume of the resulting breads was 6.6 cc/g.

TABLE 15
Wheat Flour Control

| Ingredient | Percent | Mass (g) |
|---|---|---|
| Soybean oil (Cargill, Inc., Wayzata, MN, US) | 1.35 | 10.68 |
| Lecithin (LECIPRIME ™ lecithin, Cargill, Inc., | 0.40 | 3.20 |
| Wayzata, MN, US) | | |
| Salt (Cargill, Inc., Wayzata, MN, US) | 0.10 | 0.80 |
| Sugar (Cargill, Inc., Wayzata, MN, US) | 0.10 | 0.80 |
| Wheat Flour (Artisan, Cargill, Inc., Wayzata, | 44.41 | 352.00 |
| MN, US) | | |
| Glucono delta-lactone (GDL) (PURAC America | 2.02 | 16.00 |
| Inc., Lincolnshire, IL, US) | | |
| Sodium bicarbonate (Church and Dwight Co., Inc., | 1.01 | 8.00 |
| Princeton, NJ, US) | | |
| Water | 48.82 | 387 |
| Ammonium bicarbonate (Church and Dwight Co., | 0.25 | 2.00 |
| Inc., Princeton, NJ, US) | | |
| Xanthan Gum (KELTROL ® HP, CP Kelco, | 1.26 | 10.00 |
| Chicago, IL, US) | | |
| Diacetyl tartaric acid esters of mono- and | 0.13 | 1.00 |
| diglycerides (Danisco, Ardsley, NY, US) | | |
| Azodicarbonamide ADA-PAR (BENCHMATE ™, | 0.01 | 0.10 |
| Burns Philp Food Inc., Fenton, MO, US) | | |
| Ascorbic Acid PAR-C-120 (BENCHMATE ™, | 0.01 | 0.10 |
| Burns Philp Food Inc., Fenton, MO, US) | | |
| Sodium stearoyl lactylate (Archer Daniels Midland | 0.13 | 1.00 |
| Company, Decatur, IL, US) | | |
| Total | 100.00 | 792.68 |

The wheat flour control bread was prepared as follows. The ingredients, except for the chemical leavening agents, were added to a bowl and mixed for 3 minutes on high speed in a KITCHENAID™ Classic mixer with a paddle. The chemical leavening agents were then added, and the dough was mixed on high speed for an additional 3 minutes. The resulting dough was sticky.

Approximately 220 g of dough were poured into a pup loaf pan. The dough was proofed to approximately 1 inch above the top of the pan, at 115° F. and 85% relative humidity. The dough was then baked for 30 minutes at 430° F. A significant amount of oven spring occurred. The specific volume of the resulting bread was >4 cc/g.

The texture analyzer was equipped with a 5 kg load cell and a round 2 in diameter compression platen probe. The bread samples were sliced into 1 in square by 0.5 in thick pieces. The TPA program compressed each piece to 50% of its original height at a constant speed of 1 mm/s. After the initial compression, the probe retracted 5 mm and then compressed to 50% of the original height.

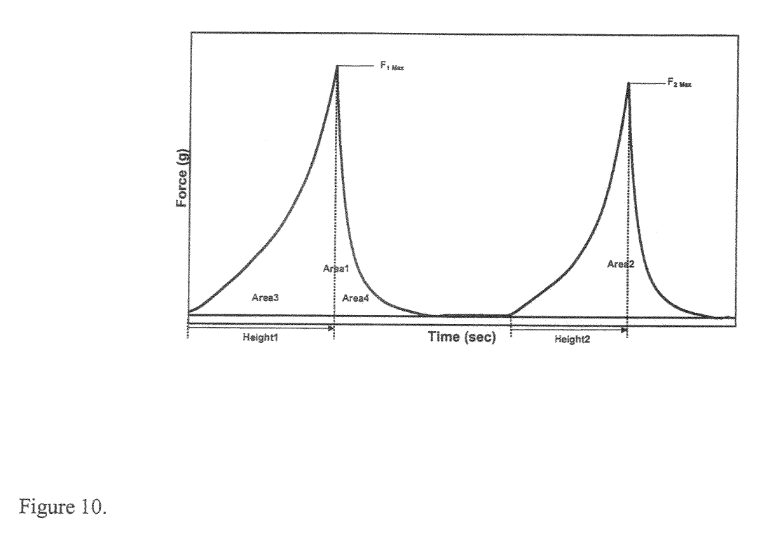

A typical TPA curve is shown in FIG. 10. From the TPA curve, texture parameters can be calculated using the method of Bourne (Food Technology, volume 32(7):62-66 (1978)). Texture parameters of interest include gumminess and chewiness as defined in Cereal Chemistry, volume 83(6):684 (2006).

Gumminess=(F1 Max)×(Area2/Area1)

Chewiness=(F1 Max)×(Area2/Area1)×(Height2/Height1)

The TPA results are listed in Table 16. The results suggest that the tapioca starch, PERMSOFT™ chewing gum base-zein hydrophobic treatment is closer in texture to the wheat flour control than the hydrophilic treatment. There is no significant difference between the wheat starch and xanthan treatments, which may be attributed to differences in crumb structure. In general, results from TPA suggest that hydrophobic polymers like chewing gum base and zein can improve the texture of gluten-free bread.

TABLE 16
Texture Profile Analysis Results

| Sample | Gumminess g | Chewiness g |
|---|---|---|
| Wheat Flour Control | 63.1 | 59.2 |
| (Table 15) | | |
| Tapioca Starch, PERMSOFT ™ chewing | 69.5 | 43.5 |
| gum base-Zein Hydrophobic Treatment | | |
| (Tables 13 and 14) | | |
| Wheat Starch, PERMSOFT ™ chewing | 27.1 | 21.2 |
| gum base-Zein Hydrophobic Treatment | | |
| (Tables 13 and 14) | | |
| Xanthan Hydrophilic Treatment | 28.2 | 25.3 |
| (Table 12) | | |

### Water Solubility

Although texture profile analysis provides valuable information, one major drawback is that water-soluble and insoluble components are treated equally in TPA, which is not true when these components are being consumed in the mouth. To analyze the differences between water soluble and water insoluble components, the following analysis was done.

### EXAMPLE 7

### Total Water Insolubles

A total water insoluble analysis was conducted on the following breads: a xanthan treatment (Table 17), a PERMSOFT™ chewing gum base-zein hydrophobic treatment (Tables 18 and 19), and a commercial WONDERS Classic white bread (Interstate Bakeries Corporation, Kansas City, Mo., US).

TABLE 17
Xanthan Treatment

| Ingredient | Percent | Mass (g) |
|---|---|---|
| Salt (Cargill, Inc., Wayzata, MN, US) | 0.13 | 0.80 |
| Sugar (Cargill, Inc., Wayzata, MN, US) | 0.13 | 0.80 |
| Starch* (AYTEX ® P wheat starch, Archer | 37.87 | 240.00 |
| Daniels Midland Company, Decatur, IL, US) | | |
| Glucono delta-lactone (GDL) (PURAC America | 2.52 | 16.00 |
| Inc., Lincolnshire, IL, US) | | |
| Sodium bicarbonate (Church and Dwight Co., Inc., | 1.26 | 8.00 |
| Princeton, NJ, US) | | |
| Water | 53.65 | 340 |
| Ammonium bicarbonate (Church and Dwight Co., | 0.31 | 2.00 |
| Inc., Princeton, NJ, US) | | |
| Soybean oil (Cargill, Inc., Wayzata, MN, US) | 1.68 | 10.68 |
| Lecithin (LECIPRIME ™ lecithin, Cargill, Inc., | 0.50 | 3.20 |
| Wayzata, MN, US) | | |
| Xanthan Gum (KELTROL ® HP, CP Kelco, | 1.58 | 10.00 |
| Chicago, IL, US) | | |
| Diacetyl tartaric acid esters of mono- and | 0.16 | 1.00 |
| diglycerides (Danisco, Ardsley, NY, US) | | |
| Azodicarbonamide ADA-PAR (BENCHMATE ™, | 0.02 | 0.10 |
| Burns Philp Food Inc., Fenton, MO, US) | | |
| Ascorbic Acid PAR-C-120 (BENCHMATE ™, | 0.02 | 0.10 |
| Burns Philp Food Inc., Fenton, MO, US) | | |
| Sodium stearoyl lactylate (Archer Daniels Midland | 0.16 | 1.00 |
| Company, Decatur, IL, US) | | |
| Total | 100.00 | 633.68 |

*Codex wheat starch can be substituted for AYTEX ® P wheat starch.

The xanthan treatment bread was prepared as follows. The ingredients, except for the chemical leavening agents, were added to a bowl and mixed for 3 minutes on high speed in a KITCHENAID™ Classic mixer with a paddle. The chemical leavening agents were then added, and the dough was mixed on high speed for an additional 3 minutes. The resulting dough was sticky.

Approximately 220 g of dough were poured into a pup loaf pan. The dough was proofed to approximately 1 inch above the top of the pan, at 115° F. and 85% relative humidity. The dough was then baked for 30 minutes at 430° F. A significant amount of oven spring occurred. The specific volume of the resulting bread was 6.4 cc/g.

TABLE 18
Softened Chewing Gum Base

| | | |
|---|---|---|
| Ingredient | Percent | Mass (g) |

| | | |
|---|---|---|
| Chewing gum base (PERMSOFT ™ chewing | 82.20 | 64.10 |
| gum base, Cafosa, S.A.U., Barcelona, Spain) | | |
| Soybean oil (Cargill, Inc., Wayzata, MN, US) | 13.69 | 10.68 |
| Lecithin (LECIPRIME ™ lecithin, Cargill, Inc., | 4.11 | 3.20 |
| Wayzata, MN, US) | | |
| Total | 100.00 | 77.98 |

TABLE 19
PERMSOFT ™ chewing gum base-zein Hydrophobic Treatment

| Ingredient | Percent | Mass (g) |
|---|---|---|
| Corn zein (Freeman Industries LLC, Tuckahoe, | 6.12 | 47.90 |
| NY, US) | | |
| 75% Aqueous ethanol (EVERCLEAR ® alcohol,. | 6.12 | 47.90 |
| Luxco, Inc., St Louis, MO, US) | | |
| Salt (Cargill, Inc., Wayzata, MN, US) | 0.10 | 0.80 |
| Sugar (Cargill, Inc., Wayzata, MN, US) | 0.10 | 0.80 |
| Softened chewing gum base (from Table 18) | 8.56 | 67.00 |
| Starch* (AYTEX ® P wheat starch, Archer | 30.67 | 240.00 |
| Daniels Midland Company, Decatur, IL, US) | | |
| Glucono delta-lactone (GDL) (PURAC America | 2.04 | 16.00 |
| Inc., Lincolnshire, IL, US) | | |
| Sodium bicarbonate (Church and Dwight Co., Inc., | 1.02 | 8.00 |
| Princeton, NJ, US) | | |
| Water | 43.44 | 340 |
| Ammonium bicarbonate (Church and Dwight Co., | 0.26 | 2.00 |
| Inc., Princeton, NJ, US) | | |
| HPMC (METHOCEL ® K4M, Dow Chemical Co., | 0.00 | 0.00 |
| Midland, MI, US) | | |
| MC (METHOCEL ® A4M, Dow Chemical Co., | 0.00 | 0.00 |
| Midland, MI, US) | | |
| Xanthan Gum (KELTROL ® HP, CP Kelco, | 1.28 | 10.00 |
| Chicago, IL, US) | | |
| Diacetyl tartaric acid esters of mono- and | 0.13 | 1.00 |
| diglycerides (Danisco, Ardsley, NY, US) | | |
| Azodicarbonamide ADA-PAR (BENCHMATE ™, | 0.01 | 0.10 |
| Burns Philp Food Inc., Fenton, MO, US) | | |
| Ascorbic Acid PAR-C-120 (BENCHMATE ™, | 0.01 | 0.10 |
| Burns Philp Food Inc., Fenton, MO, US) | | |
| Sodium stearoyl lactylate (Archer Daniels Midland | 0.13 | 1.00 |
| Company, Decatur, IL, US) | | |
| Total | 100.00 | 782.6 |

*Codex wheat starch can be substituted for AYTEX ® P wheat starch.

The PERMSOFT™ chewing gum base-zein hydrophobic treatment breads were prepared as follows. The softened chewing gum base was prepared by melting the chewing gum base completely at 200-250° C. Soybean oil and lecithin were added to the chewing gum base, and the mixture was stirred until combined.

Zein, salt, and sugar were dissolved in EVERCLEAR® alcohol. The resulting solution was combined with the softened chewing gum base. Cold water was then added to the mixture to precipitate softened chewing gum and zein, until the mixture was no longer sticky (approximately two minutes). The remaining ingredients, except for the chemical leavening agents, were added to the mixture and mixed for 3 minutes on high speed in a KITCHENAID™ Classic mixer with paddle. Finally, the chemical leavening agents were added, and the dough was mixed on high speed for an additional 3 minutes. The resulting dough was sticky.

Approximately 220 g of dough were poured into a pup loaf pan. The dough was proofed to approximately 1 inch above the top of the pan, at 115° F. and 85% relative humidity. The dough was subsequently baked for 30 minutes at 430° F. A significant amount of oven spring occurred. The specific volume of the resulting breads was 6.6 cc/g.

To examine total water insolubles, a modification of the method of B. L. D'Appolonia (Comparison of Pentosans Extracted from Conventional and Continuous Bread, Cereal Chemistry, volume 50(1):27-36 (1973) was used. Approximately 25 g of breadcrumb were mixed with 600 mL of distilled water in a Hamilton Beach blender at high speed for 3 min. The solution was centrifuged using a JLA 8.1000 rotor at 7000 rpm for 60 min at 20° C. The supernatant was decanted and the pellet (total water insolubles) examined.

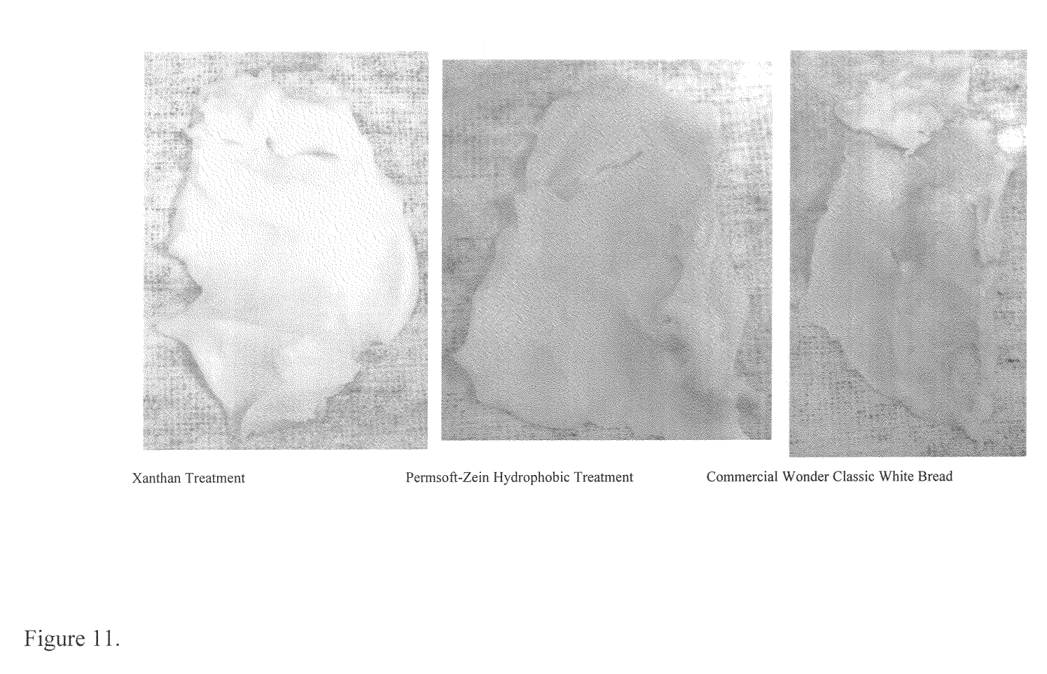

The xanthan treatment had a homogeneous pellet (FIG. 11). The pellet consistency was white and cream-like. It is believed that this pellet was predominantly gelatinized starch.

The PERMSOFT™ chewing gum base-zein hydrophobic treatment and the commercial WONDER® Classic white bread had heterogeneous pellets. Both pellets had a white, cream-like phase (similar to the xanthan treatment pellet) and a more rubbery phase. In the case of the PERMSOFT™ chewing gum base-zein hydrophobic treatment, the rubbery phase was yellow from the zein (FIG. 11). The rubbery phase was tan and resembled hydrated gluten in the commercial WONDER® Classic white bread pellet (FIG. 11).

It is believed that the rubbery phase of the total water insolubles is responsible for the characteristic chewy texture of bread, because it cannot dissolve in the mouth and because it undergoes reversible deformations during mastication due to its rubbery nature.

### Further Modifications

### Other Polymers

Viscosity-building polymers can also achieve the desired viscosity profiles described above. The viscosity-building polymer can also have gas-retaining or setting properties, or both, or can be used in addition to gas-retaining polymers and setting polymers, as described above. Either synthetic or natural polymers, having the desired viscosity-building effect, can be used in accordance with the present invention.

One common viscosity-building polymer is polyethylene oxide, or PEO. An example of a PEO-enhanced bakery product is described in Example 8.

### EXAMPLE 8

### Polyethylene Oxide

A batter was prepared according to the formula of Tables 20 and 21. The softened chewing gum base was prepared by melting the chewing gum base completely at 200-250° C. Soybean oil and lecithin were added to the chewing gum base, and the mixture was stirred until combined.

TABLE 20
Softened Chewing Gum Base

| Ingredient | Percent | Mass (g) |
|---|---|---|
| Chewing gum base (PERMSOFT ™ chewing | 82.20 | 64.10 |
| gum base, Cafosa, S.A.U., Barcelona, Spain) | | |
| Soybean oil (Cargill, Inc., Wayzata, MN, US) | 13.69 | 10.68 |
| Lecithin (LECIPRIME ™ lecithin, Cargill, Inc., | 4.11 | 3.20 |
| Wayzata, MN, US) | | |
| Total | 100.00 | 77.98 |

TABLE 21
Polyethylene Oxide Treatment

| Ingredient | Percent | Mass (g) |
|---|---|---|
| Corn zein (Freeman Industries LLC, Tuckahoe, NY, US) | 6.81 | 47.90 |
| 75% Aqueous ethanol (EVERCLEAR ® alcohol, Luxco, Inc., St. | 6.81 | 47.90 |
| Louis, MO, US) | | |
| Salt (Cargill, Inc., Wayzata, MN, US) | 0.11 | 0.80 |
| Sugar (Cargill, Inc., Wayzata, MN, US) | 0.11 | 0.80 |
| Softened chewing gum base (from Table 20) | 9.52 | 67.00 |
| Starch* (AYTEX ® P wheat starch, Archer Daniels Midland | 34.11 | 240.00 |
| Company, Decatur, IL, US) | | |
| Glucono delta-lactone (GDL) (PURAC America Inc., | 2.27 | 16.00 |
| Lincolnshire, IL, US) | | |
| Sodium bicarbonate (Church and Dwight Co., Inc., Princeton, | 1.14 | 8.00 |
| NJ, US) | | |
| Water | 35.67 | 251.00 |
| Ammonium bicarbonate (Church and Dwight Co., Inc., | 0.28 | 2.00 |
| Princeton, NJ, US) | | |
| Poly(ethylene oxide) (MW 7 million, 372811, Sigma-Aldrich, | 2.84 | 20.00 |
| Inc., St. Louis, MO, US) | | |
| Diacetyl tartaric acid esters of mono- and diglycerides (Danisco, | 0.14 | 1.00 |
| Ardsley, NY, US) | | |
| Azodicarbonamide ADA-PAR (BENCHMATE ™, Burns Philp | 0.01 | 0.10 |
| Food Inc., Fenton, MO, US) | | |
| Ascorbic Acid PAR-C-120 (BENCHMATE ™, Burns Philp Food | 0.01 | 0.10 |
| Inc., Fenton, MO, US) | | |
| Sodium stearoyl lactylate (Archer Daniels Midland Company, | 0.14 | 1.00 |
| Decatur, IL, US) | | |
| Total | 100.00 | 703.60 |

*Codex wheat starch can be substituted for AYTEX ® P wheat starch.

Zein, salt, and sugar were dissolved in EVERCLEAR® alcohol. The resulting solution was combined with the softened chewing gum base. Cold water was then added to the mixture to precipitate softened chewing gum and zein, until the mixture was no longer sticky (approximately two minutes). The remaining ingredients, except for the chemical leavening agents, were added to the mixture and mixed for 3 minutes on high speed in a KITCHENAID™ Classic mixer with paddle. Finally, the chemical leavening agents were added, and the batter was mixed on high speed for an additional 3 minutes. The resulting batter was sticky.

Approximately 220 g of batter were poured into a pup loaf pan. The batter was proofed to approximately 0.75 inch above the top of the pan, at 115° F. and 85% relative humidity. The batter was subsequently baked for 30 minutes at 430° F.

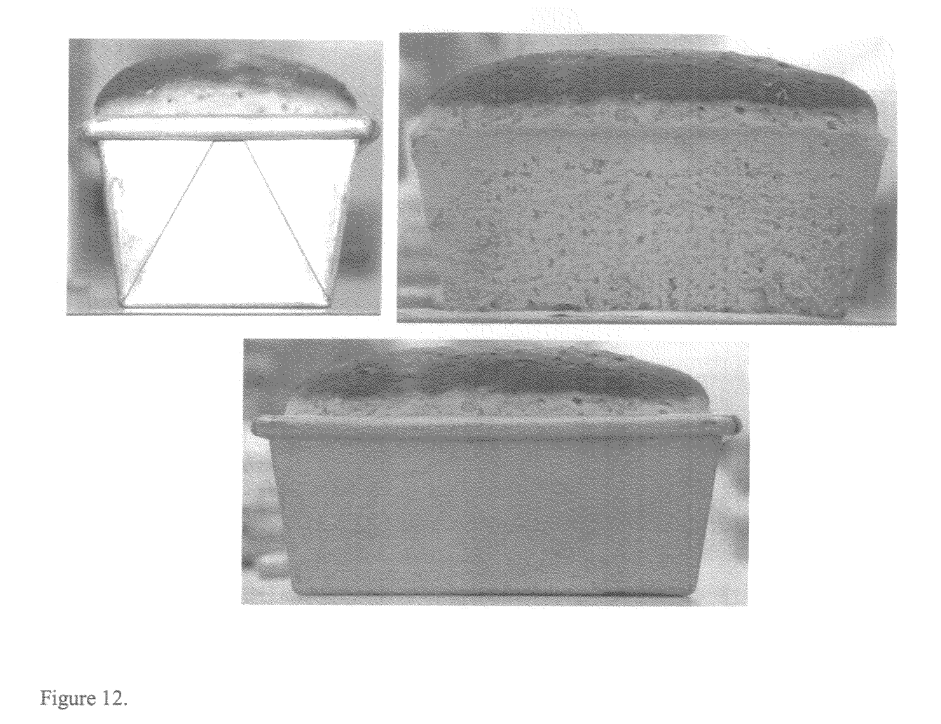

A modest amount of oven spring occurred (FIG. 12). Further optimization of the polymer properties, such as molecular weight, degree of branching, degree of cross-linking, degree of crystallization, and side and/or end group modification, and modifying batter moisture level will likely result in greater oven spring. The final bread specific volume was acceptable (4.3 cc/g). The breadcrumb was soft and chewy. Hydrophilic synthetic polymers like high-molecular-weight PEO function adequately as viscosifiers in bread-making.

### Natural Chewing Gum Base

Other gum bases are suitable for use as the gas-retaining agent of the present invention. Example 9 describes the use of natural chicle gum base and zein as the gluten replacement system.

### EXAMPLE 9

### Natural Chicle Chewing Gum Base

A bread was prepared according to the formula of Tables 22 and 23. The chicle was treated similarly to the synthetic PERMSOFT™ chewing gum base. The softened chewing gum base was prepared by melting the chewing gum base completely at 200-250° C. Soybean oil and lecithin were added to the chewing gum base, and the mixture was stirred until combined.

TABLE 22
Softened Chewing Gum Base

| Ingredient | Percent | Mass (g) |
|---|---|---|
| Chewing gum base (Chicle gum base, Verve, Inc., | 82.20 | 64.10 |
| distributed by Schylling Associates Inc., Rowley, | | |
| MA, US) | | |
| Soybean oil (Cargill, Inc., Wayzata, MN, US) | 13.69 | 10.68 |
| Lecithin (LECIPRIME ™ lecithin, Cargill, Inc., | 4.11 | 3.20 |
| Wayzata, MN, US) | | |
| Total | 100.00 | 77.98 |

TABLE 23
Natural Chicle Chewing Gum Base Treatment

| Ingredient | Percent | Mass (g) |
|---|---|---|
| Corn zein (Freeman Industries LLC, Tuckahoe, NY, US) | 6.12 | 47.90 |
| 75% Aqueous ethanol (EVERCLEAR ® alcohol, Luxco, Inc., St. | 6.12 | 47.90 |
| Louis, MO, US) | | |
| Salt (Cargill, Inc., Wayzata, MN, US) | 0.10 | 0.80 |
| Sugar (Cargill, Inc., Wayzata, MN, US) | 0.10 | 0.80 |
| Softened chewing gum base (from Table 22) | 8.56 | 67.00 |
| Starch* (AYTEX ® P wheat starch, Archer Daniels Midland | 30.67 | 240.00 |
| Company, Decatur, IL, US) | | |
| Glucono delta-lactone (GDL) (PURAC America Inc., | 2.04 | 16.00 |
| Lincolnshire, IL, US) | | |
| Sodium bicarbonate (Church and Dwight Co., Inc., Princeton, | 1.02 | 8.00 |
| NJ, US) | | |
| Water | 43.44 | 340 |
| Ammonium bicarbonate (Church and Dwight Co., Inc., | 0.26 | 2.00 |
| Princeton, NJ, US) | | |
| HPMC (METHOCEL ® K4M, Dow Chemical Co., Midland, | 0.00 | 0.00 |
| MI, US) | | |
| MC (METHOCEL ® A4M, Dow Chemical Co., Midland, MI, | 0.00 | 0.00 |
| US) | | |
| Xanthan Gum (KELTROL ® HP, CP Kelco, Chicago, IL, US) | 1.28 | 10.00 |
| Diacetyl tartaric acid esters of mono- and diglycerides (Danisco, | 0.13 | 1.00 |
| Ardsley, NY, US) | | |
| Azodicarbonamide ADA-PAR (BENCHMATE ™, Burns Philp | 0.01 | 0.10 |
| Food Inc., Fenton, MO, US) | | |
| Ascorbic Acid PAR-C-120 (BENCHMATE ™, Burns Philp Food | 0.01 | 0.10 |
| Inc., Fenton, MO, US) | | |
| Sodium stearoyl lactylate (Archer Daniels Midland Company, | 0.13 | 1.00 |
| Decatur, IL, US) | | |
| Total | 100.00 | 782.6 |

*Codex wheat starch can be substituted for AYTEX ® P wheat starch.

Zein, salt, and sugar were dissolved in EVERCLEAR® alcohol. The resulting solution was combined with the softened chewing gum base. Cold water was then added to the mixture to precipitate softened chewing gum and zein, until the mixture was no longer sticky (approximately two minutes). The remaining ingredients, except for the chemical leavening agents, were added to the mixture and mixed for 3 minutes on high speed in a KITCHENAID™ Classic mixer with paddle. Finally, the chemical leavening agents were added, and the dough was mixed on high speed for an additional 3 minutes. The resulting dough was sticky.

Approximately 220 g of dough were poured into a pup loaf pan. The batter was proofed to approximately 1 inch above the top of the pan, at 115° F. and 85% relative humidity. The dough was subsequently baked for 30 minutes at 430° F.

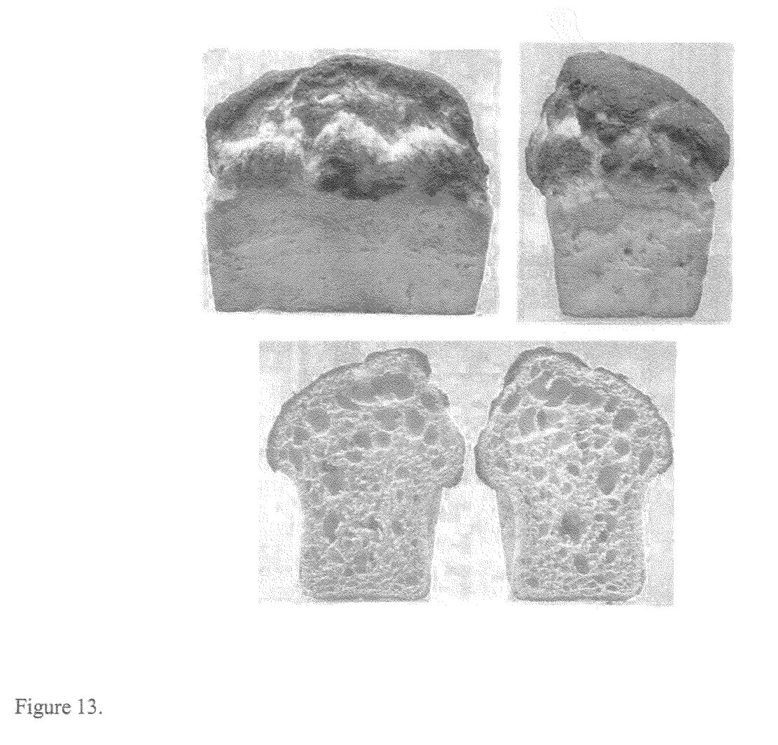

A significant amount of oven spring occurred. The specific volume of the bread was 5.7 cc/g (FIG. 13). The bread remained soft and stable (set) for at least 24 hours after baking.

### Aqueous Zein

To minimize excessive specific volume and an undesirable yellowish color, ethanol-solubilized zein can be replaced with an aqueous, plasticized zein product, such as AQUA ZEIN NEUTRAL™ solution, which is 10% zein, 75% propylene glycol, and 14% water (available from Freeman Industries LLC, New York). Example 10 describes the use of aqueous zein in the gluten replacement system of the present invention.

### EXAMPLE 10

### Aqueous Zein

A dough was prepared based on the formula of Tables 24 and 25. The softened chewing gum base was prepared by melting the chewing gum base completely at 200-250° C. Soybean oil and lecithin were added to the chewing gum base, and the mixture was stirred until combined.

TABLE 24
Softened Chewing Gum Base

| Ingredient | Percent | Mass (g) |
|---|---|---|
| Chewing gum base (PERMSOFT ™ chewing gum | 82.20 | 64.10 |
| base, Cafosa, S.A.U., Barcelona, Spain) | | |
| Soybean oil (Cargill, Inc., Wayzata, MN, US) | 13.69 | 10.68 |
| Lecithin (LECIPRIME ™ lecithin, Cargill, Inc., | 4.11 | 3.20 |
| Wayzata, MN, US) | | |
| Total | 100.00 | 77.98 |

TABLE 25
Aqueous Zein

| Ingredient | Percent | Mass (g) |
|---|---|---|
| AQUA ZEIN NEUTRAL ™ solution (Freeman Industries LLC, | 6.52 | 47.90 |
| Tuckahoe, NY, US) | | |
| Salt (Cargill, Inc., Wayzata, MN, US) | 0.11 | 0.80 |
| Sugar (Cargill, Inc., Wayzata, MN, US) | 0.11 | 0.80 |
| Softened chewing gum base (from Table 24) | 9.12 | 67.00 |
| Starch* (AYTEX ® P wheat starch, Archer Daniels Midland | 32.67 | 240.00 |
| Company, Decatur, IL, US) | | |
| Glucono delta-lactone (GDL) (PURAC America Inc., | 2.18 | 16.00 |
| Lincolnshire, IL, US) | | |
| Sodium bicarbonate (Church and Dwight Co., Inc., Princeton, | 1.09 | 8.00 |
| NJ, US) | | |
| Water | 46.28 | 340 |
| Ammonium bicarbonate (Church and Dwight Co., Inc., | 0.27 | 2.00 |
| Princeton, NJ, US) | | |
| MC (METHOCEL ® A4M, Dow Chemical Co., Midland, MI, | 1.36 | 10.00 |
| US) | | |
| Diacetyl tartaric acid esters of mono- and diglycerides (Danisco, | 0.14 | 1.00 |
| Ardsley, NY, US) | | |
| Azodicarbonamide ADA-PAR (BENCHMATE ™, Burns Philp | 0.01 | 0.10 |
| Food Inc., Fenton, MO, US) | | |
| Ascorbic Acid PAR-C-120 (BENCHMATE ™, Burns Philp Food | 0.01 | 0.10 |
| Inc., Fenton, MO, US) | | |
| Sodium stearoyl lactylate (Archer Daniels Midland Company, | 0.14 | 1.00 |
| Decatur, IL, US) | | |
| Total | 100.00 | 772.6 |

*Codex wheat starch can be substituted for AYTEX ® P wheat starch.

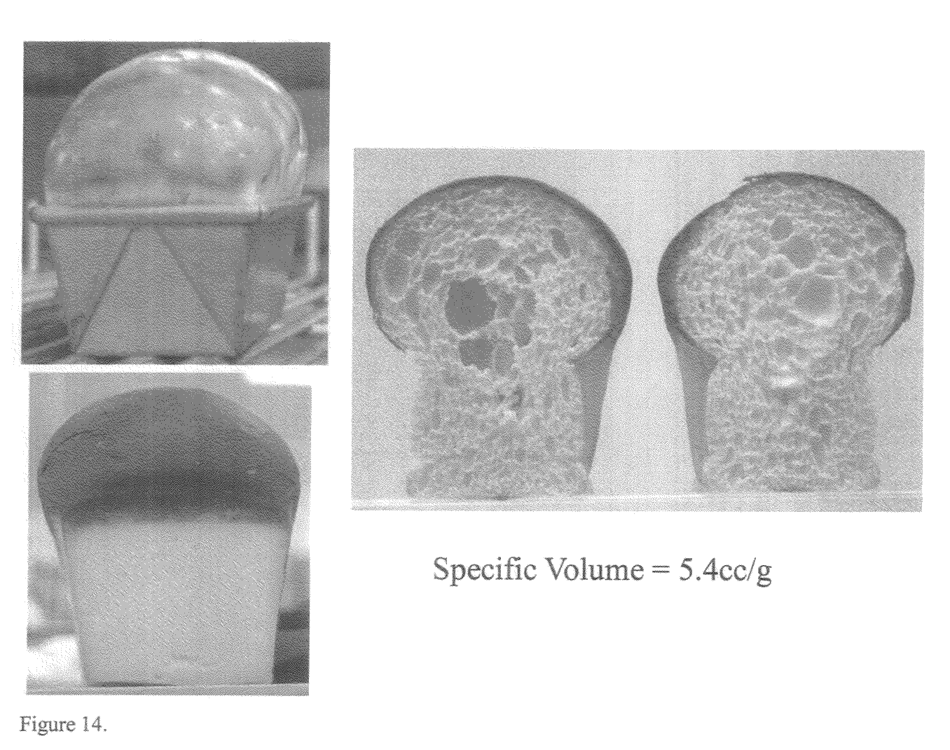

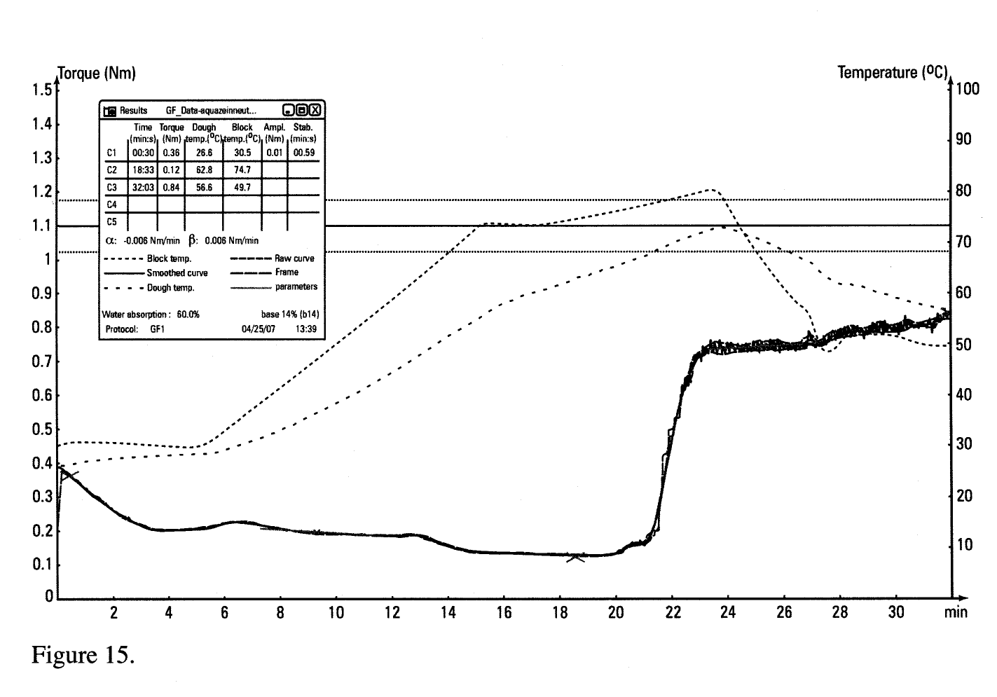

The aqueous zein was combined with the softened chewing gum base by mixing on high speed for 1 minute in a KITCHENAID™ Classic mixer with a paddle, and then precipitated in cold water for 2 minutes. The dough was prepared with the remaining ingredients, and was baked into a loaf for 30 minutes at 430° F. The resulting bread had a specific volume of 5.4 cc/g, and is shown in FIG. 14. A MIXOLAB™ curve of a dough prepared according to the formula of Tables 24 and 25 is shown in FIG. 15.

It was discovered that the pH of all dough formulations can be lowered to reduce loaf browning by reducing the amount of sodium bicarbonate and ammonium bicarbonate, such as by one-half.

In addition, there are other ways to plasticize zein and thereby eliminate ethanol from the formulation. In particular, glycerol and lactic acid each work well when followed by cold-water precipitation. Glycerol results in a more soluble zein than lactic acid, but the lactic acid is in an 85% aqueous solution. A combination of 50:50 glycerol:lactic acid solution (aqueous) can be used to plasticize zein. Cold-water precipitation of the resulting mass provides a material with viscoelastic properties that are similar to, but weaker than, gluten. The material traps gas and hardens upon heating.

### Yeast-Leavened Products

By eliminating the ethanol from the formula as described above, it is possible to use yeast as the leavening agent, either alone or in combination with chemical leavening agents. The use of yeast in the dough formulation results in the desired properties associated with a yeast-leavened product, such as flavor and aroma. Example 11 describes a yeast-leavened gluten-free bakery product made in accordance with the present invention.

### EXAMPLE 11

### Yeast-Leavened Dough

A dough was made in accordance with the formula in Tables 26 and 27. The softened chewing gum base was prepared by melting the chewing gum base completely at 200-250° C. Soybean oil and lecithin were added to the chewing gum base, and the mixture was stirred until combined.

TABLE 26
Softened Chewing Gum Base

| Ingredient | Percent | Mass (g) |
|---|---|---|
| Chewing gum base (PERMSOFT ™ chewing gum | 82.20 | 64.10 |
| base, Cafosa, S.A.U., Barcelona, Spain) | | |
| Soybean oil (Cargill, Inc., Wayzata, MN, US) | 13.69 | 10.68 |
| Lecithin (LECIPRIME ™ lecithin, Cargill, Inc., | 4.11 | 3.20 |
| Wayzata, MN, US) | | |
| Total | 100.00 | 77.98 |

TABLE 27
Yeast Treatment

| Ingredient | Percent | Mass (g) |
|---|---|---|
| AQUA ZEIN NEUTRAL ™ solution (Freeman Industries LLC, | 7.11 | 47.90 |
| Tuckahoe, NY, US) | | |
| Compressed yeast (Baker's Select, FLEISCHMANN'S ® Yeast, | 3.71 | 25.00 |
| AB Mauri Food Inc., Chesterfield, MO, US) | | |
| Salt (Cargill, Inc., Wayzata, MN, US) | 0.18 | 1.20 |
| Dextrose (Cargill, Wayzata) | 3.71 | 25.00 |
| Softened chewing gum base (from Table 26) | 9.95 | 67.00 |
| Starch* (AYTEX ® P wheat starch, Archer Daniels Midland | 35.64 | 240.00 |
| Company, Decatur, IL, US) | | |
| Water | 37.13 | 250.00 |
| MC (METHOCEL ® A4M, Dow Chemical Co., Midland, MI, | 1.04 | 7.00 |
| US) | | |
| Xanthan Gum (KELTROL ® HP, CP Kelco, Chicago, IL, US) | 1.19 | 8.00 |
| Diacetyl tartaric acid esters of mono- and diglycerides (Danisco, | 0.15 | 1.00 |
| Ardsley, NY, US) | | |
| Azodicarbonamide ADA-PAR (BENCHMATE ™, Burns Philp | 0.01 | 0.10 |
| Food Inc., Fenton, MO, US) | | |
| Ascorbic Acid PAR-C-120 (BENCHMATE ™, Burns Philp Food | 0.01 | 0.10 |
| Inc., Fenton, MO, US) | | |
| Sodium stearoyl lactylate (Archer Daniels Midland Company, | 0.15 | 1.00 |
| Decatur, IL, US) | | |
| Total | 100.00 | 673.3 |

*Codex wheat starch can be substituted for AYTEX ® P wheat starch.

The softened chewing gum base was combined with AQUA ZEIN NEUTRAL™ solution by mixing for 1 minute on high speed in a KITCHENAID™ Classic mixer with paddle. Cold water was then added to the mixture to precipitate softened chewing gum and zein, until the mixture was no longer sticky (approximately two minutes). The remaining ingredients, except for the yeast, were added to the mixture and mixed with the paddle for 3 minutes on high speed in a KITCHENAID™ Classic mixer. Finally, the yeast was added, and the dough was mixed on high speed for an additional 3 minutes. The resulting dough was sticky, and had a very light color.

Approximately 220 g of dough were poured into a pup loaf pan. The batter was proofed to approximately 1 inch above the top of the pan, at 115° F. and 85% relative humidity. The dough was subsequently baked for 30 minutes at 430° F.

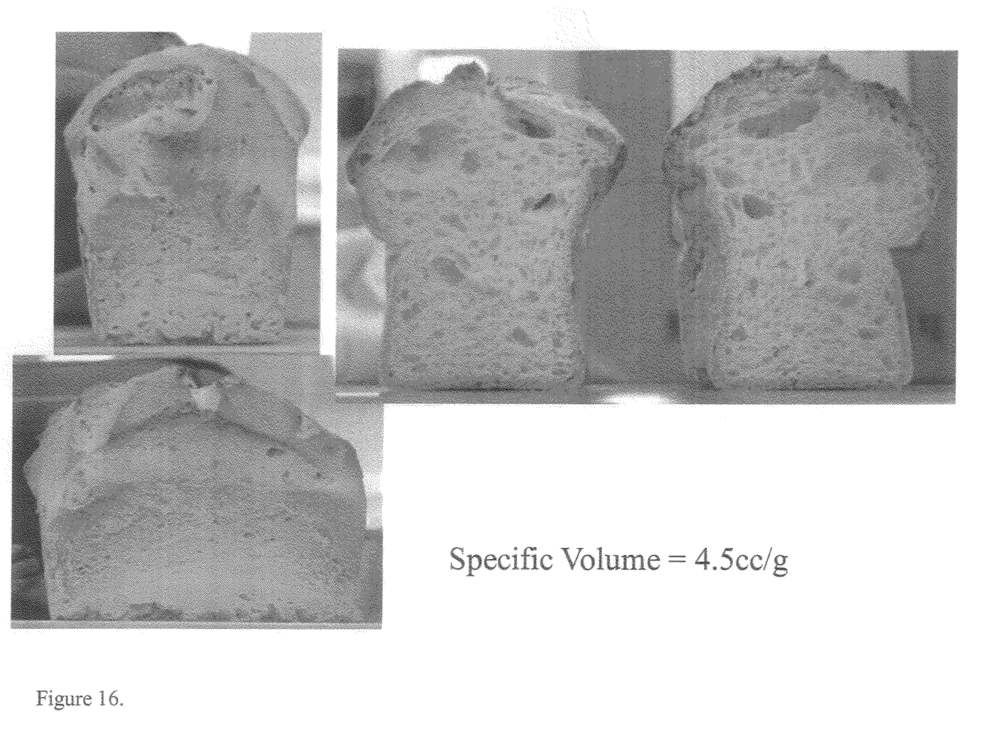

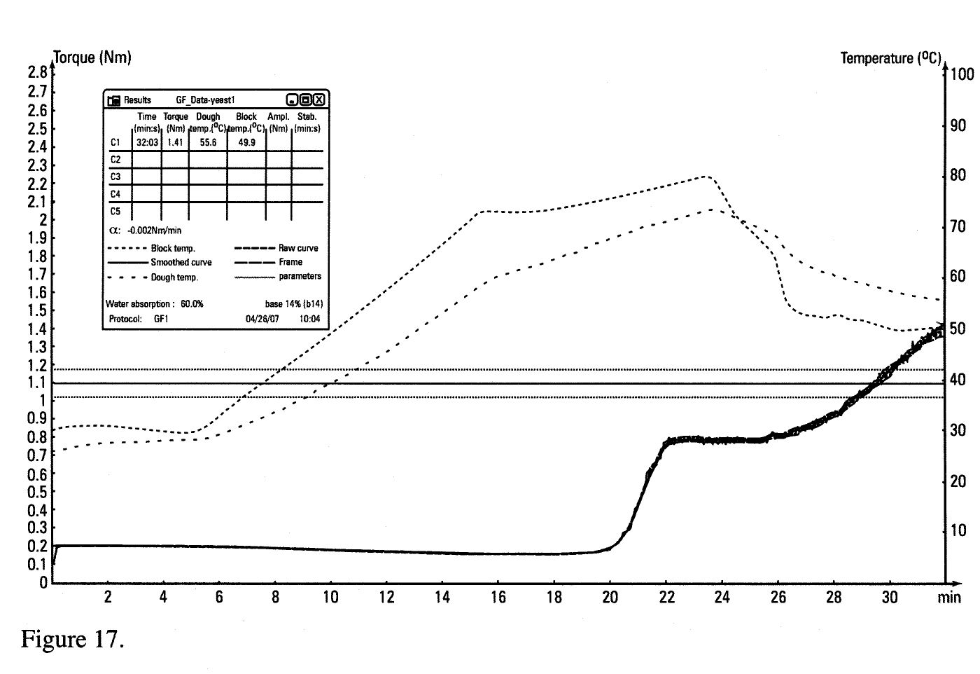

This treatment proofed to height and had oven spring. The specific volume of the bread was 4.5 cc/g, which was acceptable. Views of the bread are shown in FIG. 16. A MIXOLAB™ curve of a dough prepared according to the formula of Tables 26 and 27 is shown in FIG. 17.

### X-Ray Analysis of Gluten-Free Bread

In order to evaluate the crumb structures of bread samples, x-ray tomography (X-ray CAT) was used. X-ray CAT is a non-destructive analytical method that utilizes the penetration of x-rays to probe internal structures of cell wall materials. Depending on the structure, x-rays are absorbed and/or scattered resulting in density variations.

In tomography, two-dimensional (2D) image planes are collected as the sample is rotated. The series of collected image planes are then processed using an algorithm designed to convert the series of 2D transmission images into structural images in the orthogonal plane. The 2D image slices may then be reconstructed into a 3D volumetric rendering of the object, where the gray scale intensity at a given volumetric element (voxel) is inversely proportional to the density of the material contained in that voxel. The acquisition and reconstruction of image data to generate a 3D representation of a sample is known as computer aided tomography (CAT).

Seven loaves of bread (2 commercial breads and 5 bread products made in accordance with the present invention) were evaluated. The samples were prepared from frozen loaves that were sectioned into approximately 1 cm×1 cm×1 cm cubes with a sharp blade. Three or four replicates of each sample in size were analyzed. All data were collected on a SkyScan X-ray Tomograph (SkyScan, Kontich, Belgium).

The samples were exposed to 80 keV x-rays. Images were collected using 20× magnification and then compiled using the manufacturer's software. Top-down composite images were used for quantification and analyzed through a z-series for each sample. With the exception of sample 4, the voxel size is 15 μm×15 μm×30 μm. Sample 4 was run at a voxel size of 19 μm×19 μm×38 μm. All of the data collected was statistically significant. The average values for the replicates were used for analysis.

To calculate the average cell diameter, the software inserts an imaginary sphere into each structure and expands it until it touches the edges. The diameter of this sphere was then measured and reported as the size of the feature. The average cell wall thickness was extracted by analyzing the grayscale image and then scoring each pixel between 0 (white) and 255 (black). The same threshold was applied to all of the samples. When there was more than one bin tied for the mode, the higher of the two was taken.

Average cell diameters and cell wall thicknesses, and the standard deviations, were calculated and are shown in Table 28.

TABLE 28

| | Cell wall | | Cell wall | |
|---|---|---|---|---|
| | diameter | Std. | thickness | Std. |
| Sample | (μm) | dev. | (μm) | dev. |
| WONDER ® Classic | 117 | 5.8 | 147 | 4.5 |
| white bread | | | | |
| Levain artisan bread (Rustica, | 264 | 3.5 | 264 | 1.7 |
| L.L.C., Minneapolis, MN, US) | | | | |
| Example 2 | 59 | 6.0 | 205 | 3.4 |
| Example 3 | 117 | 4.5 | 264 | 2.0 |
| Treatment 1 | | | | |
| Example 3 | 192 | 4.2 | 269 | 3.0 |
| Treatment 3 | | | | |
| Example 10 | 147 | 4.1 | 264 | 2.7 |
| AQUA ZEIN NEUTRAL ™ | | | | |
| Treatment | | | | |
| Example 11 | 205 | 3.0 | 205 | 2.2 |
| Yeast Treatment | | | | |

With the exception of Example 2, the cell size mode of the gluten-free bread products made in accordance with the present invention fall at or between the values of the commercial WONDER® Classic white bread and the commercial artisan bread (Levain artisan bread, Rustica, L.L.C., Minneapolis, Minn., US). Example 2 did not contain the gas-retaining polymer or the gas-setting polymer of the present invention. With the exception of Example 3, Treatment 3, the cell wall thickness mode of the gluten-free bread products of the present invention all fall between the values of the commercial WONDER® Classic white bread and the commercial artisan bread. Example 3, Treatment 3, has slightly different binning mode, and the difference in cell wall thickness is therefore due to the difference in multiplier based on voxel size. This would equate to the 264 μm bin, and is therefore within the range defined by the commercial products. The commercial WONDER® Classic white bread has a comparatively small average cell diameter and thin cell wall, while the commercial artisan bread has a comparatively large average cell diameter and thick cell wall. These two commercial gluten-containing products are examples of the range of acceptable structures of bread products, and the data indicate that the gluten-free bread products made in accordance with the present invention fall within the acceptable ranges of these desired parameters.

### Microscopic Analysis of Gluten-Free Bread

To further elucidate the mechanisms of action of the gluten-replacing system of the present invention, microscopic analysis was conducted on several control products that contain gluten, and on gluten-free products made in accordance with the present invention.

As discussed previously, gluten provides both the strength and flexibility to stabilize gas cells in the dough as the ingredients are being mixed, and provides the continuous phase in the final product as the dough is baked and the gluten undergoes strain hardening. To provide a suitable gluten-free product, such as a bakery product, it is therefore desirable to replicate these different and important functions of gluten.

While not intending to be bound by theory, it is believed that the polymeric setting agent, such as zein, helps to create and stabilize air cells within the dough matrix. It is believed that zein, hydrated hydrocolloids like xanthan, or other setting agents that are hydrophobic in nature are conducive to the formation of cells, as air is also believed to be hydrophobic.

The gas-retaining polymer, such as chewing gum base, is believed to contribute to the amorphous continuous or semi-continuous phase. Histological analysis has demonstrated that the chewing gum base exists as an amorphous form in the gluten-free products of the present invention. This amorphous form of the chewing gum base makes up the substantially continuous phase of the product and provides the functionality of the chewing gum base in a gluten replacement system of the present invention.

To evaluate the gluten-free products of the present invention, light microscopy was used to differentiate and identify various regions of the product. To prepare the samples for sectioning, the following method was developed. The bread was stored in the freezer (18° C.) until it was frozen. The bread was then removed from the freezer and cut with a sharp razor blade into cubes 5-10 mm per dimension. Then a section ˜2 mm thick was sliced from a flat face. The section was then placed in the bottom of an intermediate size plastic TISSUE-TEK® CRYOMOLD® mold (Electron Microscopy Sciences, Hatfield, Pa., US). TISSUE-TEK® O.C.T. compound (Electron Microscopy Sciences, Hatfield, Pa., US) was used to cover the sample. A thin piece of cork (1-2 mm) was used to seal the bread-O.C.T. inside the CRYOMOLD® mold. The CRYOMOLD® mold and its contents were left at room temperature for 15 minutes to allow the O.C.T. to infuse into the bread matrix. It was then frozen to −20° C. and sectioned into 10 micron sections. FROSTBITES coolant (Surgipath Medical Industries, Inc., Richmond, Ill., US) was used to freeze the newly exposed surface immediately before sectioning (this was critical for the samples containing chewing gum base); otherwise, the sample would deform while being sectioned. COLORMARK™ Plus slides (available from Triangle Biomedical Sciences, Durham, N.C., US) were used. The positive charge of the slide encouraged adhesion between the microtomed bread section and glass microscope slide. After sectioning, samples were stored in the refrigerator. Prior to staining, the samples were removed from the refrigerator and allowed to equilibrate to room temperature. Iodine and methylene blue, polychromatic stains, were used to stain individual components within the bread samples. Dilute 1N iodine solution was utilized to differentiate starch, zein, and xanthan gun. Similarly, dilute 1% solution of methylene blue stain was employed to visualize xanthan gum and amorphous regions of the gum base. COVERWELL™ imaging chambers (Electron Microscopy Sciences, Hatfield, Pa., US) were used to contain the sections and any applied liquids or stains.

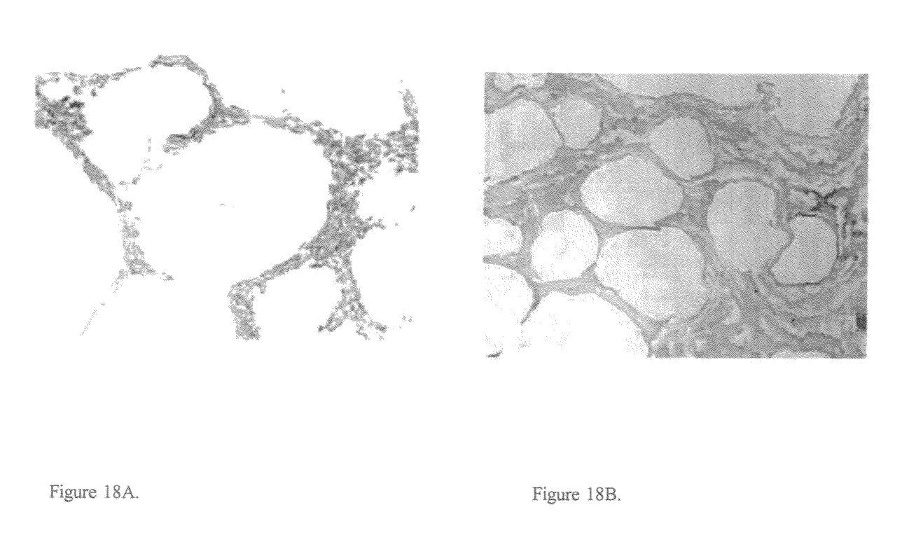

FIGS. 18A and 18B show light microscope images of iodine-stained gluten-containing commercial breads. FIG. 18A is an image of WONDER® Classic white bread, and FIG. 18B is an image of a gluten-containing artisan bread (Levain artisan bread, Rustica, L.L.C., Minneapolis, Minn., US).

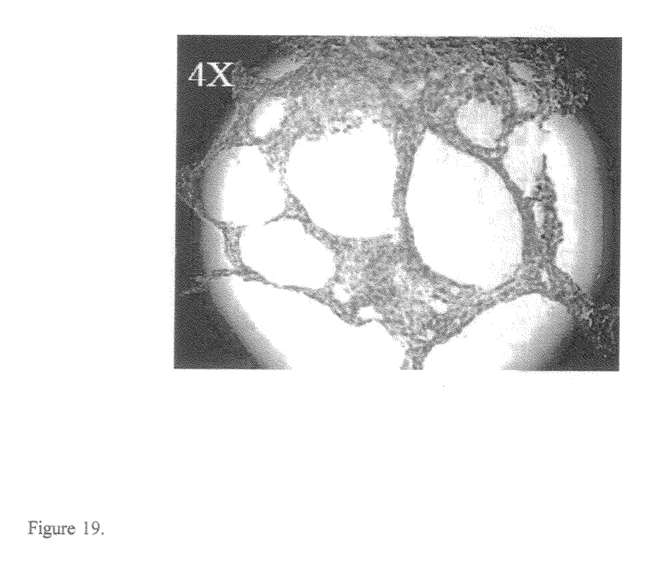

FIG. 19 shows a light microscope image of iodine-stained gluten-free bread made in accordance with the present invention. As can be seen from this figure, the gluten replacement system of the present invention results in a product having a structure at the microscopic level that is very similar to that of a gluten-containing product shown in FIGS. 18A and 18B. Further histological analysis of the product shown in FIG. 19 confirmed that the air cell wall contains primarily zein, and that the continuous regions are primarily made up of the chewing gum base in its amorphous form.

As discussed above, products made in accordance with the present invention are made with non-glutenaceous ingredients, and are therefore suitable for use by those individuals with gluten allergic, intolerant or sensitive disorders, and by those who are on a gluten-free diet for medical or non-medical reasons. The products of the present invention enable such individuals to manage or treat their gluten-related symptoms, and enable them to enjoy nutritious, organoleptically pleasing food products that very closely resemble gluten-containing products, while maintaining a gluten-free diet.

### EXAMPLE 12

### Gluten-free Bread Containing Powdered Chewing Gum Base

It has been surprisingly discovered that chewing gum base when ground finely or cryoground can be incorporated homogenously into bread with no prior or additional manipulations such as the addition of heat. When chewing gum base is heated, it can create malodors and flavors. These characteristics are minimized when the chewing gum base is finely ground or cryoground. This was true for both ground gum base and powered gum base. In this example, the particle size of the ground gum base was largely between 283 and 340 micrometers. In other embodiments, the particle size of the ground gum base may be less than 5 mm, such as less than 2 mm, or less than 0.5 mm.

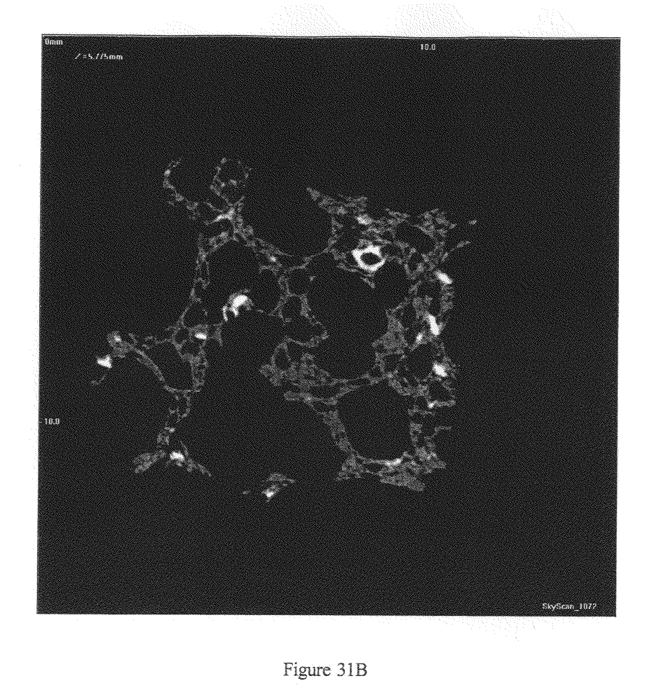

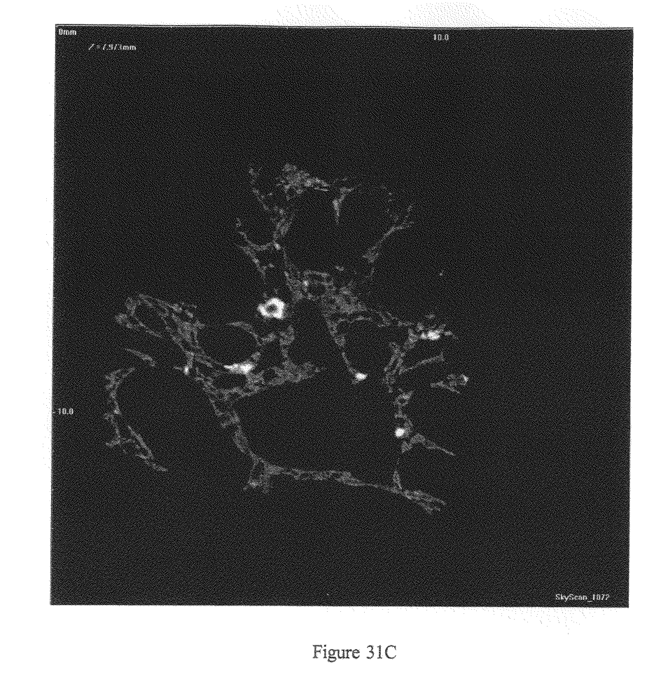

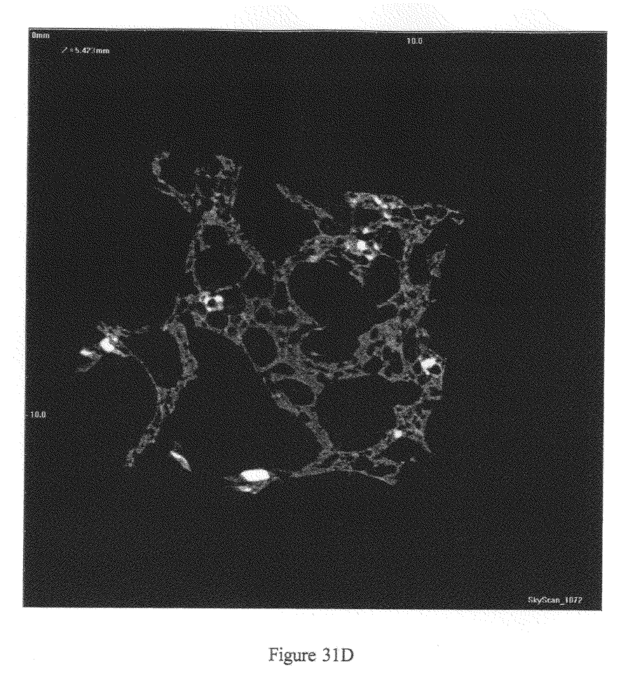

The inventors also used DSC (differential scanning calorimetry) to study the thermal transitions of the gum base. There was a transition at 122° F., well within the temperatures the bread is exposed to during baking (bread has to reach 212° F. to liberate the water). While not being bound by theory, the results suggest that at this transition the gum softens enough to spread out and coat some of the air cells (as shown in FIGS. 31A-31D).

Gum base is received from the manufacturer as a slab or sheet and ground finely using a mechanical grinder such as a cryogrinder. Powdered gum base is received from the manufacturer in powdered form. The benefits of incorporating gum homogeneously into bread include an increased bread chewiness, increased mouth residence time and a finer (lacier) crumb texture. This is due for the most part to the hydrophobic character of the polymers in gum. Hydrophobicity is a key attribute of rubbery character and in turn bread chewiness. Mouth residence time depends on rate of solubilization and hydrophobic polymers solubilized extremely slowly if at all, hence the longer mouth residence time. And finally, air cells are more stable in a hydrophobic environment. The gum provides this environment and also acts as a reinforcing air cell wall. Reinforcing even a limited number of air cells with hydrophobic gum base increases bread chewiness, mouth residence time, and air cell stability (the crumb is finer).

The present goal was to create more centers of hydrophobicity to enhance the performance of this bread. To do this, the inventors focused on two key factors, increasing the dispersion uniformity of the gum base particles and maximizing the hydrophobic environment each gum base particle can influence. Variations in particle size and melting/softening point were investigated to build a gum base that has the ability to reach maximum functionality during the proofing and baking process.

Ground Gum Base (Permsoft™) Level Study, No Zein, with Soybean Oil and Lecithin

A level study using three levels of gum base (50%, 75% and 90% reduction in gum base as described in Example 3, Table 5 above) was performed. The formula and method are listed in Tables 29-31 below.

TABLE 29

| Ingredient | Mass (g) |
|---|---|
| Powdered chewing gum base (PERMSOFT ™ chewing gum base, Cafosa, | 32.000 |
| S.A.U., Barcelona, Spain) | |
| Soy bean oil (Cargill, Inc., Wayzata, MN, US) | 10.680 |
| Lecithin (LECIPRIME ™ lecithin, Cargill, Inc., Wayzata, MN, US) | 3.200 |
| Salt (Cargill, Inc., Wayzata, MN, US) | 0.800 |
| Sugar (Cargill, Inc., Wayzata, MN, US) | 0.800 |
| Wheat starch (AYTEX-P, Archer Daniels Midland Company, Decatur, IL, | 240.000 |
| US) | |
| Xanthan gum (Satiaxine CX91, Cargill, Inc., Wayzata, MN, US) | 10.000 |
| glucano delta-lactone (GDL) (PURAC America Inc., Lincolnshire, IL, US) | 16.000 |
| sodium bicarbonate (soda) | 8.000 |
| ammonium bicarbonate (Church and Dwight Co., Inc., Princeton, NJ, US) | 2.000 |
| water (ice cold) | 340.000 |
| diacetyl tartaric acid esters of mono- and diglycerides (DATEM) (Danisco, | 1.000 |
| Ardsley, MY, US) | |
| azodicarbonamide ADA-PAR (BENCHMATE ™, Burns Philp Food, Inc., | 0.100 |
| Fenton, MO, US) | |
| ascorbic acid PAR-C-120 (BENCHMATE ™, Burns Philp Food, Inc., | 0.1000 |
| Fenton, MO, US) | |
| sodium stearoyl lactylate (SSL) (Archer Daniels Midland Company, Decatur, | 1.000 |
| IL, US) | |
| TOTAL | 665.680 |

For the formula of Table 29, the following process was followed. Salt and sugar were added to the starch mixture and stirred with a wooden stick. Soybean oil and lecithin were added to the ground gum base and stirred with a wooden stick. Approximately ⅔ of the water was added to the bowl of a KitchenAid™ mixer, and then approximately ⅔ of the starch mixture was added and kneaded by hand. The gum base mixture was added to the bowl and stirred with a wooden stick. The remaining water and starch mixture was added to the bowl and the mixer was turned on (set to speed 6). The batter was mixed for 10 minutes, stopping the mixer once to scrape the bowl. After 10 minutes, the leavening agents (listed in Table 29 in italics) were added and the batter mixed for an additional 3 minutes. 220 g of the batter were weighed into a pup loaf pan and the top of the batter was smoothed with a stick. The batter was proofed to 1 inch above the top of the pan (approximately 38 minutes) at 113° F./78% RH and then baked for 38 minutes at 430° F.

TABLE 30

| Ingredient | Mass (g) |
|---|---|
| Powdered chewing gum base (PERMSOFT ™ chewing gum base, Cafosa, | 16.000 |
| S.A.U., Barcelona, Spain) | |
| Soy bean oil (Cargill, Inc., Wayzata, MN, US) | 10.680 |
| Lecithin (LECIPRIME ™ lecithin, Cargill, Inc., Wayzata, MN, US) | 3.200 |
| Salt (Cargill, Inc., Wayzata, MN, US) | 0.800 |
| Sugar (Cargill, Inc., Wayzata, MN, US) | 0.800 |
| Wheat starch (AYTEX-P, Archer Daniels Midland Company, Decatur, IL, | 240.000 |
| US) | |
| Xanthan gum (Satiaxine CX91, Cargill, Inc., Wayzata, MN, US) | 10.000 |
| glucano delta-lactone (GDL) (PURAC America Inc., Lincolnshire, IL, US) | 16.000 |
| sodium bicarbonate (soda) | 8.000 |
| ammonium bicarbonate (Church and Dwight Co., Inc., Princeton, NJ, US) | 2.000 |
| water (ice cold) | 340.000 |
| diacetyl tartaric acid esters of mono- and diglycerides (DATEM) (Danisco, | 1.000 |
| Ardsley, MY, US) | |
| azodicarbonamide ADA-PAR (BENCHMATE ™, Burns Philp Food, Inc., | 0.100 |
| Fenton, MO, US) | |
| ascorbic acid PAR-C-120 (BENCHMATE ™, Burns Philp Food, Inc., | 0.100 |
| Fenton, MO, US) | |
| sodium stearoyl lactylate (SSL) (Archer Daniels Midland Company, Decatur, | 1.000 |
| IL, US) | |
| TOTAL | 649.680 |

For the formula of Table 30, the following process was followed. Salt and sugar were added to the starch mixture and stirred with a wooden stick. Soybean oil and lecithin were added to the ground gum base and stirred with a wooden stick. Approximately ⅔ of the water was added to the bowl of a KitchenAid™ mixer, and then gum base mixture was added and kneaded by hand. Approximately ⅔ of the starch mixture was added to the bowl and stirred with a wooden stick. The remaining water and starch mixture was added to the bowl and the mixer was turned on (set to speed 6). The batter was mixed for 10 minutes, stopping the mixer once to scrape the bowl. After 10 minutes, the leavening agents (listed in Table 30 in italics) were added and the batter mixed for an additional 3 minutes. 220 g of the batter were weighed into a pup loaf pan and the top of the batter was smoothed with a stick. The batter was proofed to 1 inch above the top of the pan (approximately 27 minutes) at 113° F./78% RH and then baked for 29 minutes at 430° F.

TABLE 31

| Ingredient | Mass (g) |
|---|---|
| Powdered chewing gum base (PERMSOFT ™ chewing gum base, Cafosa, | 6.400 |
| S.A.U., Barcelona, Spain) | |
| Soy bean oil (Cargill, Inc., Wayzata, MN, US) | 10.680 |
| Lecithin (LECIPRIME ™ lecithin, Cargill, Inc., Wayzata, MN, US) | 3.200 |
| Salt (Cargill, Inc., Wayzata, MN, US) | 0.800 |
| Sugar (Cargill, Inc., Wayzata, MN, US) | 0.800 |
| Wheat starch (AYTEX-P, Archer Daniels Midland Company, Decatur, IL, | 240.000 |
| US) | |
| Xanthan gum (Satiaxine CX91, Cargill, Inc., Wayzata, MN, US) | 10.000 |
| glucano delta-lactone (GDL) (PURAC America Inc., Lincolnshire, IL, US) | 16.000 |
| sodium bicarbonate (soda) | 8.000 |
| ammonium bicarbonate (Church and Dwight Co., Inc., Princeton, NJ, US) | 2.000 |
| water (ice cold) | 340.000 |
| diacetyl tartaric acid esters of mono-and diglycerides (DATEM) (Danisco, | 1.000 |
| Ardsley, MY, US) | |
| azodicarbonamide ADA-PAR (BENCHMATE ™, Burns Philp Food, Inc., | 0.100 |
| Fenton, MO, US) | |
| ascorbic acid PAR-C-120 (BENCHMATE ™, Burns Philp Food, Inc., | 0.100 |
| Fenton, MO, US) | |
| sodium stearoyl lactylate (SSL) (Archer Daniels Midland Company, Decatur, | 1.000 |
| IL, US) | |
| TOTAL | 640.080 |

For the formula of Table 31, the following process was followed. Salt and sugar were added to the starch mixture and stirred with a wooden stick. Soybean oil and lecithin were added to the ground gum base and stirred with a wooden stick. Approximately ⅔ of the water was added to the bowl of a KitchenAid™ mixer, and then gum base mixture was added and kneaded by hand. Approximately ⅔ of the starch mixture was added to the bowl and stirred with a wooden stick. The remaining water and starch mixture was added to the bowl and the mixer was turned on (set to speed 6). The batter was mixed for 10 minutes, stopping the mixer once to scrape the bowl. After 10 minutes, the leavening agents (listed in Table 31 in italics) were added and the batter mixed for an additional 3 minutes. 220 g of the batter were weighed into a pup loaf pan and the top of the batter was smoothed with a stick. The batter was proofed to 1 inch above the top of the pan (approximately 35 minutes) at 113° F./78% RH and then baked for 31 minutes at 430° F.

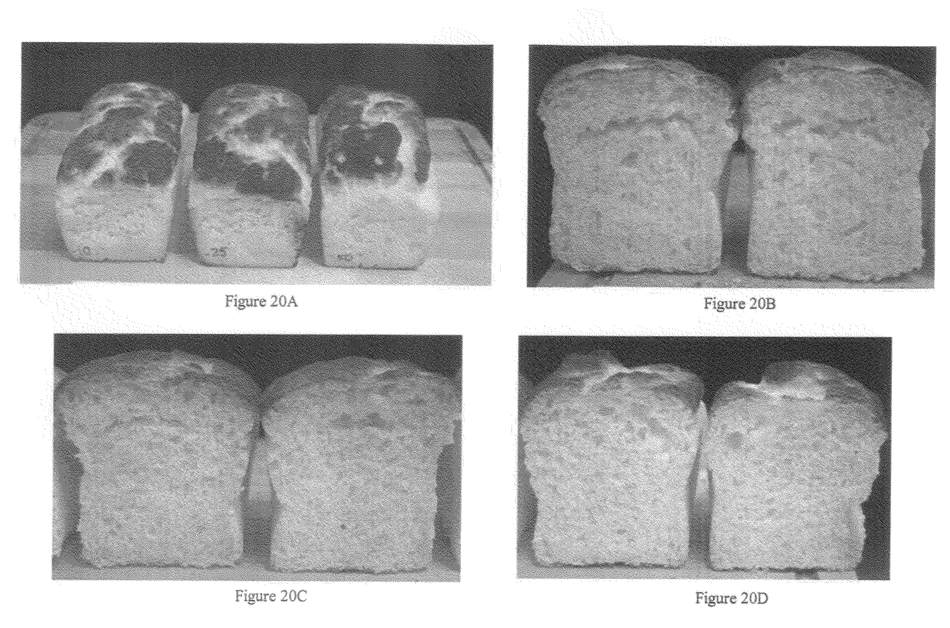

Pictures of the finished breads are shown in FIGS. 20A-D. Differences in taste and texture were detectable among the three breads. While the typical “synthetic, petroleum-like” flavor derived from the gum base polymers was detectable in all three samples, the bread with the lowest level of gum base was the least objectionable, while the formula with the highest amount of gum base had the most objectionable flavor, especially near the end of the residence time in the mouth. The formula used in this experiment has very few ingredients and is intentionally bland. Although these off flavors are detectable, it is likely they can be masked with other flavors. Texture differences between the three breads were also detectable. In general, the ground gum base added resilience and springiness to the crumb. At the lowest level of gum base, this effect was the smallest and possibly inadequate, suggesting the next highest level of ground gum base may be best in attaining desirable texture while minimizing the concentration of the gum base.

The crumb structure of the resulting bread was quite similar to a gluten-containing white pan bread (small cell size and lacy). There also seemed to be some directionality in the crumb. Additionally, the crumb had a resiliency that can be likely attributed to the presence of the hydrophobic polymers in the gum base. The gum particles were well distributed during mixing but some discreet particles were observed in the batter; however upon baking, they were not distinguishable to the naked eye. Furthermore, no grainy or gritty texture was detected upon eating, suggesting the gum base particles may have softened or melted during baking. Crumb color for all three samples was desirable (white to slightly off-white). The crust color was too dark and had an unnatural appearance due to an imbalance brought about by the chemical leaving system. All three of the breads set adequately despite the absence of zein, suggesting that the wheat starch, hydrocolloids and gum base kept the matrix intact, minimizing keyholing and preventing catastrophic collapse.

### EXAMPLE 13

### Gluten-free Bread Containing Ground Gum Base (Permsoft™), Zein, Soybean Oil and Lecithin

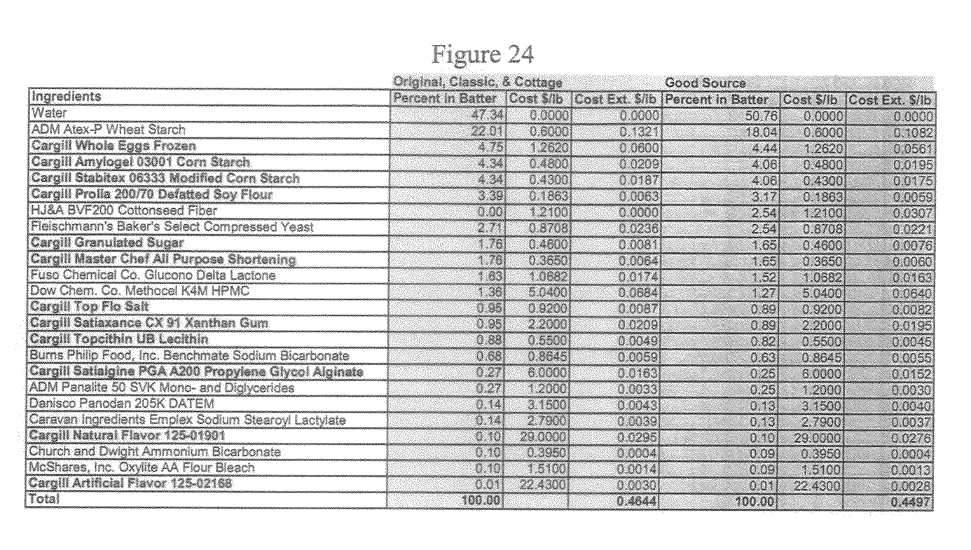

This example demonstrates the use of zein in the presence of ground gum base. The formula and method are listed in FIG. 24.

TABLE 32

| Ingredient | Mass (g) |
|---|---|
| Powdered chewing gum base (PERMSOFT ™ chewing gum base, Cafosa, | 64.100 |
| S.A.U., Barcelona, Spain) | |
| Soy bean oil (Cargill, Inc., Wayzata, MN, US) | 10.680 |
| Lecithin (LECIPRIME ™ lecithin, Cargill, Inc., Wayzata, MN, US) | 3.200 |
| Corn Zein (Freeman Industries, LLC, Tuckahoe, NY, US) | 47.900 |
| Salt (Cargill, Inc., Wayzata, MN, US) | 0.800 |
| Sugar (Cargill, Inc., Wayzata, MN, US) | 0.800 |
| 75% aqueous ethanol (EVERCLEAR alcohol, Luxco Inc. St. Louis, MO, | 47.900 |
| US) | |
| Wheat starch (AYTEX-P, Archer Daniels Midland Company, Decatur, IL, | 240.000 |
| US) | |
| Xanthan gum (Satiaxine CX91, Cargill, Inc., Wayzata, MN, US) | 10.000 |
| glucano delta-lactone (GDL) (PURAC America Inc., Lincolnshire, IL, US) | 16.000 |
| sodium bicarbonate (soda) | 8.000 |
| ammonium bicarbonate (Church and Dwight Co., Inc., Princeton, NJ, US) | 2.000 |
| water (ice cold) | 340.000 |
| diacetyl tartaric acid esters of mono-and diglycerides (DATEM) (Danisco, | 1.000 |
| Ardsley, MY, US) | |
| azodicarbonamide ADA-PAR (BENCHMATE ™, Burns Philp Food, Inc., | 0.100 |
| Fenton, MO, US) | |
| ascorbic acid PAR-C-120 (BENCHMATE ™, Burns Philp Food, Inc., | 0.100 |
| Fenton, MO, US) | |
| sodium stearoyl lactylate (SSL) (Archer Daniels Midland Company, Decatur, | 1.000 |
| IL, US) | |
| TOTAL | 793.580 |

For the formula of Table 32, the following process was followed. Salt and sugar were added to the zein and stirred with a wooden stick. Soybean oil and lecithin were added to the ground gum base and stirred with a wooden stick. Ethanol was added to the zein mixture and stirred well (until solubilized into a syrup). The gum base mixture was added to the zein and mixed well. The cold water was added to the KitchenAid™ mixing bowl then the gum base/zein mixture was added and precipitated by hand. The starch mixture was added and mixed well the mixer was turned on (set to speed 6). Clumps were present in the batter during earl mixing but improved with mixing. The batter was mixed for 10 minutes, stopping the mixer once to scrape the bowl. After 10 minutes, the leavening agents (listed in Table 32 in italics) were added and the batter mixed for an additional 3 minutes. 220 g of the batter were weighed into a pup loaf pan and the top of the batter was smoothed with a stick. The batter was proofed to near the top of the pan (approximately 38 minutes) at 113° F./78% RH and then baked for 27 minutes at 430° F.

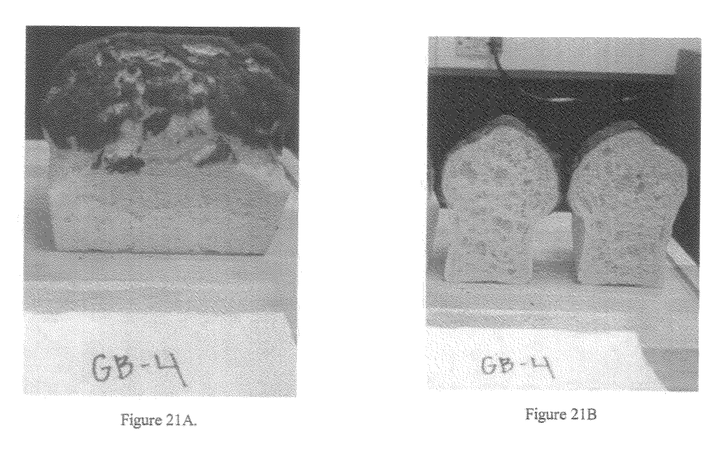

Pictures of the finished breads are shown in FIG. 21.

### EXAMPLE 14

### Gluten-free Bread Containing Ground Freedent® Chewing Gum, Zein, Soybean Oil and Lecithin

This example demonstrates the use of zein in the presence of ground chewing gum. Freedent® chewing gum contains more polyvinyl acetate than regular gum. This polymer is less sticky than other synthetic, gas retaining polymers for use in gum. The formula is listed in Table 33 below.

TABLE 33

| Ingredient | Mass (g) |
|---|---|
| Freedent chewing gum (Wrigley, Chicago, IL, US) | 64.100 |
| Soy bean oil (Cargill, Inc., Wayzata, MN, US) | 10.680 |
| Lecithin (LECIPRIME ™ lecithin, Cargill, Inc., Wayzata, MN, US) | 3.200 |
| Corn Zein (Freeman Industries, LLC, Tuckahoe, NY, US) | 47.900 |
| Salt (Cargill, Inc., Wayzata, MN, US) | 0.800 |
| Sugar (Cargill, Inc., Wayzata, MN, US) | 0.800 |
| 75% aqueous ethanol (EVERCLEAR alcohol, Luxco Inc. St. Louis, MO, | 47.900 |
| US) | |
| Wheat starch (AYTEX-P, Archer Daniels Midland Company, Decatur, IL, | 240.000 |
| US) | |
| Xanthan gum (Satiaxine CX91, Cargill, Inc., Wayzata, MN, US) | 10.000 |
| glucano delta-lactone (GDL) (PURAC America Inc., Lincolnshire, IL, US) | 16.000 |
| sodium bicarbonate (soda) | 8.000 |
| ammonium bicarbonate (Church and Dwight Co., Inc., Princeton, NJ, US) | 2.000 |
| water (ice cold) | 340.000 |
| diacetyl tartaric acid esters of mono-and diglycerides (DATEM) (Danisco, | 1.000 |
| Ardsley, MY, US) | |
| azodicarbonamide ADA-PAR (BENCHMATE ™, Burns Philp Food, Inc., | 0.100 |
| Fenton, MO, US) | |
| ascorbic acid PAR-C-120 (BENCHMATE ™, Burns Philp Food, Inc., | 0.100 |
| Fenton, MO, US) | |
| sodium stearoyl lactylate (SSL) (Archer Daniels Midland Company, Decatur, | 1.000 |
| IL, US) | |
| TOTAL | 793.580 |

For the formula of Table 33, the following process was followed. Salt and sugar were added to the zein and stirred with a wooden stick. Soybean oil and lecithin were added to the ground gum base and stirred with a wooden stick. Ethanol was added to the zein mixture and stirred well (until solubilized into a syrup). The gum base mixture was added to the zein and mixed well. The cold water was added to the KitchenAid™ mixing bowl then the gum base/zein mixture was added and precipitated by hand. The starch mixture was added and mixed well the mixer was turned on (set to speed 6). Clumps were present in the batter during earl mixing but improved with mixing. The batter was mixed for 10 minutes, stopping the mixer once to scrape the bowl. After 10 minutes, the leavening agents (listed in Table 33 in italics) were added and the batter mixed for an additional 3 minutes. 220 g of the batter were weighed into a pup loaf pan and the top of the batter was smoothed with a stick. The batter was proofed to 1″ above the top of the pan (approximately 38 minutes) at 113° F./78% RH and then baked for 31 minutes at 430° F.

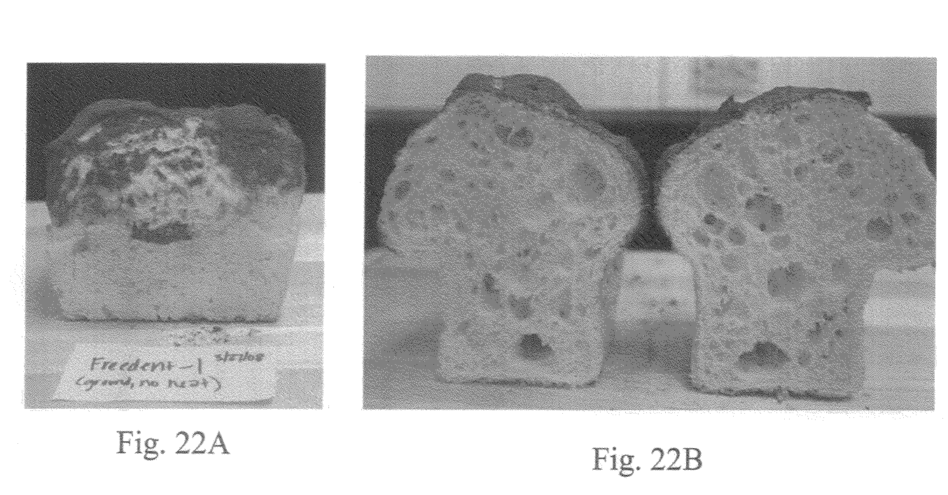

Pictures of the finished breads are shown in FIGS. 22A and 22B.

### EXAMPLE 15

### Further Optimized Hydrocolloid Treatment

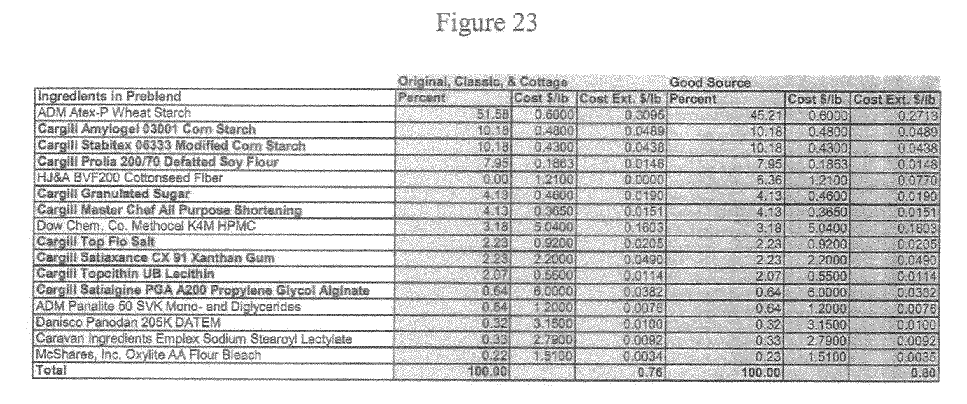

In this example, a hydrocolloid treatment using a formula that was closer to a commercial bread formula was used. The bread was made with a gluten-free and also milk-free bread premix (FIG. 23). There were two versions of premix, a regular bread premix and a good source of fiber premix (this premix enabled the bread to deliver 10% of the recommended daily value of fiber per 50 g of bread). Note that both premixes contained wheat starch. The maximum safe level of gluten for patients with celiac disease is less than 0.02% (200 ppm) and possibly less than 0.002% (20 ppm). The R-Biopharm RIDASCREEN® FAST Gliadin (ELISA kit) gluten test was used to measure gluten in final products. The minimum detection level of this test was 10 ppm gluten.

The term “gluten-free” to mean that a food bearing this term does not contain any of the following:
An ingredient that is a prohibited grain (e.g., wheat, rye, barley, and triticale),
An ingredient that is derived from a prohibited grain and that has not been processed to remove gluten,
An ingredient that is derived from a prohibited grain and that has been processed to remove gluten, if the use of that ingredient results in the presence of 20 parts per million (ppm) or more gluten in the food, or 20 ppm or more gluten.

The maximum allowable level of gluten in wheat starch is 75 ppm based on calculation. A target of 40 ppm is better because it allows for other forms of trace gluten contamination.

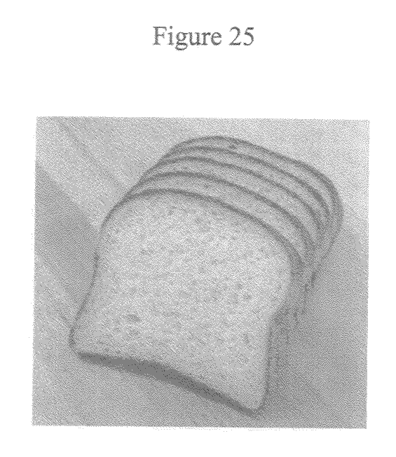

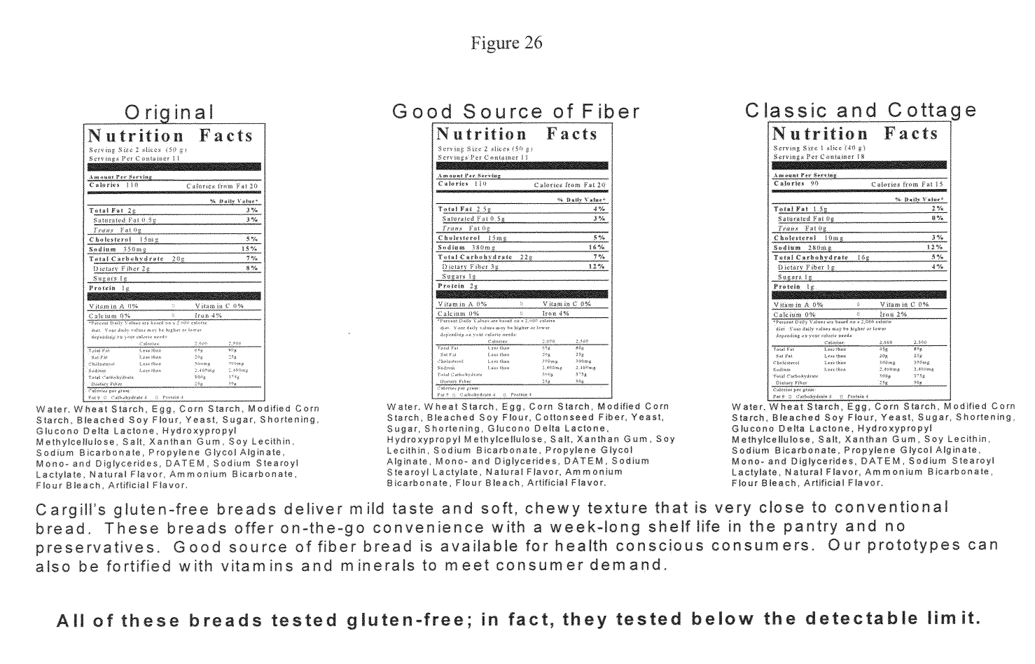

Three lots of wheat starch have tested less than 40 ppm: 17, 22, and 23 ppm, respectively. The bread formula is listed in FIG. 24. The bread was made using the following process. The investigators dissolved ammonium bicarbonate in water. They added ingredients and mixed for 3 minutes on high speed in a KitchenAid™ mixer with paddle. Chemical leavening agents were added and mixed for 3 minutes on high speed. The dough was poured into a sprayed pan, smoothed, and the mass was recorded. The dough was proofed to ⅝ inch at 115° F. and 95% HR. The bread was dusted with starch and baked at 430° F. for 40 minutes, or baked undusted at 406° F. for 40 minutes with initial steam for 20 seconds. Dusting with starch ensures optimal crust color formation. Likewise, steam ensures optimal crust color formation and set. FIG. 25 shows the final baked bread. FIG. 26 provides nutrition labels, ingredient and declarations. The present gluten-free breads delivered mild taste and soft, chewy texture that was very close to conventional bread.

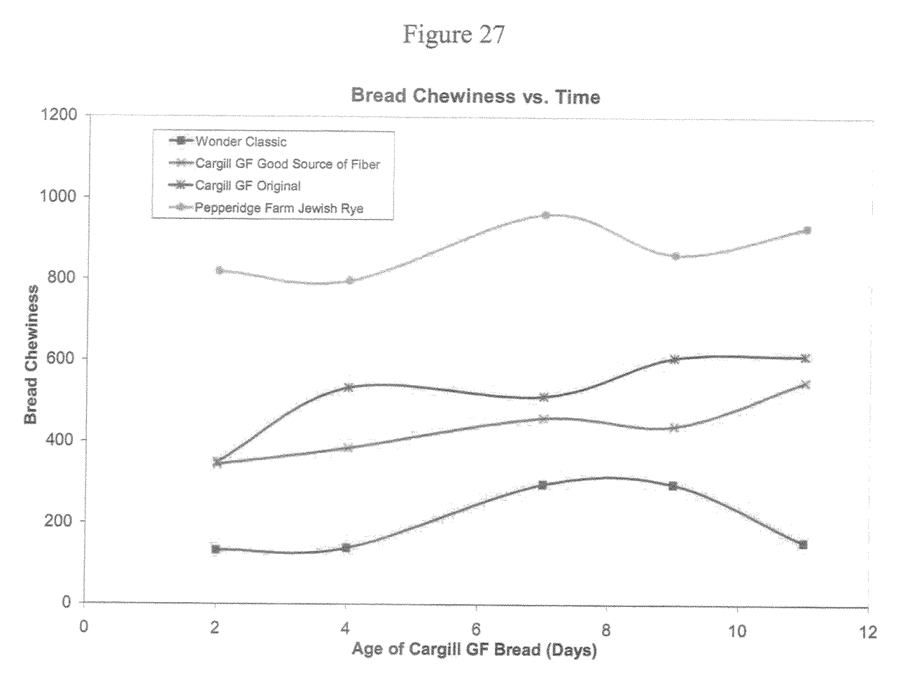

These breads offer on-the-go convenience with a week-long shelf life in the pantry and no preservatives. Good source of fiber bread is available for health conscious consumers. The present formulas are also fortified with vitamins and minerals to meet consumer demand. Dietary Reference Intakes are reasonable guidelines for patients with celiac disease. Key nutrients that are often low in the GF diet include: fiber, (insoluble and soluble), Iron (balanced with zinc), Calcium (balanced with magnesium), Vitamin D (balanced with potassium), Folate (balanced with vitamin B6), B2, B3, and B12. FIG. 27 shows the texture of the gluten-free and milk-free breads. It was surprising that the bread texture was stable for 11 days at ambient conditions. It was also surprising that the chewiness score of the gluten-free and milk-free breads fell within the chewiness score of conventional (wheat-containing) breads. The use of propylene glycol alginate in gluten-free and milk-free bread was one variable for tuning bread chewiness as were modified starches. The method for measuring bread chewiness is described in Example 6 above.

The gluten-free and milk-free breads have changed the breadmaking rules to some extent. The breads are made from a viscous batter that is high in water and more similar to a cake or muffin system than conventional water-limited dough. Key properties in this system are viscosity, air cell distribution and stability and density. Mixing hydrates hydrocolloids and modified starches, which thicken the batter as opposed to gluten, which when hydrated forms a continuous network with the dough. The batter requires shorter proof times than normal because diffusion is faster in the batter and air cells are less stable compared to gluten-containing dough. The batter matrix retains air cells, but lacks strength and collapses if it contacts a solid surface unlike gluten-containing dough, which is extensible and responds to an increase in pressure, but also has strength and does not collapse during expansion. Upon heating, chemical leavening and expanding air cells yield ovenspring, which must occur quickly before the batter sets. This is faster than normal because there is no gluten competing for water in the batter system. The batter sets as starch gelatinizes and proteins denature; set-ability is highly dependent on plasticizer (sugar, water, etc.) content. Setting in the batter is more challenging than in conventional bread because the batter does not contain gluten, which can undergo strain hardening and thermoset. In the baked bread, hydrocolloids and starches impart chewy and soft bread texture. This is traditionally the role of gluten in conventional bread. Gluten is not only inherently rubbery; it also minimizes the formation of a continuous starch network and in turn brittleness. Flavors are added to the batter to enhance final bread flavor to compensate for the flavor of gluten and the flavor that results from reactions between gluten and sugars. There is also minimal yeast fermentation in the batter and therefore yeast flavors are also added to the batter.

### EXAMPLE 16

### Further Optimized Hydrocolloid Treatment for Gluten-Free, Milk-Free, and Wheat-Free Bread

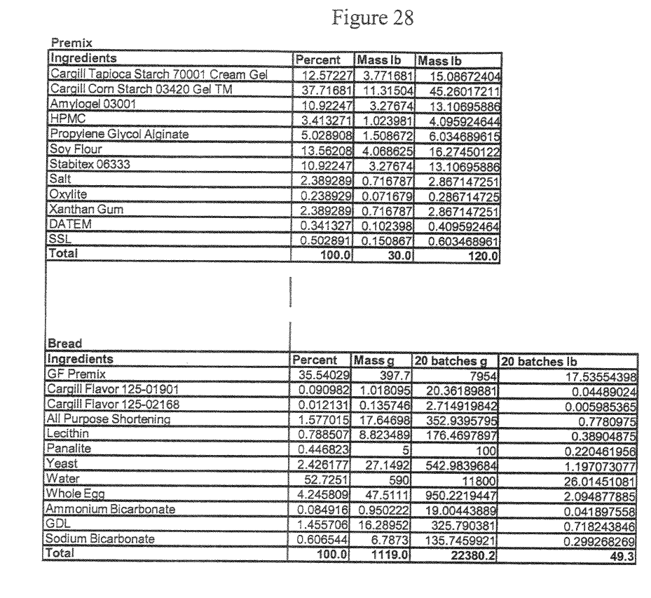

This bread was very similar to the breads in Example 15, except that it was wheat-free. It was also formulated to deliver a good source of fiber as described in Example 15. The bread premix and formula are listed in FIG. 28.

The bread was made using the following process. Ammonium bicarbonate was dissolved in water. The ingredients were combined and mixed for 3 minutes on high speed in KitchenAid™ mixer with paddle. Chemical leavening was added and mixed for 3 minutes on high speed. The dough was poured into a sprayed pan and smoothed. The dough was proofed to ⅝ inch of the pan at 115° F. and 95% HR. The bread was dusted with starch and baked at 430° F. for 40 minutes, or baked undusted at 406° F. for 40 minutes with initial steam for 20 seconds. Dusting with starch ensures optimal crust color formation. Likewise, steam ensures optimal crust color formation and set.

### EXAMPLE 17

### Further Optimized Hydrocolloid Treatment with Ground Gum Base

An accurate and revealing method to analyze bread crumb structure is x-ray micro computed tomography (CT). This technique is a non-destructive analytical method that utilizes the penetration of x-rays to differentiate density variations within the bread. To minimize the introduction of artifacts during preparation, the breads were frozen and sectioned with a sharp blade into approximately 1 cm×1 cm×1 cm cubes. Four cubes from each bread type were analyzed at room temperature. Data was collected on a Skyscan™ 1072 desktop x-ray microtomograph where all samples were exposed to 60 kV x-rays at 100 mA under 20× magnification. X-rays are absorbed or scattered, detecting variations in sample density. The sample is rotated 180 degrees in the x-axis and data slices are collected in the orthogonal plane. Images were reconstructed with Nrecon and analyzed with CT Analyser. For consistent measurement, a region of interest with a set volume was applied across all experiments. Key structure parameters relevant for the analysis of bread include percent object volume, cell wall thickness and air cell size. Additionally, a 3-dimensional rendering of the 2-D slices can be reconstructed to further visualize the bread.

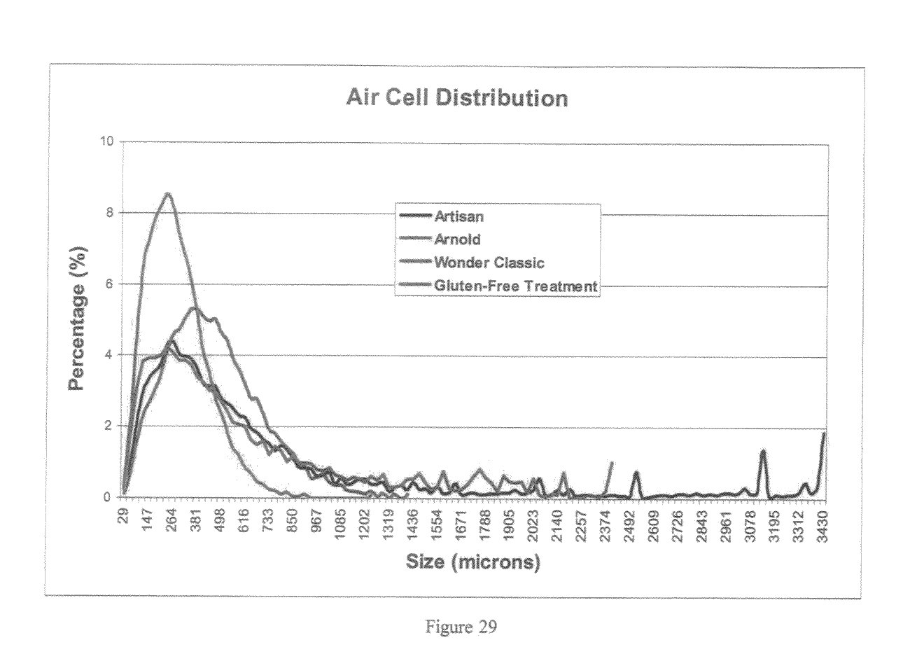

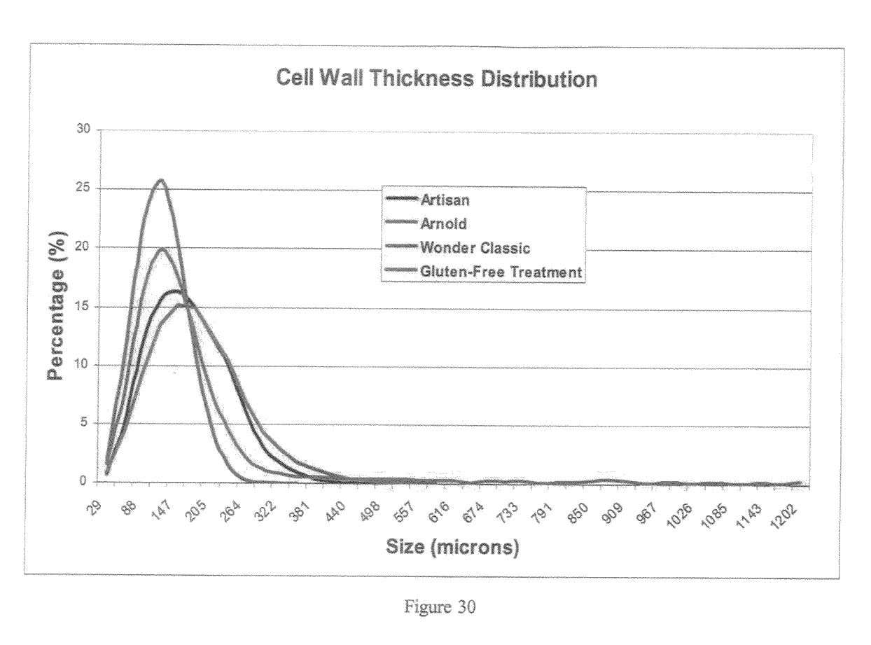

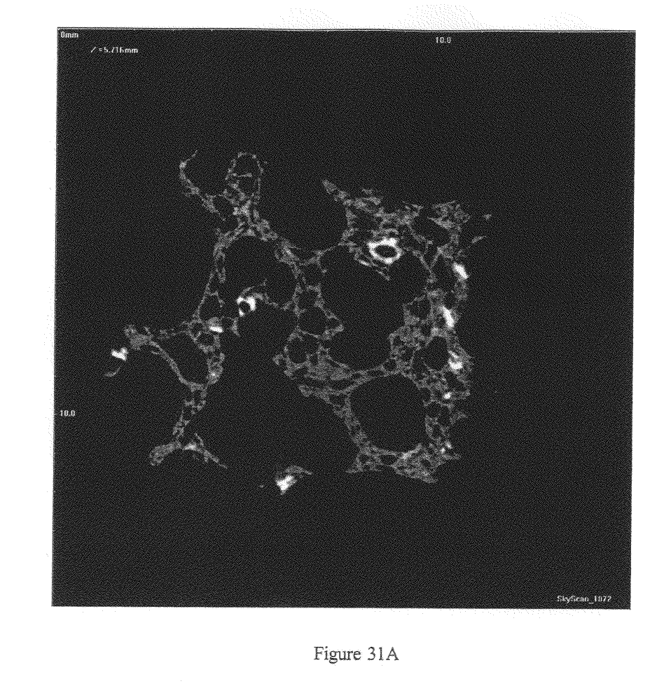

The further optimized hydrocolloid treatment with ground gum base bread was produced using the formula and method of Example 16. In addition, 20 g of ground gum base (Permsoft™) were added with the dry ingredients. The bread looked similar to the breads in Example 18. The crumb was slightly chewier and the crumb texture was finer (lacier). FIGS. 29 and 30 show air cell distribution and cell wall thickness measurements using CT of this example compared to conventional breads. Surprisingly, the gluten free bread was almost identical in terms of cell distribution and wall thickness to conventional artisan (Lund's Artisan Wheat) bread. FIGS. 31A-31D show 2-D slices from the 3-D x-ray rendering of the internal bread crumb structure. The location of the gum base is shown as the lightest gray/white regions on the images. The gum base lines some, but not all air cells. Judging by the morphology, it is reasonable to assume the gum base particles soften and to some extent “melt out” during the proof and bake. The result is a reinforced air cell. Ultimately, this leads to greater crumb resiliency. CT results also show variation in cell wall thickness and air cell size with bread type. For example, the object volume or amount of solid structure of the Arnold Natural Flax and Fiber bread was 28%, the highest among the three commercial, conventional breads analyzed. The relative increase in object volume reflects the addition of higher density inclusions. Very interestingly, the experimental gluten-free bread also had a density object volume of 28%, which may be attributable to the addition of gum base in the formulation. The gum base “inclusions” are not visible to the naked eye nor are they detectable upon mastication, but based on the CT density object volume the gum base inclusions “look” like fiber. They likely act like an unfermentable, insoluble fiber and may provide a satiating effect.

### EXAMPLE 18

### Alternative Setting Agents in Gluten-Free Bread

It has been surprisingly discovered that shellac, in both an ethanol solubilized form and a dry and in a ground form, can be used as setting agents in gluten free bread. Additional forms of shellac, such as aqueous solubilized shellac also function similarly. Shellac can be aqueous solubilized by creating a 23% w/w shellac syrup using water and 28% ammonium hydroxide. This solution was heated to 45-50° C. Another method for solubilizing shellac in aqueous solvent is to mix wheat starch, water, dry shellac and 5% ammonium hydroxide at room temperature and allow the solution to equilibrate overnight. These kinds of materials denature with heat and other methods such as chemical or enzymatic methods. These methods may induce thiol-disulfide interchange or other cross-links, which result in a thermoset bread matrix.

Shellac is a natural, edible gum resin secreted by a female beetle (lac insect Kerria lacca lacca). The crude secretion is refined into a granular or powered form and is usually made functional by adding solvent to the granular shellac to form a glaze, which in food applications is commonly referred to as confectioner's glaze or lac resin glaze. A suitable gluten replacement system must be wettable, viscoelastic and have the ability to set up on chemical and/or physical perturbation.

It has also been surprisingly discovered that water insoluble protein-based edible barrier coatings and films can be used as setting agents in gluten free bread. Proteins for use as setting agents in gluten free bread include: zein, kafirin, whey proteins, egg proteins, soy proteins, caseins, and caroubin. Caroubin may also function as a gas-retaining agent.

Breads were produced using several types of solubilized shellac according to the formula provided in Table 34 below:

TABLE 34

| Ingredient | Mass (g) |
|---|---|
| Powdered chewing gum base (PERMSOFT ™ chewing gum base, Cafosa, | 64.100 |
| S.A.U., Barcelona, Spain) | |
| Soy bean oil (Cargill, Inc., Wayzata, MN, US) | 10.680 |
| Lecithin (LECIPRIME ™ lecithin, Cargill, Inc., Wayzata, MN, US) | 3.200 |
| Shellac (different companies) | 96.000 |
| Salt (Cargill, Inc., Wayzata, MN, US) | 0.800 |
| Sugar (Cargill, Inc., Wayzata, MN, US) | 0.800 |
| tapioca starch | 240.000 |
| Xanthan gum (Satiaxine CX91, Cargill, Inc., Wayzata, MN, US) | 10.000 |
| glucano delta-lactone (GDL) (PURAC America Inc., Lincolnshire, IL, US) | 16.000 |
| sodium bicarbonate (soda) | 8.000 |
| ammonium bicarbonate (Church and Dwight Co., Inc., Princeton, NJ, US) | 2.000 |
| water (ice cold) | 340.000 |
| diacetyl tartaric acid esters of mono-and diglycerides (DATEM) (Danisco, | 1.000 |
| Ardsley, MY, US) | |
| azodicarbonamide ADA-PAR (BENCHMATE ™, Burns Philp Food, Inc., | 0.100 |
| Fenton, MO, US) | |
| ascorbic acid PAR-C-120 (BENCHMATE ™, Burns Philp Food, Inc., | 0.100 |
| Fenton, MO, US) | |
| sodium stearoyl lactylate (SSL) (Archer Daniels Midland Company, Decatur, | 1.000 |
| IL, US) | |
| TOTAL | 793.780 |

For the formula of Table 34, the following process was followed. Salt and sugar were added to the shellac and stirred with a wooden stick. Soybean oil and lecithin were added to the melted gum base and stirred with a wooden stick. The gum base mixture was added to the shellac and mixed well. The cold water was added to the KitchenAid™ mixing bowl then the gum base/shellac mixture was added and precipitated by hand. The starch mixture was added and mixed well the mixer was turned on (set to speed 6). Clumps were present in the batter during earl mixing but improved with mixing. The batter was mixed for 10 minutes, stopping the mixer once to scrape the bowl. After 10 minutes, the leavening agents (listed in Table 34 in italics) were added and the batter mixed for an additional 3 minutes. 220 g of the batter were weighed into a pup loaf pan and the top of the batter was smoothed with a stick. The batter was proofed to 1 inch above the top of the pan (approximately 25-30 minutes) at 113° F./78% RH and then baked for 25-30 minutes at 430° F.

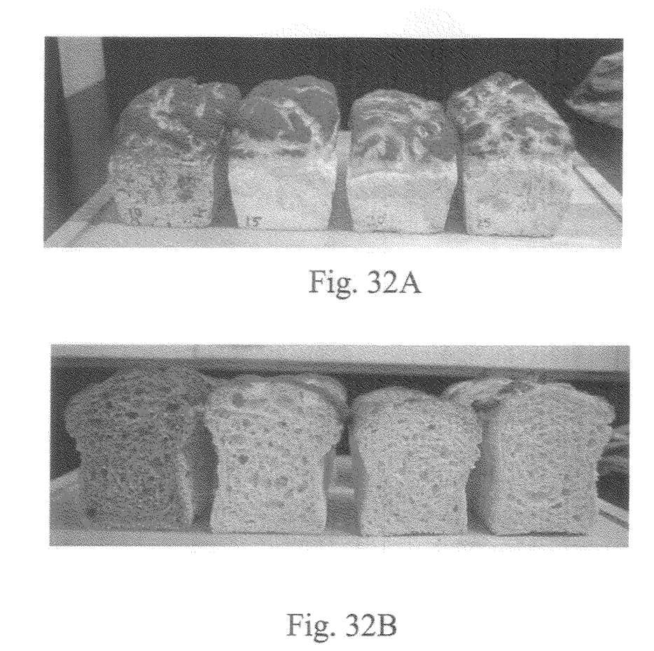

Pictures of the breads are shown in FIGS. 32A-32B. The shellacs were the following:
CB-10 Crystalac® 5# from Mantrose Haeuser (Attleboro, Mass., US)
CB-15 Crystalac® 5# from Mantrose Haeuser (Attleboro, Mass., US)
CB-20 Crystalac® 5# from Mantrose Haeuser (Attleboro, Mass., US)
CB-25 Crystalac® 5# from Mantrose Haeuser (Attleboro, Mass., US)

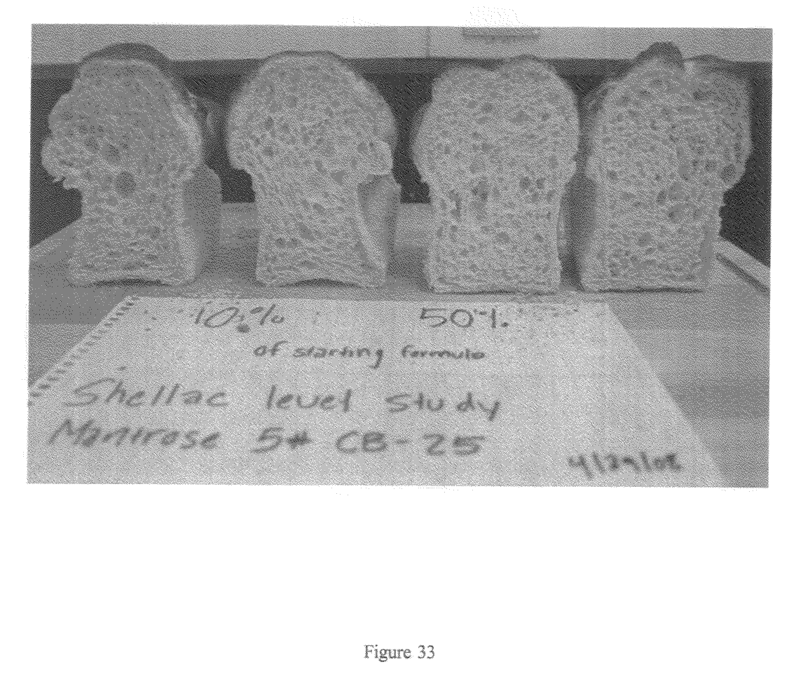

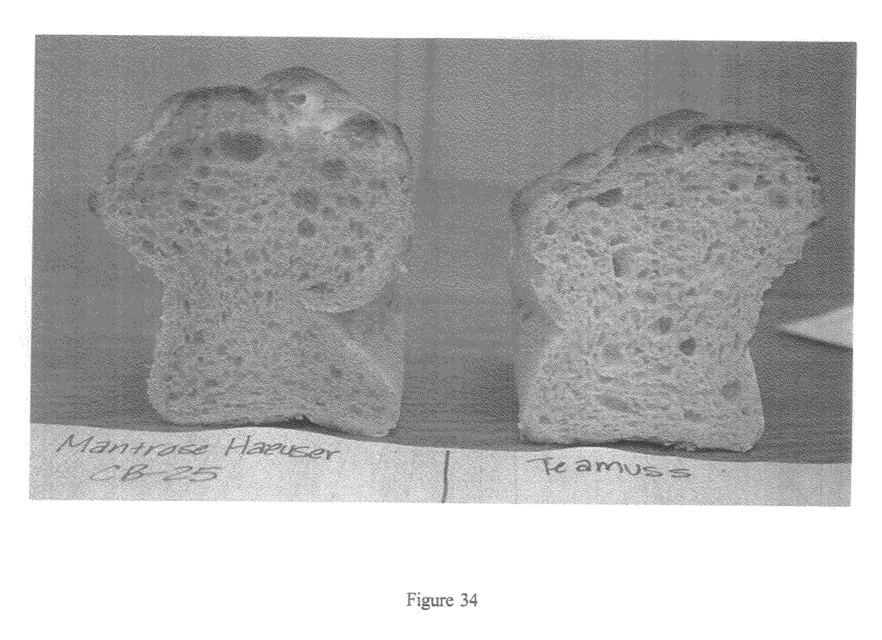

The shellac prevents catastrophic collapse of the tapioca-based breads. The inventors also ran a level study using the best shellac performer (CB-25 Crystalic 5#) at 50% and 90% reduced shellac levels in the formula of Table 34. After 2 days, there was little to no collapse in the 50% and slight collapse in the 10%, as shown in FIG. 33.

### EXAMPLE 19

### Powdered Shellac Used as a Setting Agent in Gluten-Free Bread

Breads were produced using several types of powdered shellac according to the formula provided in Table 35.

TABLE 35

| Ingredient | Mass (g) |
|---|---|
| Soy bean oil (Cargill, Inc., Wayzata, MN, US) | 10.680 |
| Lecithin (LECIPRIME ™ lecithin, Cargill, Inc., Wayzata, MN, US) | 3.200 |
| Powdered Shellac | 96.000 |
| Salt (Cargill, Inc., Wayzata, MN, US) | 0.800 |
| Sugar (Cargill, Inc., Wayzata, MN, US) | 0.800 |
| tapioca starch | 240.000 |
| Xanthan gum (Satiaxine CX91, Cargill, Inc., Wayzata, MN, US) | 10.000 |
| glucano delta-lactone (GDL) (PURAC America Inc., Lincolnshire, IL, US) | 16.000 |
| sodium bicarbonate (soda) | 8.000 |
| ammonium bicarbonate (Church and Dwight Co., Inc., Princeton, NJ, US) | 2.000 |
| water (ice cold) | 340.000 |
| diacetyl tartaric acid esters of mono-and diglycerides (DATEM) (Danisco, | 1.000 |
| Ardsley, MY, US) | |
| azodicarbonamide ADA-PAR (BENCHMATE ™, Burns Philp Food, Inc., | 0.100 |
| Fenton, MO, US) | |
| ascorbic acid PAR-C-120 (BENCHMATE ™, Burns Philp Food, Inc., | 0.100 |
| Fenton, MO, US) | |
| sodium stearoyl lactylate (SSL) (Archer Daniels Midland Company, Decatur, | 1.000 |
| IL, US) | |
| TOTAL | 729.680 |

For the formula of Table 35, the following process was followed. Salt and sugar were added to the shellac and stirred with a wooden stick. Soybean oil and lecithin were added to the shellac and stirred with a wooden stick. The cold water was added to the KitchenAid™ mixing bowl then the shellac mixture was added and stirred. The starch mixture was added and mixed well the mixer was turned on (set to speed 6). Clumps were present in the batter during early mixing but improved with mixing. The batter was mixed for 10 minutes, stopping the mixer once to scrape the bowl. After 10 minutes, the leavening agents (listed in Table 35 in italics) were added and the batter mixed for an additional 3 minutes. 220 g of the batter were weighed into a pup loaf pan and the top of the batter was smoothed with a stick. The batter was proofed to 1 inch above the top of the pan (approximately 25-30 minutes) at 113° F./78% RH and then baked for 25-30 minutes at 4300F.

The shellacs were CB-25 Crystalac from Mantrose Haeuser and Teamuss. Pictures of the breads are shown in FIG. 34. The crumb was set, fine and lacy.

Although the foregoing specification and examples fully disclose and enable the present invention, they are not intended to limit the scope of the invention, which is defined by the claims appended hereto.

All publications, patents and patent applications are incorporated herein by reference. While in the foregoing specification this invention has been described in relation to certain embodiments thereof, and many details have been set forth for purposes of illustration, it will be apparent to those skilled in the art that the invention is susceptible to additional embodiments and that certain of the details described herein may be varied considerably without departing from the basic principles of the invention.

The use of the terms “a” and “an” and “the” and similar referents in the context of describing the invention are to be construed to cover both the singular and the plural, unless otherwise indicated herein or clearly contradicted by context. The terms “comprising,” “having,” “including,” and “containing” are to be construed as open-ended terms (i.e., meaning “including, but not limited to”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Embodiments of this invention are described herein, including the best mode known to the inventors for carrying out the invention. Variations of those embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A dry, gluten-free ingredient delivery system comprising a gas-retaining agent and a setting agent that when processed to form a batter and baked to form a gluten-free product has a chewiness of less than about 1500 grams for at least 7 days.

2. The delivery system of claim 1, wherein the gas-retaining agent is a powdered chewing gum base.

3. The delivery system of claim 2, wherein the chewing gum base has a particle size of less than about 2 mm.

4. The delivery system of claim 2, wherein the chewing gum base has a particle size of less than about 0.5 mm.

5. The delivery system of claim 4, wherein the chewing gum base has a particle size of between about 0.2 mm to 0.35 mm.

6. The delivery system of claim 2, wherein the chewing gum base is present at an amount of about 2 to about 9 wt % of the gluten-free product.

7. The delivery system of claim 1, wherein the gas-retaining agent or the setting agent is a hydrocolloid.

8. The delivery system of claim 7, wherein the hydrocolloid is a linear and neutral hydrocolloid, a linear and charged hydrocolloid, or a combination thereof.

9. The delivery system of claim 8, wherein the linear and charged hydrocolloid is pectin, low ester pectin, alginate, carrageenan, agar, xanthan gum, gellan gum, carboxymethyl cellulose, or a combination thereof.

10. The delivery system of claim 8, wherein the linear and neutral hydrocolloid is microcrystalline cellulose, methyl cellulose, hydroxypropyl methyl cellulose, hydroxypropyl cellulose, amylose, guar, locust bean gum, tara, konjac, or a combination thereof.

11. The delivery system of claim 7, wherein the hydrocolloid is propylene glycol alginate.

12. The delivery system of claim 1, further comprising a hydrocolloid.

13. The delivery system of claim 1, wherein the setting agent is polylactic acid, polyvinyl alcohol, zein, polycaprolactone, kafirin, whey protein, egg protein, soy protein, casein, caroubin, shellac, or water insoluble protein-based edible barrier coating or film.

14. The delivery system of claim 13, wherein the shellac is in an ethanol-solubilized form, aqueous-solubilized form or a dry-and-ground form.

15. The delivery system of claim 1, wherein the gas-retaining agent or the setting agent is a starch.

16. The delivery system of claim 1, further comprising a starch.

17. The delivery system of claim 1, wherein the gluten-free product is dairy-free.

18. The delivery system of claim 1, wherein the gluten-free product is a bakery product.

19. The delivery system of claim 1, wherein the gluten-free product has a chewiness of about 800 to 1500 grams for at least 7 days.

20. The delivery system of claim 1, wherein the gluten-free product has a chewiness of about 800 to 1200 grams for at least 7 days.

21. A food product made with the delivery system of claim 1.

22. The food product of claim 21, wherein the food product is a gluten-free bakery product, a gluten-free pasta, a gluten-free cereal product, a gluten-free cracker, a gluten-free pizza crust, or a gluten-free bar product.

23. A pre-mix comprising the delivery system of claim 1.

24. A dough product made with the delivery system of claim 1.

25. A batter made with the delivery system of claim 1.

26. A method for making a gluten-free bakery product, comprising the steps of
(a) providing a gluten-free gas-retaining agent that is a powdered chewing gum base and a gluten-free setting agent,
(b) preparing a batter composition; and
(c) baking the batter composition to form an air continuous, stable food product.

27. A method of managing a gluten-related disorder in an individual, comprising providing the food product of claim 21 to the individual.

28. The method of claim 27, wherein the gluten-related disorder is celiac disease, gluten allergy, gluten intolerance, or gluten sensitivity.

29. A method of producing a gluten-free bakery product with a chewiness of less than about 1200 grams for at least 7 days, comprising the steps of:
(a) preparing a batter composition from an ingredient delivery system such as a dry, gluten-free baking mix;
(b) proofing the batter to a known height above the bread pan; and
(c) either (i) steaming the proofed batter to ensure optimal crust color formation and set, and baking the steamed batter to form an air continuous, stable food product, or (ii) dusting the proofed batter to ensure optimal crust color formation, and baking the dusted batter to form an air continuous, stable food product.
